(19) United States
(12) Patent Application Publication
(10) Pub. No.: US 2023/0328569 A1
(43) Pub. Date: Oct. 12, 2023

(54) TECHNIQUES FOR JOINT CHANNEL STATE INFORMATION REPORTING FOR MULTIPLE TRANSMISSION AND RECEPTION POINT COMMUNICATION SCHEMES

(71) Applicant: QUALCOMM INCORPORATED, San Diego, CA (US)

(72) Inventors: Mostafa Khoshnevisan, San Diego, CA (US); Muhammad Sayed Khairy Abdelghaffar, San Jose, CA (US); Yu Zhang, San Diego, CA (US); Chenxi Hao, Beijing (CN); Wooseok Nam, San Diego, CA (US)

(21) Appl. No.: 18/044,425

(22) PCT Filed: Oct. 6, 2020
(86) PCT No.: PCT/CN2020/119827

§ 371 Date: Mar. 8, 2023

(51) Int. Cl. H04W 24/10; H04L 5/00

(52) U.S. Cl. CPC H04W 24/10; H04L 5/0035

(57) ABSTRACT

Methods, systems, and devices for wireless communications are described. In some systems, a user equipment (UE) may receive a transmission from multiple transmission and reception points (TRPs) according to a communication scheme, such as a multi-TRP or single frequency network (SFN) communication scheme, in which the multiple TRPs may transmit associated reference signals based on applying different transmission configuration indicator (TCI) states. The UE may receive a control message indicating the communication scheme and, in some examples, one or more parameters that the UE is to include in a corresponding channel state information (CSI) reference signal (CSI-RS) report. The UE, based on receiving the control message, may monitor for the reference signals from the multiple TRPs and generate the CSI-RS report based on receiving the reference signals and based on the indicated communication scheme. Accordingly, the UE may transmit the generated CSI-RS report.

### CROSS REFERENCE

The present application is a 371 national stage filing of International PCT Application No. PCT/CN2020/119827 by KHOSHNEVISAN et al. entitled “TECHNIQUES FOR JOINT CHANNEL STATE INFORMATION REPORTING FOR MULTIPLE TRANSMISSION AND RECEPTION POINT COMMUNICATION SCHEMES,” filed Oct. 6, 2020, which is assigned to the assignee hereof, and which is expressly incorporated by reference in its entirety herein.

### FIELD OF TECHNOLOGY

The following relates to wireless communications, including techniques for joint channel state information (CSI) reporting for multiple transmission and reception point (TRP) communication schemes.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a UE may communicate with multiple transmission and reception points (TRPs). In some cases, each TRP of the multiple TRPs may apply a different transmission configuration indicator (TCI) state. As such, the multiple TRPs may employ different multi-TRP communication schemes in which the multiple TRPs perform transmissions over a same resource according to their different TCI states.

### SUMMARY

The described techniques relate to improved methods, systems, devices, and apparatuses that support techniques for joint channel state information (CSI) reporting for multiple transmission and reception point (TRP) communication schemes. Generally, the described techniques provide for signaling to a user equipment (UE) indicating a communication scheme, such as a multi-TR) communication scheme or a single frequency network (SFN) communication scheme, according to which multiple TRPs may transmit to the UE. The UE, based on receiving the indication of the communication scheme, may monitor for associated reference signals, such as CSI reference signals (CSI-RSs), from the multiple TRPs and may generate a report, such as a CSI report, upon receiving the reference signals and according to the indicated communication scheme. For example, the parameters that the UE may include in a CSI report may depend on the communication scheme employed by the multiple TRPs. In other words, the UE may include different parameters (or different quantities of the same parameters) in a CSI report for transmissions according to different communication schemes.

For instance, the UE may include one or more precoding matrix indicators (PMIs), one or more rank indicators (RIs), one or more layer indicators (LIs), or one or more channel quality indicators (CQIs), or any combination thereof, in a joint CSI report generated in response to receiving the reference signals from the multiple TRPs and based the communication scheme employed by the multiple TRPs to transmit the reference signals or any associated data. In some implementations, in addition or in an alternative to receiving the indication of the communication scheme, the UE may receive an indication of a quantity of one or more parameters to include in the CSI report. For example, the UE may receive an indication of a quantity of LIs to include in the CSI report. In such examples, the UE may include one or more LIs in the CSI report according to the indicated quantity and, in some aspects, expect to receive one or more phase-tracking reference signals (PT-RSs) corresponding to the one or more reported Us.

A method of wireless communication at a UE is described. The method may include receiving a control message including a joint CSI reporting configuration that indicates a multi-TRP communication scheme of a set of multi-TRP communication schemes and a set of TCI states to be applied by two or more TRPs, monitoring for two or more reference signals from the two or more TRPs based on the control message, generating a joint CSI report based on the two or more reference signals, the multi-TRP communication scheme, and the set of TCI states, and transmitting the joint CSI report.

An apparatus for wireless communication at a UE is described. The apparatus may include a processor, memory coupled with the processor, and instructions stored in the memory. The instructions may be executable by the processor to cause the apparatus to receive a control message including a joint CSI reporting configuration that indicates a multi-TRP communication scheme of a set of multi-TRP communication schemes and a set of TCI states to be applied by two or more TRPs, monitor for two or more reference signals from the two or more TRPs based on the control message, generate a joint CSI report based on the two or more reference signals, the multi-TRP communication scheme, and the set of TCI states, and transmit the joint CSI report.

Another apparatus for wireless communication at a UE is described. The apparatus may include means for receiving a control message including a joint CSI reporting configuration that indicates a multi-TRP communication scheme of a set of multi-TRP communication schemes and a set of TCI states to be applied by two or more TRPs, monitoring for two or more reference signals from the two or more TRPs based on the control message, generating a joint CSI report based on the two or more reference signals, the multi-TRP communication scheme, and the set of TCI states, and transmitting the joint CSI report.

A non-transitory computer-readable medium storing code for wireless communication at a UE is described. The code may include instructions executable by a processor to receive a control message including a joint CSI reporting configuration that indicates a multi-TRP communication scheme of a set of multi-TRP communication schemes and a set of TCI states to be applied by two or more TRPs, monitor for two or more reference signals from the two or more TRPs based on the control message, generate a joint CSI report based on the two or more reference signals, the multi-TRP communication scheme, and the set of TCI states, and transmit the joint CSI report.

In some examples of the method, apparatuses, and non-transitory computer-readable medium described herein, transmitting the joint CSI report may include operations, features, means, or instructions for transmitting the joint CSI report including one or more CSI parameters according to the multi-TRP communication scheme.

In some examples of the method, apparatuses, and non-transitory computer-readable medium described herein, the one or more CSI parameters include one or more PMIs, one or more RIs, one or more Us, or one or more CQIs.

In some examples of the method, apparatuses, and non-transitory computer-readable medium described herein, transmitting the joint CSI report may include operations, features, means, or instructions for transmitting the joint CSI report including a quantity of one or more reported CSI parameters that may be selected according to the multi-TRP communication scheme.

Some examples of the method, apparatuses, and non-transitory computer-readable medium described herein may further include operations, features, means, or instructions for receiving a second control message indicating the set of multi-TRP communication schemes, where the joint CSI reporting configuration indicates one or more multi-TRP communication schemes of the set of multi-TRP communication schemes, and selecting to report the multi-TRP communication scheme from the one or more multi-TRP communication schemes in the joint CSI report.

In some examples of the method, apparatuses, and non-transitory computer-readable medium described herein, transmitting the joint CSI report may include operations, features, means, or instructions for transmitting the joint CSI report including an indication of the multi-TRP communication scheme that may be selected from the one or more multi-TRP communication schemes based on a respective spectral efficiency metric observed for the one or more multi-TRP communication schemes.

In some examples of the method, apparatuses, and non-transitory computer-readable medium described herein, transmitting the joint CSI report further may include operations, features, means, or instructions for transmitting the indication of the multi-TRP communication scheme in a first part of the joint CSI report, and transmitting one or more CSI parameters according to the multi-TRP communication scheme in a second part of the joint CSI report.

In some examples of the method, apparatuses, and non-transitory computer-readable medium described herein, the first part of the joint CSI report may be associated with a fixed size and the second part of the joint CSI report may be associated with a variable size that may be based on the multi-TRP communication scheme.

In some examples of the method, apparatuses, and non-transitory computer-readable medium described herein, each of the one or more multi-TRP communication schemes indicated by the joint CSI reporting configuration correspond to at least one CSI reporting hypothesis.

In some examples of the method, apparatuses, and non-transitory computer-readable medium described herein, receiving the control message may include operations, features, means, or instructions for receiving the control message via RRC signaling, a MAC-CE, DCI, or any combination thereof.

In some examples of the method, apparatuses, and non-transitory computer-readable medium described herein, the set of multi-TRP communication schemes include a space-division multiplexing communication scheme, a time-division multiplexing scheme, a frequency-division multiplexing scheme, a coherent joint transmission communication scheme, a first SFN communication scheme in which each demodulation reference signal and each data layer of a data transmission may be associated with a single TCI state, a second SFN communication scheme in which each demodulation reference signal port and each data layer of the data transmission may be associated with the set of TCI states, a third SFN communication scheme in which each data layer of the data transmission may be associated with the set of TCI states and in which each demodulation reference signal port may be associated with one of the set of TCI states, or any combination thereof.

In some examples of the method, apparatuses, and non-transitory computer-readable medium described herein, the two or more TRPs include a first TRP and a second TRP and the set of TCI states include a first TCI state and a second TCI state, and where the first TRP applies the first TCI state and the second TRP applies the second TCI state.

A method of wireless communication at a UE is described. The method may include receiving a control message including a joint CSI reporting configuration that indicates a set of TCI states to be applied by two or more TRPs and at least one of a SFN communication scheme of a set of SFN communication schemes, a quantity of one or more Us to be included in a joint CSI report, or both, identifying the quantity of the one or more Us to include in the joint CSI report based on the SFN communication scheme, the quantity of the one or more Us, or both, indicated in the control message, monitoring for two or more reference signals from the two or more TRPs based on the control message, generating the joint CSI report including the one or more Us based on the two or more reference signals, the quantity of the one or more Us, the SFN communication scheme, and the set of TCI states, and transmitting the joint CSI report.

An apparatus for wireless communication at a UE is described. The apparatus may include a processor, memory coupled with the processor, and instructions stored in the memory. The instructions may be executable by the processor to cause the apparatus to receive a control message including a joint CSI reporting configuration that indicates a set of TCI states to be applied by two or more TRPs and at least one of a SFN communication scheme of a set of SFN communication schemes, a quantity of one or more Us to be included in a joint CSI report, or both, identify the quantity of the one or more Us to include in the joint CSI report based on the SFN communication scheme, the quantity of the one or more Us, or both, indicated in the control message, monitor for two or more reference signals from the two or more TRPs based on the control message, generate the joint CSI report including the one or more Us based on the two or more reference signals, the quantity of the one or more Us, the SFN communication scheme, and the set of TCI states, and transmit the joint CSI report.

Another apparatus for wireless communication at a UE is described. The apparatus may include means for receiving a control message including a joint CSI reporting configuration that indicates a set of TCI states to be applied by two or more TRPs and at least one of a SFN communication scheme of a set of SFN communication schemes, a quantity of one or more Us to be included in a joint CSI report, or both, identifying the quantity of the one or more Us to include in the joint CSI report based on the SFN communication scheme, the quantity of the one or more Us, or both, indicated in the control message, monitoring for two or more reference signals from the two or more TRPs based on the control message, generating the joint CSI report including the one or more Us based on the two or more reference signals, the quantity of the one or more Us, the SFN communication scheme, and the set of TCI states, and transmitting the joint CSI report.

A non-transitory computer-readable medium storing code for wireless communication at a UE is described. The code may include instructions executable by a processor to receive a control message including a joint CSI reporting configuration that indicates a set of TCI states to be applied by two or more TRPs and at least one of a SFN communication scheme of a set of SFN communication schemes, a quantity of one or more Us to be included in a joint CSI report, or both, identify the quantity of the one or more Us to include in the joint CSI report based on the SFN communication scheme, the quantity of the one or more Us, or both, indicated in the control message, monitor for two or more reference signals from the two or more TRPs based on the control message, generate the joint CSI report including the one or more Us based on the two or more reference signals, the quantity of the one or more Us, the SFN communication scheme, and the set of TCI states, and transmit the joint CSI report.

In some examples of the method, apparatuses, and non-transitory computer-readable medium described herein, transmitting the joint CSI report may include operations, features, means, or instructions for transmitting the joint CSI report including a first PMI associated with a first TCI state of the set of TCI states and a second PMI associated with a second TCI state of the set of TCI states.

In some examples of the method, apparatuses, and non-transitory computer-readable medium described herein, transmitting the joint CSI report further may include operations, features, means, or instructions for transmitting the joint CSI report including a single LI based on the SFN communication scheme, where the single LI indicates a layer corresponding to a same column in each of the first PMI and the second PMI.

In some examples of the method, apparatuses, and non-transitory computer-readable medium described herein, transmitting the joint CSI report further may include operations, features, means, or instructions for transmitting the joint CSI report including a first LI and a second LI based on the SFN communication scheme, where the first LI corresponds to a first layer corresponding to a first column of the first PMI and the second LI corresponds to a second layer corresponding to a second column of the second PMI.

In some examples of the method, apparatuses, and non-transitory computer-readable medium described herein, transmitting the joint CSI report further may include operations, features, means, or instructions for transmitting the joint CSI report including a single LI based on the SFN communication scheme, where the single LI indicates a layer corresponding to a column of one of the first PMI or the second PMI.

In some examples of the method, apparatuses, and non-transitory computer-readable medium described herein, the one of the first PMI or the second PMI reported in the joint CSI report may be preconfigured or signaled.

In some examples of the method, apparatuses, and non-transitory computer-readable medium described herein, the one of the first PMI or the second PMI reported in the joint CSI report may be selected based on a signal metric, and where transmitting the joint CSI report further may include operations, features, means, or instructions for transmitting the joint CSI report including an indication of the selected one of the first PMI or the second PMI.

In some examples of the method, apparatuses, and non-transitory computer-readable medium described herein, the first PMI and the second PMI may have a same number of columns corresponding to a jointly selected RI.

Some examples of the method, apparatuses, and non-transitory computer-readable medium described herein may further include operations, features, means, or instructions for receiving one or more phase tracking reference signals over one or more layers corresponding to the one or more LIs of the joint CSI report.

In some examples of the method, apparatuses, and non-transitory computer-readable medium described herein, receiving the control message may include operations, features, means, or instructions for receiving the control message including an indication of a single reference signal resource associated with the set of TCI states, where the single reference signal resource may be associated with a set of reference signal port groups, each reference signal port group of the set of reference signal port groups corresponding to one of the set of TCI states.

Some examples of the method, apparatuses, and non-transitory computer-readable medium described herein may further include operations, features, means, or instructions for monitoring the single reference signal resource, where each of the two or more reference signals may be received based on monitoring the single reference signal resource, each of the two or more reference signals corresponding to a reference signal port group of the set of reference signal port groups.

In some examples of the method, apparatuses, and non-transitory computer-readable medium described herein, receiving the control message may include operations, features, means, or instructions for receiving the control message including an indication of a set of reference signal resources, each reference signal resource of the set of reference signal resources corresponding to one of the set of TC states.

Some examples of the method, apparatuses, and non-transitory computer-readable medium described herein may further include operations, features, means, or instructions for monitoring the set of reference signal resources, where each of the two or more reference signals may be received based on monitoring the set of reference signal resources, each of the two or more reference signals corresponding to a reference signal resource of the set of reference signal resources.

In some examples of the method, apparatuses, and non-transitory computer-readable medium described herein, transmitting the joint CSI report may include operations, features, means, or instructions for transmitting the one or more Us in a first part of the joint CSI report, the first part of the joint CSI report having a fixed size.

In some examples of the method, apparatuses, and non-transitory computer-readable medium described herein, transmitting the joint CSI report may include operations, features, means, or instructions for transmitting the one or more LIs in a second part of the joint CSI report, the second part of the joint CSI report having a variable size.

In some examples of the method, apparatuses, and non-transitory computer-readable medium described herein, transmitting the joint CSI report may include operations, features, means, or instructions for transmitting the joint CSI report including a single PMI corresponding to all ports or a set of ports of the two or more reference signals.

In some examples of the method, apparatuses, and non-transitory computer-readable medium described herein, transmitting the joint CSI report may include operations, features, means, or instructions for transmitting the joint CSI report including a single PMI corresponding to a port-to-port sum of respective pluralities of ports associated with the two or more reference signals.

In some examples of the method, apparatuses, and non-transitory computer-readable medium described herein, the joint CSI reporting configuration includes a field indicating the quantity of the one or more LIs to be included in the joint CSI report, the quantity corresponding to the SFN communication scheme.

In some examples of the method, apparatuses, and non-transitory computer-readable medium described herein, receiving the control message may include operations, features, means, or instructions for receiving the control message via RRC signaling, a MAC-CE, DCI, or any combination thereof.

In some examples of the method, apparatuses, and non-transitory computer-readable medium described herein, the set of SFN communication schemes include a coherent joint transmission communication scheme, a first SFN communication scheme in which each demodulation reference signal and each data layer of a data transmission may be associated with a single TCI state, a second SFN communication scheme in which each demodulation reference signal port and each data layer of the data transmission may be associated with the set of TCI states, a third SFN communication scheme in which each data layer of the data transmission may be associated with the set of TCI states and in which each demodulation reference signal port may be associated with one of the set of TCI states, or any combination thereof.

In some examples of the method, apparatuses, and non-transitory computer-readable medium described herein, the two or more TRPs include a first TRP and a second TRP and the set of TCI states include a first TCI state and a second TCI state, and where the first TRP applies the first TCI state and the second TRP applies the second TCI state.

A method of wireless communication at a first TRP is described. The method may include transmitting, to a UE, a control message including a joint CSI reporting configuration that indicates a multi-TRP communication scheme of a set of multi-TRP communication schemes and a set of TCI states to be applied by the first TRP and a second TRP, transmitting a reference signal according to the multi-TRP communication scheme and a first TCI state of the set of TCI states, and receiving, from the UE, a joint CSI report based on the reference signal.

An apparatus for wireless communication at a first TRP is described. The apparatus may include a processor, memory coupled with the processor, and instructions stored in the memory. The instructions may be executable by the processor to cause the apparatus to transmit, to a UE, a control message including a joint CSI reporting configuration that indicates a multi-TRP communication scheme of a set of multi-TRP communication schemes and a set of TCI states to be applied by the first TRP and a second TRP, transmit a reference signal according to the multi-TRP communication scheme and a first TCI state of the set of TCI states, and receive, from the UE, a joint CSI report based on the reference signal.

Another apparatus for wireless communication at a first TRP is described. The apparatus may include means for transmitting, to a UE, a control message including a joint CSI reporting configuration that indicates a multi-TRP communication scheme of a set of multi-TRP communication schemes and a set of TCI states to be applied by the first TRP and a second TRP, transmitting a reference signal according to the multi-TRP communication scheme and a first TCI state of the set of TCI states, and receiving, from the UE, a joint CSI report based on the reference signal.

A non-transitory computer-readable medium storing code for wireless communication at a first TRP is described. The code may include instructions executable by a processor to transmit, to a UE, a control message including a joint CSI reporting configuration that indicates a multi-TRP communication scheme of a set of multi-TRP communication schemes and a set of TCI states to be applied by the first TRP and a second TRP, transmit a reference signal according to the multi-TRP communication scheme and a first TCI state of the set of TCI states, and receive, from the UE, a joint CSI report based on the reference signal.

In some examples of the method, apparatuses, and non-transitory computer-readable medium described herein, receiving the joint CSI report may include operations, features, means, or instructions for receiving the joint CSI report including one or more CSI parameters according to the multi-TRP communication scheme.

In some examples of the method, apparatuses, and non-transitory computer-readable medium described herein, the one or more CSI parameters include one or more PMIs, one or more RIs, one or more Us, or one or more CQIs.

In some examples of the method, apparatuses, and non-transitory computer-readable medium described herein, receiving the joint CSI report may include operations, features, means, or instructions for receiving the joint CSI report including a quantity of one or more reported CSI parameters that may be selected according to the multi-TRP communication scheme.

Some examples of the method, apparatuses, and non-transitory computer-readable medium described herein may further include operations, features, means, or instructions for transmitting, to the UE, a second control message indicating the set of multi-TRP communication schemes, where the joint CSI reporting configuration indicates one or more multi-TRP communication schemes of the set of multi-TRP communication schemes.

In some examples of the method, apparatuses, and non-transitory computer-readable medium described herein, receiving the joint CSI report may include operations, features, means, or instructions for receiving the joint CSI report including an indication of the multi-TRP communication scheme that may be selected from the one or more multi-TRP communication schemes based on a respective spectral efficiency metric observed for the one or more multi-TRP communication schemes.

In some examples of the method, apparatuses, and non-transitory computer-readable medium described herein, receiving the joint CSI report may include operations, features, means, or instructions for receiving the indication of the multi-TRP communication scheme in a first part of the joint CSI report, and receiving one or more CSI parameters according to the multi-TRP communication scheme in a second part of the joint CSI report.

In some examples of the method, apparatuses, and non-transitory computer-readable medium described herein, the first part of the joint CSI report may be associated with a fixed size and the second part of the joint CSI report may be associated with a variable size that may be based on the multi-TRP communication scheme.

In some examples of the method, apparatuses, and non-transitory computer-readable medium described herein, each of the one or more multi-TRP communication schemes indicated by the joint CSI reporting configuration correspond to at least one CSI reporting hypothesis.

In some examples of the method, apparatuses, and non-transitory computer-readable medium described herein, transmitting the control message may include operations, features, means, or instructions for transmitting the control message via RRC signaling, a MAC-CE, DCI, or any combination thereof.

In some examples of the method, apparatuses, and non-transitory computer-readable medium described herein, the set of multi-TRP communication schemes include a space-division multiplexing communication scheme, a time-division multiplexing scheme, a frequency-division multiplexing scheme, a coherent joint transmission communication scheme, a first SFN communication scheme in which each demodulation reference signal and each data layer of a data transmission may be associated with a single TCI state, a second SFN communication scheme in which each demodulation reference signal port and each data layer of the data transmission may be associated with the set of TCI states, a third SFN communication scheme in which each data layer of the data transmission may be associated with the set of TCI states and in which each demodulation reference signal port may be associated with one of the set of TCI states, or any combination thereof.

In some examples of the method, apparatuses, and non-transitory computer-readable medium described herein, the set of TCI states include the first TCI state and a second TCI state, and where the first TRP applies the first TCI state and the second TRP applies the second TCI state.

A method of wireless communication at a first TRP is described. The method may include transmitting, to a UE, a control message including a joint CSI reporting configuration that indicates a set of TCI states to be applied by the first TRP and a second TRP and at least one of a SFN communication scheme of a set of SFN communication schemes, a quantity of one or more LIs to be included in a joint CSI report, or both, transmitting a reference signal according to the SFN communication scheme, and receiving, from the UE, the joint CSI report including the one or more LIs based on the reference signal.

An apparatus for wireless communication at a first TRP is described. The apparatus may include a processor, memory coupled with the processor, and instructions stored in the memory. The instructions may be executable by the processor to cause the apparatus to transmit, to a UE, a control message including a joint CSI reporting configuration that indicates a set of TCI states to be applied by the first TRP and a second TRP and at least one of a SFN communication scheme of a set of SFN communication schemes, a quantity of one or more Us to be included in a joint CSI report, or both, transmit a reference signal according to the SFN communication scheme, and receive, from the UE, the joint CSI report including the one or more Us based on the reference signal.

Another apparatus for wireless communication at a first TRP is described. The apparatus may include means for transmitting, to a UE, a control message including a joint CSI reporting configuration that indicates a set of TCI states to be applied by the first TRP and a second TRP and at least one of a SFN communication scheme of a set of SFN communication schemes, a quantity of one or more Us to be included in a joint CSI report, or both, transmitting a reference signal according to the SFN communication scheme, and receiving, from the UE, the joint CSI report including the one or more Us based on the reference signal.

A non-transitory computer-readable medium storing code for wireless communication at a first TRP is described. The code may include instructions executable by a processor to transmit, to a UE, a control message including a joint CSI reporting configuration that indicates a set of TCI states to be applied by the first TRP and a second TRP and at least one of a SFN communication scheme of a set of SFN communication schemes, a quantity of one or more Us to be included in a joint CSI report, or both, transmit a reference signal according to the SFN communication scheme, and receive, from the UE, the joint CSI report including the one or more Us based on the reference signal.

In some examples of the method, apparatuses, and non-transitory computer-readable medium described herein, receiving the joint CSI report may include operations, features, means, or instructions for receiving the joint CSI report including a first PMI associated with a first TCI state of the set of TCI states and a second PMI associated with a second TCI state of the set of TCI states.

In some examples of the method, apparatuses, and non-transitory computer-readable medium described herein, receiving the joint CSI report further may include operations, features, means, or instructions for receiving the joint CSI report including one a single LI based on the SFN communication scheme, where the single LI indicates a layer corresponding to a same column in each of the first PMI and the second PMI.

In some examples of the method, apparatuses, and non-transitory computer-readable medium described herein, receiving the joint CSI report further may include operations, features, means, or instructions for receiving the joint CSI report including a first LI and a second LI based on the SFN communication scheme, where the first LI corresponds to a first layer corresponding to a first column of the first PMI and the second LI corresponds to a second layer corresponding to a second column of the second PMI.

In some examples of the method, apparatuses, and non-transitory computer-readable medium described herein, receiving the joint CSI report further may include operations, features, means, or instructions for receiving the joint CSI report including a single LI based on the SFN communication scheme, where the single LI indicates a layer corresponding to a column of one of the first PMI or the second PMI.

In some examples of the method, apparatuses, and non-transitory computer-readable medium described herein, the one of the first PMI or the second PMI reported in the joint CSI report may be preconfigured or signaled.

In some examples of the method, apparatuses, and non-transitory computer-readable medium described herein, the one of the first PMI or the second PMI reported in the joint CSI report may be selected based on a signal metric, and where receiving the joint CSI report further may include operations, features, means, or instructions for receiving the joint CSI report including an indication of the selected one of the first PMI or the second PMI.

In some examples of the method, apparatuses, and non-transitory computer-readable medium described herein, the first PMI and the second PMI may have a same number of columns corresponding to a jointly selected RI.

Some examples of the method, apparatuses, and non-transitory computer-readable medium described herein may further include operations, features, means, or instructions for transmitting one or more phase tracking reference signals over one or more layers corresponding to the one or more Us of the joint CSI report.

In some examples of the method, apparatuses, and non-transitory computer-readable medium described herein, transmitting the control message may include operations, features, means, or instructions for transmitting the control message including an indication of a single reference signal resource associated with the set of TCI states, where the single reference signal resource may be associated with a set of reference signal port groups, each reference signal port group of the set of reference signal port groups corresponding to one of the set of TCI states.

In some examples of the method, apparatuses, and non-transitory computer-readable medium described herein, transmitting the control message may include operations, features, means, or instructions for transmitting the control message including an indication of a set of reference signal resources, each reference signal resource of the set of reference signal resources corresponding to one of the set of TCI states.

In some examples of the method, apparatuses, and non-transitory computer-readable medium described herein, receiving the joint CSI report may include operations, features, means, or instructions for receiving the one or more Us in a first part of the joint CSI report, the first part of the joint CSI report having a fixed size.

In some examples of the method, apparatuses, and non-transitory computer-readable medium described herein, receiving the joint CSI report may include operations, features, means, or instructions for receiving the one or more LIs in a second part of the joint CSI report, the second part of the joint CSI report having a variable size.

In some examples of the method, apparatuses, and non-transitory computer-readable medium described herein, receiving the joint CSI report may include operations, features, means, or instructions for receiving the joint CSI report including a single PMI corresponding to all ports or a set of ports associated with two or more reference signals, the two or more reference signals including the reference signal.

In some examples of the method, apparatuses, and non-transitory computer-readable medium described herein, receiving the joint CSI report may include operations, features, means, or instructions for receiving the joint CSI report including a single PMI corresponding to a port-to-port sum of respective pluralities of ports associated with two or more reference signals, the two or more reference signals including the reference signal.

In some examples of the method, apparatuses, and non-transitory computer-readable medium described herein, the joint CSI reporting configuration includes a field indicating the quantity of the one or more LIs to be included in the joint CSI report, the quantity corresponding to the SFN communication scheme.

In some examples of the method, apparatuses, and non-transitory computer-readable medium described herein, transmitting the control message may include operations, features, means, or instructions for transmitting the control message via RRC signaling, a MAC-CE, DCI, or any combination thereof.

In some examples of the method, apparatuses, and non-transitory computer-readable medium described herein, the set of SFN communication schemes include a first SFN communication scheme in which each demodulation reference signal and each data layer of a data transmission may be associated with a single TCI state, a second SFN communication scheme in which each demodulation reference signal port and each data layer of the data transmission may be associated with the set of TCI states, a third SFN communication scheme in which each data layer of the data transmission may be associated with the set of TCI states and in which each demodulation reference signal port may be associated with one of the set of TCI states, or any combination thereof.

In some examples of the method, apparatuses, and non-transitory computer-readable medium described herein, the set of TCI states include a first TCI state and a second TCI state, and where the first TRP applies the first TCI state and the second TRP applies the second TCI state.

### BRIEF DESCRIPTION OF THE DRAWINGS

FIGS. 1 and 2 illustrate examples of wireless communications systems that support techniques for joint channel state information (CSI) reporting for multiple transmission and reception point (TRP) communication schemes in accordance with aspects of the present disclosure.

FIG. 3 illustrates examples of multi-TRP communication schemes that support techniques for joint CSI reporting in accordance with aspects of the present disclosure.

FIG. 4 illustrates examples of multiple TRP communication schemes that support techniques for joint CSI reporting in accordance with aspects of the present disclosure.

FIG. 5 illustrates an example of a CSI resource configuration that supports techniques for joint CSI reporting for multiple TRP communication schemes in accordance with aspects of the present disclosure.

FIGS. 6A and 6B illustrate examples of multiple TRP communication schemes that support techniques for joint CSI reporting in accordance with aspects of the present disclosure.

FIG. 7 illustrates examples of reported precoding matrix indicators (PMIs) that support techniques for joint CSI reporting for multiple TRP communication schemes in accordance with aspects of the present disclosure.

FIG. 8 illustrates an example of a process flow that supports techniques for joint CSI reporting for multiple TRP communication schemes in accordance with aspects of the present disclosure.

FIGS. 9 and 10 show block diagrams of devices that support techniques for joint CSI reporting for multiple TRP communication schemes in accordance with aspects of the present disclosure.

FIG. 11 shows a block diagram of a communications manager that supports techniques for joint CSI reporting for multiple TRP communication schemes in accordance with aspects of the present disclosure.

FIG. 12 shows a diagram of a system including a device that supports techniques for joint CSI reporting for multiple TRP communication schemes in accordance with aspects of the present disclosure.

FIGS. 13 and 14 show block diagrams of devices that support techniques for joint CSI reporting for multiple TRP communication schemes in accordance with aspects of the present disclosure.

FIG. 15 shows a block diagram of a communications manager that supports techniques for joint CSI reporting for multiple TRP communication schemes in accordance with aspects of the present disclosure.

FIG. 16 shows a diagram of a system including a device that supports techniques for joint CSI reporting for multiple TRP communication schemes in accordance with aspects of the present disclosure.

FIGS. 17 through 24 show flowcharts illustrating methods that support techniques for joint CSI reporting for multiple TRP communication schemes in accordance with aspects of the present disclosure.

### DETAILED DESCRIPTION

In some wireless communications systems, such as in multi-transmission and reception point (TRP) systems, a user equipment (UE) may communicate with multiple TRPs. For example, the UE may receive joint transmissions from the multiple TRPs. In some cases, the multiple TRPs may increase spectral efficiency by employing a multi-TRP communication scheme, such as a single frequency network (SFN) communication scheme, in which the multiple TRPs may transmit to the UE over a same frequency resource according to different transmission configuration indicator (TCI) states. As such, the multiple TRPs may jointly transmit to the UE and consume fewer resources than would be otherwise used in cases in which the multiple TRPs refrained from performing such a multi-TRP communication scheme. In some cases, the multiple TRPs may employ a multi-TRP communication scheme to jointly transmit, to the UE, over a data channel associated with two or more reference signals. For example, each of the multiple TRPs may transmit a channel state information (CSI) reference signal (CSI-RS) to the UE according to different TCI states and may transmit an over an associated data channel according to a multi-TRP communication scheme. The UE, based on receiving the two or more CSI-RSs from the multiple TRPs, may generate a joint CSI report based on the two or more CSI-RSs (e.g., based on a channel quality determined based on measuring the two or more CSI-RSs). In some cases, however, the number or quantity of CSI parameters to be included in the CSI report may depend on which multi-TRP communication scheme is employed by the multiple TRPs, which may be unknown by the UE.

In some implementations of the present disclosure, multi-TRP systems may provide signaling to indicate, to the UE, which multi-TRP communication scheme the multiple TRPs will employ for the transmission over the data channel associated with the two or more reference signals (e.g., CSI-RSs or tracking reference signals (TRSs), among other examples) to the UE. In some examples, the UE may receive the indication of which multi-TRP communication scheme is being employed by the multiple TRPs via a control message that may include an explicit indication of the multi-TRP communication scheme to be used by the multiple TRPs. Additionally or alternatively, the control message may include an indication of a number of CSI parameters to be included in the CSI report. Further, in some examples, the control message may indicate a set of multi-TRP communication schemes and the UE may generate the CSI report based on a selected multi-TRP communication scheme from the indicated set of multi-communication schemes. In some aspects, the selected multi-TRP communication scheme may be the multi-TRP communication scheme of the set of multi-TRP communication schemes that achieves a greatest spectral efficiency.

In some examples, such as in examples in which the multi-TRP communication scheme is an SFN communication scheme, the control message may indicate a quantity of one or more parameters to be included in the CSI report. For example, the control message may indicate a quantity of layer indicators (LIs) to be included in the CSI report based on indicating an SFN communication scheme or based on including an indication of the quantity of LIs in the control message. In other words, the indication of the quantity of LIs may be implicitly indicated by the indication of the SFN communication scheme (e.g., the SFN communication scheme employed by the multiple TRPs may correspond to a quantity of LIs) or may be explicitly indicated in the control message. In examples in which the quantity of LIs to be included in the CSI report is explicitly indicated, for instance, the UE may receive the control message indicating that a single LI is to be included in the CSI report or that two LIs are to be included in the CSI report, among other examples. Additionally or alternatively, the control message may indicate one or more resources (and how such resources are configured) over which the multiple TRPs may transmit the two or more reference signals or provide other configuration for the generation of the CSI report, such as whether the CSI report is to be generated as a two-part CSI report and, if so, what information (e.g., which CSI parameters, if any) the UE is to include in each part of the CSI report.

Some implementations of the subject matter described in this disclosure can be implemented to realize one or more of the following potential advantages. In some implementations, the described techniques can provide for additional signaling that may enable the UE to accurately generate the CSI report based on the multi-TRP communication scheme, such as the SFN communication scheme, used by the multiple TRPs to transmit, to the UE, over a data channel associated with the two or more reference signals. As such, the UE may provide a quantity of CSI parameters to one of the TRPs (e.g., a serving base station) via the CSI report based on the multi-TRP communication scheme used, which may provide a more complete reporting of the channel conditions between the UE and the multiple TRPs from which the UE received a reference signal. Accordingly, based on implementing the techniques described herein, the multi-TRP system including the UE and the multiple TRPs may achieve the greater spectral efficiency associated with the use of multi-TRP and SFN communication schemes while also increasing the likelihood of complete channel knowledge between the UE and the multiple TRPs, which may result in a greater likelihood for communication between the UE and the multiple TRPs, improved network planning and scheduling, and greater throughput, among other examples.

Aspects of the disclosure are initially described in the context of wireless communications systems. Aspects of the disclosure are additionally illustrated by and described with reference to various communication schemes, CSI reporting configurations, and Us associated with reported precoding matrix indicator (PMIs). Aspects of the disclosure are further illustrated by and described with reference to apparatus diagrams, system diagrams, and flowcharts that relate to techniques for joint CSI reporting for SFN communication schemes.

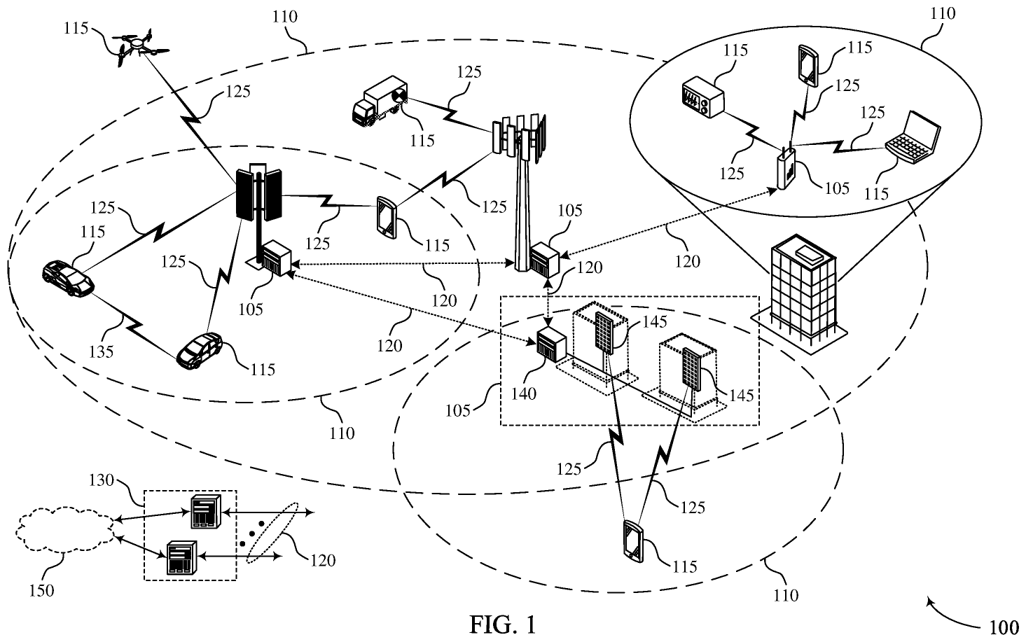

FIG. 1 illustrates an example of a wireless communications system 100 that supports techniques for joint CSI reporting for multiple TRP communication schemes in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Af) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively or additionally, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, sometimes in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some cases, the wireless communications system 100 may include multiple TRPs that may jointly communicate with a UE 115. For example, a base station 105 may function as a TRP (or as multiple TRPs) and the UE 115 may receive joint transmissions from multiple TRPs. For example, the UE 115 may receive joint transmissions of two or more reference signals from the multiple TRPs. In some cases, the multiple TRPs may perform the joint transmissions of the two or more reference signals to the UE 115 according to a multi-TRP communication scheme, such as an SFN communication scheme, to increase the spectral efficiency of the communication between the UE 115 and the multiple TRPs. For example, based on employing a multi-TRP communication scheme, the multiple TRPs may perform join transmissions to the UE 115 over a same resource using different TCI states.

In such cases in which the multiple TRPs transmit the two or more reference signals to the UE 115 according to the multi-TRP communication scheme, the quantity of CSI parameters to be reported in a CSI report corresponding to the two or more reference signals may depend on the multi-TRP communication scheme used by the multiple TRPs. For example, if the multiple TRPs use a first multi-TRP communication scheme, a first quantity of CSI parameters may be included in the CSI report for complete channel reporting while if the multiple TRPs use a second multi-TRP communication scheme, a second quantity of CSI parameters different from the first quantity of CSI parameters may be included in the CSI report for complete channel reporting. In some cases, however, the UE 115 may be unaware of the multi-TRP communication scheme used by the multiple TRPs and, as such, may be unable to determine how many CSI parameters to report in the CSI report corresponding to the two or more reference signals received from the multiple TRPs.

In some implementations of the present disclosure, the UE 115 may receive a control message (e.g., from one or more of the TRPs, such as a serving base station 105) that indicates the multi-TRP communication scheme, such as an SFN communication scheme, that the multiple TRPs use to perform the joint transmission of the two or more reference signals to the UE 115. In some examples, the control message may include an explicit indication of the multi-TRP communication scheme. For example, the control message may indicate a mode that corresponds to the multi-TRP communication scheme explicitly. In some other examples, the control message may indicate a quantity of CSI parameters that are to be included in the CSI report. For example, the control message may indicate a mode that corresponds to a configuration that determines the quantity of CSI parameters that are to be included in the CSI report.

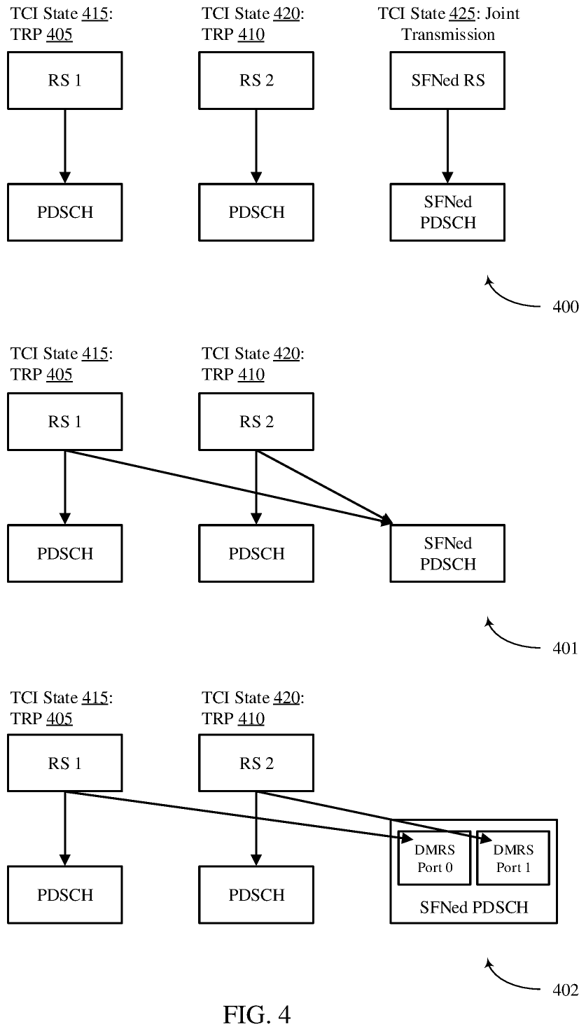

In some examples, for instance, the control message may provide an indication of a quantity of one or more CSI parameters that are to be included in the CSI report. For example, the control message may indicate (e.g., either explicitly via one or more bits or implicitly by indicating the multi-TRP communication scheme) a quantity of LIs that are to be included in the CSI report, where each of the quantity of LIs may correspond to a column of a PMI that is also included in the CSI report. For instance, in examples in which the UE 115 reports two PMIs (each corresponding to a different TCI state, such that the multiple TRPs may include two TRPs) and the control message indicates that a single LI is to be included in the CSI report, the single LI may indicate a same column across both PMIs that corresponds to a strongest layer measured by the UE 115 (e.g., in an SFN communication scheme 1, as described in more detail with reference to FIG. 4) or may indicate a column of one of the two PMIs (i.e., not both) that corresponds to the strongest layer measured by the UE 115 (e.g., in an SFN communication scheme 2, as also described in more detail with reference to FIG. 4).

Alternatively or additionally, in examples in which the UE 115 reports two PMIs and the control message indicates that two LIs are to be included in the CSI report, each of the two Us may indicate a column of one of the two PMIs such that each indicated column corresponds to a strongest layer of the respectively associated TCI state (e.g., in an SFN communication scheme 2). For example, a first LI may indicate a column of a first PMI associated with a first TCI state. As such, the indicated column of the first PMI may correspond to a strongest layer of the first TCI state. Similarly, a second LI may indicate a column of a second PMI associated with a second TCI state. As such, the indicated column of the second PMI may correspond to a strongest layer of the second TCI state. In some aspects, the number of bits for each LI in the CSI report may depend on the selected RI value. For instance, the number of bits that the UE 115-a may include in the CSI report to indicate an LI may depend on or may be equal to [log₂(RI)].

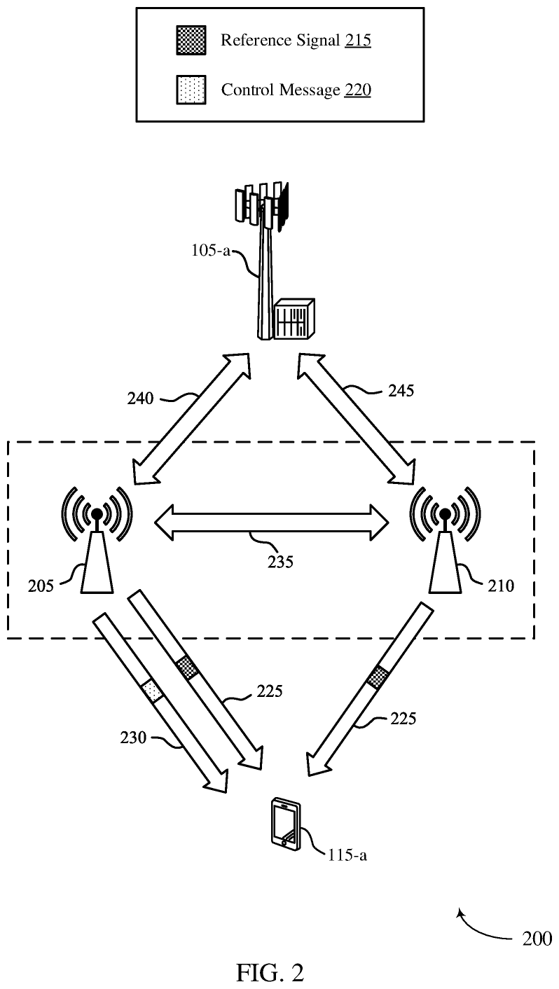

FIG. 2 illustrates an example of a wireless communications system 200 that supports techniques for joint CSI reporting for multiple TRP communication schemes in accordance with aspects of the present disclosure. In some examples, the wireless communications system 200 may implement aspects of the wireless communication system 100. For example, the wireless communication system 200 may include a UE 115-a, a base station 105-a, a TRP 205, and a TRP 210, which may be examples of corresponding devices described herein, including with reference to FIG. 1. In some examples, the UE 115-a may receive a control message 220 indicating a multi-TRP communication scheme, such as an SFN communication scheme, that the TRP 205 and the TRP 210 may use to perform a joint transmission of two reference signals 215 and the UE 115-a may use the indication of the multi-TRP communication scheme to generate a CSI report based on the reference signals 215.

In some cases, the TRP 205 and the TRP 210 may perform joint transmissions to the UE 115-a according to a multi-TRP communication scheme by applying two different TCI states. For example, the TRP 205 may apply a first TCI state and the TRP 210 may apply a second TCI state. In some examples, the TRP 205 and the TRP 210 may perform the joint transmissions over a same resource (such as over a same set of REs and OFDM symbols) based on transmitting different layers (e.g., spatial layers) with different TCI states. Such a multi-TRP communication scheme may be referred as a space-division multiplexing (SDM) communication scheme. Additionally or alternatively, the TRP 205 and the TRP 210 may perform the joint transmissions over different frequency resources but overlapping time resources (such as over different sets of REs but over a same set of OFDM symbols) based on transmitting different sets of frequency-domain resources (e.g., REs) with different TCI states. Such a multi-TRP communication scheme may be referred as an FDM communication scheme.

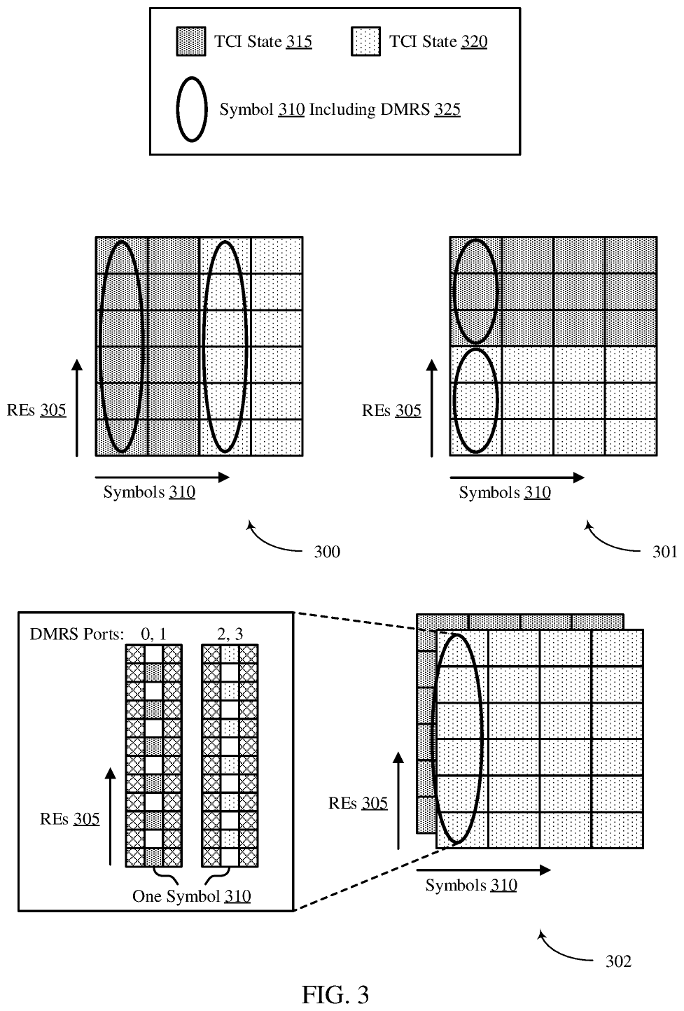

Additionally or alternatively, the TRP 205 and the TRP 210 may perform the joint transmissions over different time resources but overlapping frequency resources (such as over different sets of OFDM symbols but over a same set of REs) based on transmitting different sets of time-domain resources (e.g., OFDM symbols, slots, or mini-slots) with different TCI states. Such a multi-TRP communication scheme may be referred to as a TDM communication scheme. Additional details relating to such multi-TRP communication schemes are described herein, including with reference to FIG. 3.

In some examples, the TRP 205 and the TRP 210 may perform joint transmissions to the UE 115-a using an SFN communication scheme, which may be a type of multi-TRP communication scheme in which the physical downlink shared channel (PDSCH) 225 over which the TRP 205 may transmit and over which the TRP 210 may transmit may include the same frequency bands or channel (e.g., the TRP 205 and the TRP 210 may transmit a same transmission over the same PDSCH 225 in an SDM, FDM, TDM, SFN, or the like, manner, where the PDSCH transmission is associated with two TCI states corresponding to the two TRPs). In other words, the PDSCH 225 may be or be part of an “SFNed” PDSCH. The TRP 205 and the TRP 210 may perform joint transmissions to the UE 115-a according to various types of SFN communication schemes, such as an SFN communication scheme 0, an SFN communication scheme 1, or an SFN communication scheme 2. Additional details relating to such various types of SFN communication schemes are described herein, including with reference to FIG. 4.

As described herein, a quantity of CSI parameters to be included in a CSI report corresponding to the reference signals 215 may depend on the multi-TRP communication scheme, or the SFN communication scheme, according to which the TRP 205 and the TRP 210 transmit over the PDSCH 225. In some cases, however, the UE 115-a may be unaware of which multi-TRP communication scheme is used by the TRP 205 and the TRP 210. As such, the UE 115-a may sub-optimally or erroneously generate a CSI report because the UE 115-a may be unaware of how many CSI parameters to include in the CSI report (e.g., as a result of being unaware of the multi-TRP communication scheme used by the TRP 205 and the TRP 210).

For example, the TRP 205 and the TRP 210 may determine the multi-TRP communication scheme to be used for transmitting the reference signals 215 based on exchanging signaling with each other via a communication link 235 or based on exchanging signaling with a base station 105-a, which may function as or be connected to a core network entity, via a communication link 240 and a communication link 245, respectively, and none of the TRP 205, the TRP 210, or the base station 105-a may support signaling for providing an indication of the multi-TRP communication scheme to the UE 115-a. Such sub-optimal or erroneous CSI reporting by the UE 115-a may result in incomplete knowledge of the channels over which the TRP 205 and the TRP 210 may communicate with the UE 115-a, which may in turn result in poor scheduling decisions and sub-optimal network planning.

In some implementations of the present disclosure, the UE 115-a may receive a control message 220 over a physical downlink control channel (PDCCH) 230 indicating the multi-TRP communication scheme according to which the TRP 205 and the TRP 210 will transmit over the PDSCH 225. As such, the UE 115-a may be aware of the multi-TRP communication scheme used by the TRP 205 and the TRP 210 and the UE 115-a may generate the CSI report (e.g., a joint CSI report or hypothesis) accordingly (e.g., including a quantity of CSI parameters corresponding to the indicated multi-TRP communication scheme). In some examples, the control message 220 may include an indication of a mode for reporting CSI, where the mode may correspond to a multi-TRP communication scheme (which may also be referred to as a PDSCH scheme) explicitly or may correspond to a configuration that determines the number of reported CSI parameters. For instance, in examples in which the mode corresponds to a multi-TRP communication scheme explicitly, the mode may correspond to one of an SDM communication scheme, a TDM communication scheme, an FDM communication scheme, a coherent joint transmission (CJT) communication scheme, or a type of an SFN communication scheme.

Alternatively or additionally, in examples in which the mode corresponds to a configuration that determines the number of reported CSI parameters, the UE 115-a, using the configuration corresponding to the indicated mode, may determine a number of PMIs, rank indicators (RIs), Us, and channel quality indicators (CQIs) that are to be included in the CSI report corresponding to the mode. Likewise, the UE 115-a may determine an assumption to determine (e.g., measure) the number of PMIs, RIs, LIs, and CQIs that are to be included in the CSI report. For example, the control message 220 may indicate a mode corresponding to a configuration according to which the UE 115-a may determine to report separate PMIs, a joint RI, and one LI (which may correspond to an SFN communication scheme 1). As such, the UE 115-a may determine the separate PMIs, the joint RI, and the one LI and include the determined separate PMIs, the joint RI, and the one LI in the CSI report.

Alternatively or additionally, the UE 115-a may be configured with a set of modes (as opposed to configured with a single mode) where each mode of the set of modes may correspond to a different CSI hypothesis (e.g., a hypothesis of the multi-TRP communication scheme employed by the TRP 205 and the TRP 210). In some aspects, the set of modes may be a subset of a set of modes that the UE 115-a is capable of reporting for. In such aspects, the UE 115-a may signal or otherwise indicate the set of one or more modes that the UE 115-a is capable of reporting for to one of the TRP 205, the TRP 210, or the base station 105-a through UE capability signaling. As such, based on receiving the indication of the set of modes that the UE 115-a is capable of reporting for, the TRP 205 and the TRP 210 may determine to configure the subset of the set of modes that the UE 115-a is capable of reporting for at the UE 115-a (e.g., and avoid configuring a mode at the UE 115-a that the UE 115-a is uncapable of reporting for).

In some cases, the TRP 205 and the TRP 210 may determine the subset of modes based on communicating with each other via the communication link 235 or based on communicating with the base station 105-a via the communication link 240 and the communication link 245, respectively. For example, the UE 115-a may report the set of modes that the UE 115-a is capable of reporting for to one of the TRP 205, the TRP 210, or the base station 105-a and the TRP 205, the TRP 210, and the base station 105-a may exchange signaling to support mutual or shared knowledge of the UE capability. Upon achieving mutual or shared knowledge of the UE capability, and although shown as being transmitted by the TRP 205, any one of the TRP 205, the TRP 210, or the base station 105-a may transmit the control message 220 to the UE 115-a indicating the subset of modes.

In some examples, the UE 115-a may receive the indication or configuration of the subset of modes and may generate the CSI report based on a mode of the subset of modes that the UE 115-a determines is a “best mode” (e.g., a “best” CSI hypothesis). For example, each mode of the subset of modes may correspond to a CSI hypothesis (which may correspond to or be associated with a respective multi-TRP communication scheme) and the UE 115-a may evaluate each of the CSI hypotheses according to the different multi-TRP communication schemes. In some implementations, the UE 115-a may evaluate the CSI hypotheses according to the different multi-TRP communication schemes based on a spectral efficiency. For example, the UE 115-a may determine a spectral efficiency metric for each mode of the subset of modes and determine which mode (e.g., which CSI hypothesis) achieves the greatest spectral efficiency metric (i.e., the highest spectral efficiency). Additionally or alternatively, the UE 115-a may use various other metrics to evaluate each mode of the subset of modes and to determine which mode to select.

Upon determining the mode of the subset of modes configured at the UE 115-a according to the evaluation employed by the UE 115-a, the UE 115-a may generate the CSI report based on the determined mode. In other words, the UE 115-a may report CSI corresponding to the “best” hypothesis. In some examples, the UE 115-a may include, within the CSI report, an indication of the determined mode (or the multi-TRP communication scheme corresponding to the determined mode) to which the reported CSI corresponds. For example, the UE 115-a may include the indication of the determined mode as part of a CSI resource indicator (CRI) field. Alternatively or additionally, the UE 115-a may include the indication of the determined mode in addition to the CRI indication, such as in a “mode indicator” field in the CSI report. In such examples in which the control message 220 provides the subset of modes from which the UE 115-a may select for the purposes of CSI reporting and in examples in which the UE 115-a may transmit a two-part CSI report (e.g., a CSI report partitioned into a first part of fixed size and a second part of variable size), the UE 115-a may include the selected or determined mode in the first part of the CSI report and the CSI parameters corresponding to the selected or determined mode in the second part of the CSI report. As such, the first part of the CSI report may have a fixed size because a quantity of bits allocated for an example “mode indicator” field may be fixed and the second part of the CSI report may have a variable size because a quantity of the CSI parameters included in the second part may vary based on the selected or determined mode.

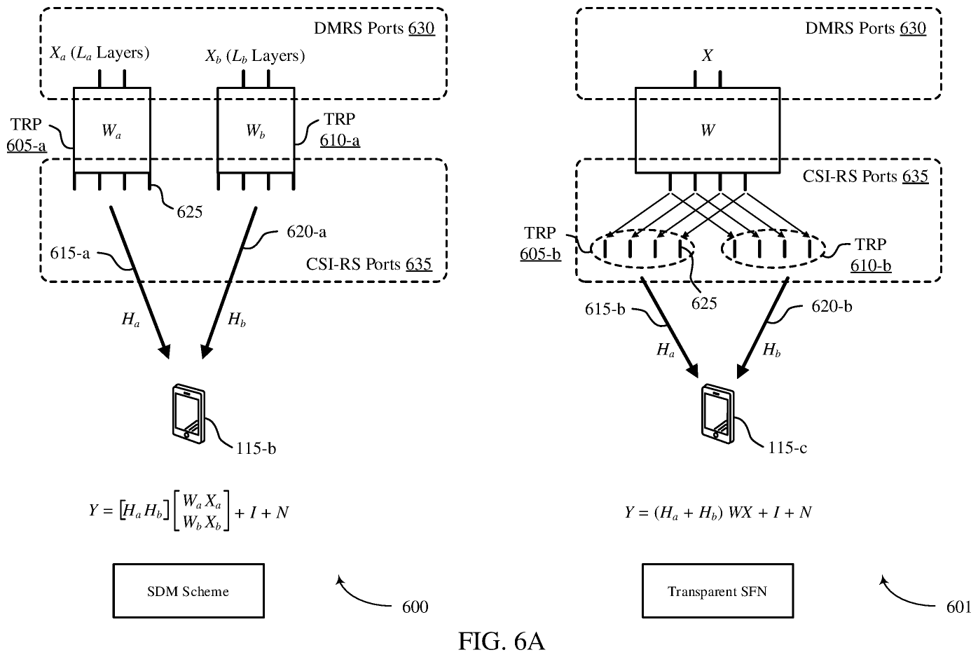

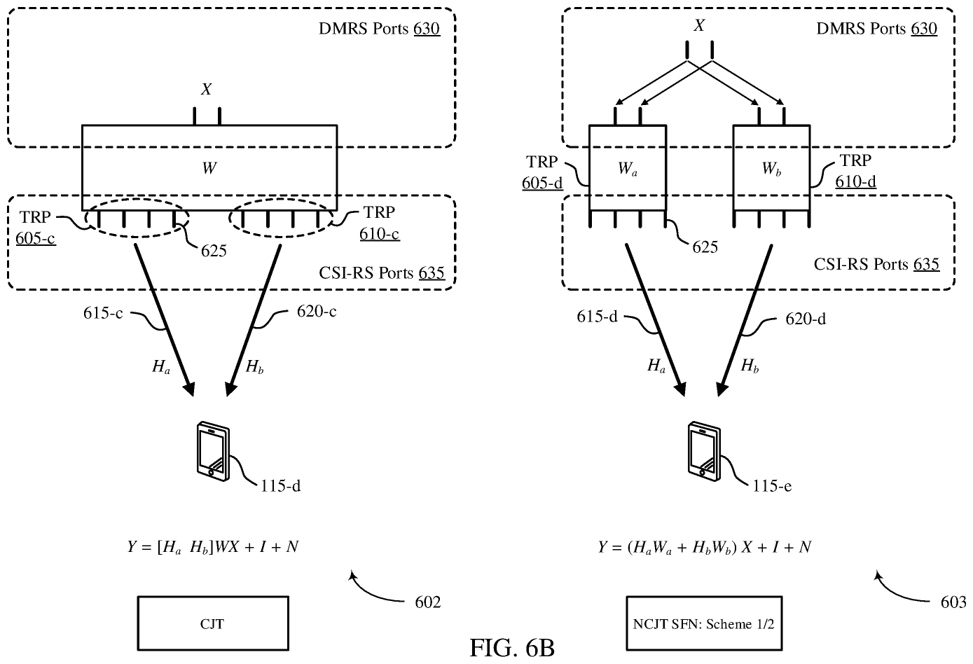

In some other implementations of the present disclosure, the control message 220 may indicate an SFN communication scheme to be used by the TRP 205 and the TRP 210 to transmit over the PDSCH 225 to the UE 115-a and may indicate a quantity of one or more parameters, such as Us, that the UE 115-a is to include in the corresponding joint CSI report. For instance, in examples in which the TRP 205 applies the first TCI state and the TRP 210 applies the second TCI state to transmit the reference signals 215 to the UE 115-a, the TRP 205 and the TRP 210 transmit over the associated PDSCH 225 in an SFN manner, and there may be separate CSI-RS resources or CSI-RS port groups for CSI-RS transmission, the UE 115-a may generate the joint CSI report (e.g., a CSI report across the first TCI state and the second TCI state) including two PMIs based on the SFN communication scheme of the PDSCH 225. The two PMIs may include a first PMI corresponding to the first TCI state and a second PMI corresponding to the second TCI state, and both the first PMI and the second PMI may be jointly determined based on the assumption or indication of the SFN communication scheme used by the TRP 205 and the TRP 210. For example, both PMIs may have the same number of columns corresponding to a jointly selected rank (which the UE 115-a may report as one RI), as described in more detail herein, including with reference to FIGS. 6A and 6B.

In some examples, the UE 115-a may include a joint CQI in the CSI report corresponding to the jointly determined PMIs, the RI, and the assumed or indicated SFN communication scheme and may include one or more Us to be used with reference to one or both of the reported PMIs. A quantity of the one or more Us that the UE 115-a may include in the CSI report may depend on the SFN communication scheme used by the TRP 205 and the TRP 210 but, in some cases, the UE 115-a may have some flexibility on the quantity based on how the Us are configured to reference one or both of the reported PMIs. As such, to reduce ambiguity associated with the one or more reported Us (e.g., to increase certainty regarding how a reported LI references one or both of the two PMIs), the control message 220 may indicate the quantity of the one or more LIs that the UE 115-a is to include in the CSI report.

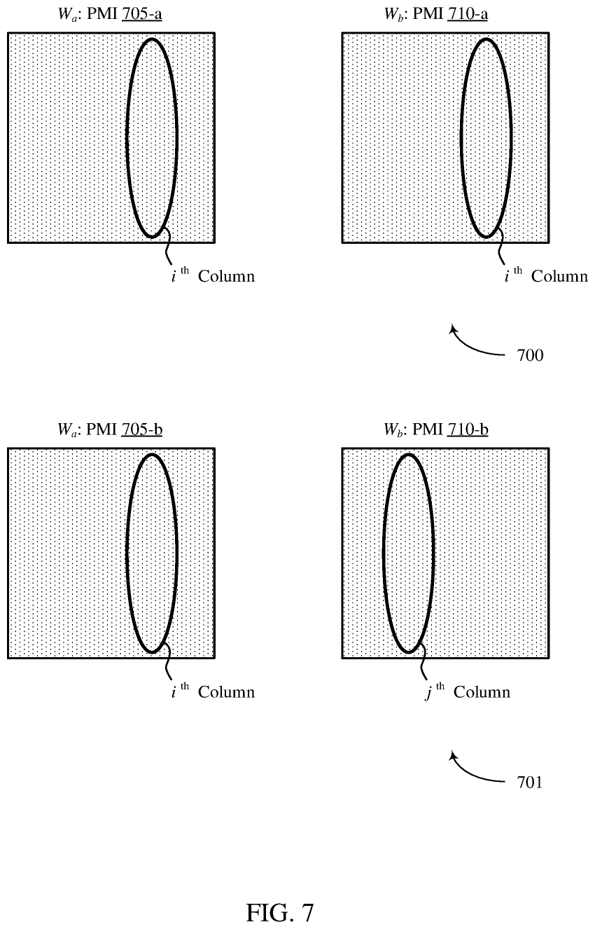

For example, the UE 115-a may report either one LI indicating a strongest layer corresponding to a same selected column across both PMIs, one LI indicating a strongest layer corresponding a selected column of one of the PMIs (but not both), or two LIs indicating respective strongest layers corresponding to respective selected columns of the two PMIs. In other words, in examples in which the UE 115-a reports one LI indicating a strongest layer corresponding to a same selected column across both PMIs, the LI may indicate an i^{th} column of both the first PMI and the second PMI. Alternatively or additionally, in examples in which the UE 115-a reports two Us indicating respective strongest layers corresponding to respective selected columns of the two PMIs, a first LI may indicate an i^{th} column of the first PMI and a second LI may indicate a j^{th} column of the second PMI (where i may or may not be equal to j). Additional details relating to the correspondence between LIs and reported PMIs are described herein, including with reference to FIG. 7.

In some examples, the UE 115-a may determine the quantity of LIs for the UE 115-a to report based on an explicit configuration or indication in the control message 220 or based on the configured or indicated mode (e.g., based on which SFN communication scheme is used). For example, the UE 115-a may determine to report one LI based on either the inclusion of an indication of the quantity of LIs that are to be reported in the control message 220 or based on the indication of an SFN communication scheme 1 in the control message 220. In such examples in which the TRP 205 and the TRP 210 transmit according to the SFN communication scheme 1 and in which the UE 115-a reports one LI, the TRP 205, the TRP 210, or the base station 105-a may transmit a phase-tracking reference signal (PT-RS) in the layer indicated by the one LI (which may correspond to an i^{th} column of both the first PMI and the second PMI). In other words, a demodulation reference signal (DMRS) port that is associated with the PT-RS port is transmitted on the layer indicated by the LI (e.g., a strongest layer). In such examples, both the PT-RS port and the associated DMRS port are associated with both TCI states. The TRP 205, the TRP 210, or the base station 105-a, based on transmitting the PT-RS in the layer indicated by the one LI, may achieve relatively high reception performance of the PT-RS such that the UE 115-a may likely obtain a relatively accurate phase noise estimation result when receiving the PT-RS.

Alternatively or additionally, the UE 115-a may determine to report two LIs based on either the inclusion of an indication of the quantity of LIs that are to be reported in the control message 220 or based on the indication of an SFN communication scheme 2 in the control message 220. In such examples in which the TRP 205 and the TRP 210 transmit according to the SFN communication scheme 2 and in which the UE 115-a reports two Us, the TRP 205, the TRP 210, or the base station 105-a may transmit a first PT-RS in a layer indicated by a first LI. As such, a first DMRS port corresponding to the first TCI state that is associated with a first PT-RS port of the first PT-RS is transmitted on the strongest layer corresponding to the first TCI state. Similarly, the TRP 205, the TRP 210, or the base station 105-a may transmit a second PT-RS in a layer indicated by a second LI. As such, a second DMRS port corresponding to the second TCI state that is associated with a second PT-RS port of the second PT-RS is transmitted on the strongest layer corresponding to the second TCI state. In such examples, the first PT-RS port and the first DMRS port may be associated with the first TCI state and the second PT-RS port and the second DMRS port may be associated with the second TCI state. Accordingly, the UE 115-a may receive the first PT-RS and the second PT-RS and estimate or otherwise determine phase noise based on the received PT-RSs.

Alternatively or additionally, the UE 115-a may determine to report one LI based on either the inclusion of an indication of the quantity of Us that are to be reported in the control message 220 or based on the indication of an SFN communication scheme 2 in the control message 220. In such examples in which the TRP 205 and the TRP 210 transmit according to the SFN communication scheme 2 and in which the UE 115-a reports one LI, the one LI may correspond to one of the two reported PMIs (and not both), indicating a strongest layer for the one PMI. The one PMI that the reported LI references (e.g., the PMI for which the LI indicates a column corresponding to a strongest layer) may be a fixed PMI or may be selected by the UE 115-a. In examples in which the PMI is fixed, the UE 115-a may determine the one PMI that the LI references based on a pre-configuration or based on signaling. In some aspects, the fixed PMI may be the PMI associated with the first TCI state (e.g., the first PMI). In some other aspects, the fixed PMI may be the PMI associated with the second TCI state (e.g., the second PMI).

In examples in which the PMI is selected by the UE 115-a, the UE 115-a may select the PMI corresponding to the stronger TRP or TCI state among the two PMIs. For example, the UE 115-a may determine which of the TRP 205 or the first TCI state and the TRP 210 or the second TCI state provides the greater signal strength and may select the PMI corresponding to the TRP or TCI state that provides the greater signal strength. In such examples, the UE 115-a may include an indication of the selected PMI within the CSI report. For example, the UE 115-a may indicate (as part of the CSI report) whether the reported LI corresponds to the first PMI associated with the first TCI state or corresponds to the second PMI associated with the second TCI state.

In either example (e.g., regardless of whether the PMI that the reported LI references is fixed or selected by the UE 115-a), the TRP 205, the TRP 210, or the base station 105-a may transmit one PT-RS in the layer indicated by the LI. In other words, the TRP 205, the TRP 210, or the base station 105-a may transmit one DMRS port corresponding to the TCI state associated with the PT-RS port that corresponds to the same TCI state as the fixed or selected PMI that the LI references. In such examples, both the PT-RS port and the associated DMRS port are associated with one of the TCI states (e.g., the TCI state associated with the fixed or selected PMI). Accordingly, the UE 115-a may estimate or otherwise determine phase noise based on the received PT-RS.

In some aspects, the number of bits for the LI in the CSI report may depend on the selected RI value. For instance, the number of bits that the UE 115-a may include in the CSI report to indicate an LI may depend on or may be equal to [log₂(RI)]. Further, in some cases, the UE 115-a may transmit the LI or the LIs as part of a two-part CSI report. In such cases, the UE 115-a may include the one or more LIs within a first part of the CSI report or within a second part of the CSI report. In examples in which the UE 115-a includes the one or more LIs within the first part of the CSI report (which may have a fixed size), the bitwidth (e.g., the number of bits that the UE 115-a may include in the CSI report to indicate an LI) of an LI may be fixed and, as such, may not be a function of the indicated RI. In some aspects, this may reduce complexity at the UE 115-a. Alternatively or additionally, in examples in which the UE 115-a includes the one or more LIs within the second part of the CSI report (which may have a variable size), the bitwidth of an LI may be a function of the indicated RI. In some aspects, this may reduce overhead associated with the CSI report by supporting the use of an appropriate number of bits to indicate the one or more LIs. For example, if RI=2, the UE 115-a may indicate each of the one or more LIs by 1 bit. For further example, if RI=4, the UE 115-a may indicate each of the one or more LIs by 2 bits. In both examples (e.g., regardless of whether the one or more LIs are included in the first part or the second part of the CSI report), the UE 115-a may include the RI in the first part of the CSI report.

To receive the reference signals 215 from the TRP 205 and the TRP 210, the UE 115-a may monitor one or more resources, such as CSI-RS resources, over which the TRP 205 and the TRP 210 may transmit the reference signals 215. In some implementations, the UE 115-a may receive an indication of the one or more resources over which the TRP 205 and the TRP 210 may transmit the reference signals 215 via the control message 220. In some examples, for instance, the control message 220 may indicate one resource (e.g., one CSI-RS resource) over which the UE 115-a may receive the reference signals 215. In such examples, the one resource may be associated with both the first TCI state and the second TCI state and may include two CSI-RS port groups corresponding to the two TCI states. In some aspects, the two CSI-RS port groups may belong to different code-division multiplexing (CDM) groups.

In some other examples, the control message 220 may indicate two different resources (e.g., two CSI-RS resources) over which the UE 115-a may receive the reference signals 215. In such examples, a first resource may be associated with the first TCI state and the second resource may be associated with the second TCI state. As such, the UE 115-a may expect to receive the reference signal 215 from the TRP 205 over the first resource associated with the first TCI state and may expect to receive the reference signal 215 from the TRP 210 over the second resource associated with the second TCI state. Such configuration of one resource associated with multiple TCI states or multiple resources each associated with one TCI state may be applicable for both SDM communication schemes and SFN communication schemes.

In some implementations, the quantity of PMIs that the UE 115-a may include in the CSI report may be variable in some SFN communication schemes. For example, in an SFN communication scheme 1, which may include a CJT communication scheme or a transparent SFN communication scheme (as described in more detail with reference to FIGS. 6A and 6B), the UE 115-a may determine to report one PMI or two PMIs based on how the UE 115-a is configured to consider the combined channel (e.g., a combination of the PDSCH 225 over which both the TRP 205 and the TRP 210 may transmit in an SFN manner). For example, in an SFN communication scheme 1, each DMRS port and each data layer may be associated with both the first TCI state and the second TCI state (as described in more detail with reference to FIG. 4) and if the UE 115-a is configured with two resources (e.g., two CSI-RS resources) each associated with different TCI states or one resource (e.g., one CSI-RS resource) including or otherwise associated with two CSI-RS port groups each associated with different TCI states, the UE 115-a may be configured to report one or two PMIs based on how the UE 115-a is configured to consider the combined channel. For instance, the UE 115-a may be configured to report one PMI by considering the concatenated channel (e.g., the concatenated channel [Hₐ H_{b}], determined based on the reference signals 215, corresponding to a coherent case, such as a CJT communication scheme, as shown by a communication scheme 602 in FIG. 6B). For example, the UE 115-a may determine Hₐ and H_{b} based on CSI-RS signals. The joint CSI report may correspond to a PDSCH scheme (e.g., what would be the CQI if a particular scheme is used, or what is the “best” PMI(s) for that PDSCH scheme, etc.), and may determine the CSI report (e.g., including PMI(s)) based on CSI-RS signals. In such examples in which the UE 115-a is configured to report one PMI by considering the concatenated channel, the number of CSI-RS ports (e.g., corresponding to the number of rows in a reported PMI) may be equal to the sum of a number of CSI-RS ports associated with the first TCI state and a number of CSI-RS ports associated with the second TCI state. Additional detail relating to the numbers of CSI-RS ports associated with the first TCI state and the second TCI state are described herein, including with reference to FIGS. 6A and 6B.

Alternatively or additionally, the UE 115-a may be configured to report two PMIs in a non-coherent case (such as in a non-CJT (NCJT) SFN communication scheme 1 as shown by a communication scheme 603 in FIG. 6B). In such examples in which the UE 115-a is configured to report two PMIs in a non-coherent case, the UE 115-a may determine whether to report one or two LIs based on an implicit or explicit indication in the control message 220.

Alternatively or additionally, the UE 115-a may be configured to report one PMI by considering the combined channel (e.g., the combined channel (Hₐ+H_{b}), determined based on the reference signals 215, corresponding to a transparent SFN communication scheme, as shown by a communication scheme 601 in FIG. 6A). In such examples in which the UE 115-a is configured to report one PMI by considering the combined channel, there may be a one-to-one mapping between a CSI-RS port associated with the first TCI state and a CSI-RS port associated with the second TCI state and the UE 115-a may add the estimated channel for each two corresponding CSI-RS ports based on the one-to-one mapping. For example, the UE 115-a may determine the combined channel based on adding a first estimated channel for a first CSI-RS port associated with the first TCI state to a first estimated channel for a first CSI-RS port associated with the second TCI state, adding a second estimated channel for a second CSI-RS port associated with the first TCI state to a second estimated channel for a second CSI-RS port associated with the second TCI state, and so on. In some aspects, such an addition of estimated channels for CSI-RS ports according to the one-to-one mapping between the CSI-RS ports of different TCI states may be referred to as a port-to-port sum. The UE 115-a may determine the one PMI, an RI, an LI, and a CQI based on the combined channel, such that the number of rows of the one PMI may be equal to the number of CSI-RS ports associated with the first TCI state or the number of CSI-RS ports associated with the second TCI state (e.g., the number of rows of the PMI=the number of CSI-RS ports associated with the first TCI state=the number of CSI-RS ports associated with the second TCI state).

Further, although described in the context of a single control message 220, the UE 115-a may receive one or more control messages 220 to provide the configurations or indications relating to the communication scheme-based CSI reporting configuration described herein. In some examples, the control message 220 may be sent to the UE 115-a via RRC signaling. In such examples, the multi-TRP communication schemes or modes indicating the multi-TRP communication schemes indicated by the control message 220 may be RRC configured. For example, the mode or modes indicated to the UE 115-a via the control message 220 may be RRC configured as part of a CSI report setting configuration or as part of a CSI-RS resource setting configuration.

In some other examples, the control message 220 may be sent to the UE 115-a via a MAC-CE. For example, the control message 220 may be included within a MAC-CE that also activates semi-persistent CSI reporting (e.g., the MAC-CE that activates semi-persistent CSI reporting may include an additional field to convey the contents of the control message 220), a MAC-CE that also activates semi-persistent CSI-RS transmission (e.g., the MAC-CE that activates semi-persistent CSI-RS transmission may include an additional field to convey the contents of the control message 220), or within a MAC-CE that can be used for cases (e.g., all cases) of periodic, semi-persistent, or aperiodic CSI reporting or CSI-RS resource configurations. In some other examples, the control message 220 may be sent to the UE 115-a via downlink control information (DCI), which may be applicable to cases in which aperiodic CSI reporting is employed. In such examples, the DCI may implicitly convey the contents of the control message 220 by pointing to a CSI report setting or a CSI-RS resource set through a “CSI request” field (e.g., by pointing to a corresponding trigger state). Alternatively or additionally, the DCI may explicitly convey the contents of the control message 220 via an additional DCI field.

The UE 115-a, based on implementing the described techniques, may provide more complete CSI information or a more complete picture of the channel conditions between the UE 115-a and the TRP 205 and the TRP 210. As such, the wireless communications system 200 may achieve the spectral efficiency gains resulting from the use of multi-TRP communication schemes, such as SFN communication schemes, while also providing more complete CSI information via the described techniques for communication scheme-based CSI reporting, which may result in improved scheduling decisions, improved network planning, and greater throughput, among other benefits.

FIG. 3 illustrates examples of multi-TRP communication schemes 300, 301, and 302 that support techniques for joint CSI reporting for multiple TRP communication schemes in accordance with aspects of the present disclosure. In some examples, the multi-TRP communication schemes 300, 301, and 302 may be implemented to realize aspects of the wireless communications system 100 or the wireless communications system 200. For example, multiple TRPs may employ one of the multi-TRP communication schemes 300, 301, and 302 to transmit over a PDSCH associated with two or more reference signals to a UE 115 by applying multiple TCI states and the UE 115 may generate a CSI report based on which of the multi-TRP communication schemes 300, 301, or 302 is employed by the multiple TRPs. For example, the multi-TRP communication schemes 300, 301, and 302 may illustrate joint downlink transmissions to the UE 115 from a first TRP applying a TCI state 315 and from a second TRP applying a TCI state 320.

For example, in a single-DCI based multi-TRP design, a single PDCCH (e.g., a single NR-PDCCH) may schedule a single PDSCH (e.g., a single NR-PDSCH) and various communication schemes may be applied by the multiple TRPs, such as the multi-TRP communication schemes 300, 301, and 302. In some cases, for example, as shown by the multi-TRP communication scheme 300, the multiple TRPs may apply a TDM communication scheme in which the different TRPs may transmit in different symbols 310 (which may be OFDM symbols) and overlapping REs 305. In such cases, the multiple TRPs may transmit different sets of symbols 310 (e.g., different slots or mini-slots of symbols 310) with different TCI states. For example, the first TRP may transmit a first set of symbols 310 with the TCI state 315 and the second TRP may transmit a second set of symbols 310 with the TCI state 320. In some aspects, the multiple TRPs may transmit different repetitions of the set of symbols 310 within a same slot or in different slots. Further, the first symbol 310 of each set of symbols 310 transmitted by a different TRP (and likewise transmitted according to a different TCI state) may include a DMRS 325.

In some other cases, as shown by the multi-TRP communication scheme 301, the multiple TRPs may apply an FDM communication scheme in which the different TRPs may transmit in different REs 305 during overlapping symbols 310. In such cases, the multiple TRPs may transmit different sets of REs 305 with different TCI states. For example, the first TRP may transit a first set of REs 305 with the TCI state 315 and the second TRP may transmit a second set of REs 305 with the TCI state 320. The first symbol 310 of each set of REs 305 transmitted by a different TRP (and likewise transmitted according to a different TCI state) may include a DMRS 325 (e.g., the first symbol 310 including the DMRS 325 may be a same symbol for both the first TRP and the second TRP when using FDM communication schemes).

In some other cases, as shown by the multi-TRP communication scheme 302, the multiple TRPs may apply an SDM communication scheme in which the different TRPs may transmit different spatial layers in overlapping REs 305 and symbols 310. In such cases, the multiple TRPs may transmit different layers with different TCI states. For example, the first TRP may transmit a first layer with the TCI state 315 and the second TRP may transmit a second layer with the TCI state 320. The first symbol 310 of each layer transmitted by a different TRP (and likewise transmitted according to a different TCI state) may include a DMRS 325 (e.g., the first symbol 310 including the DMRS 325 may be a same symbol for both the first TRP and the second TRP when using SDM communication schemes).

Further, for the transmission of the DMRS 325 in examples in which the first TRP and the second TRP transmit according to the SDM communication scheme, the REs 305 to which the TRPs may map DMRS ports may be configured according to a frequency hopping pattern such that the DMRS ports associated with a first set of layers transmitted by the first TRP with the TCI state 315 do not occupy the same REs 305 as the DMRS ports associated with a second set of layers transmitted by the second TRP with the TCI state 320. For example, the first TRP may transmit DMRS ports 0, 1 over a first set of REs 305 with the TCI state 315 and the second TRP may transmit DMRS ports 2, 3 over a second set of REs 305 with the TCI state 320 such that the first set of REs 305 and the second set of REs 305 do not occupy the same REs 305.

As shown by the multi-TRP communication scheme 302 (e.g., an SDM communication scheme), the first TRP and the second TRP may transmit over sets of REs 305 and symbols 310. In some cases, an RB may include 12 REs 305 such that, in some aspects, the first TRP and the second TRP may also be understood as transmitting over RBs (or sets of RBs) and symbols 310. In the depicted example, there are four layers and four DMRS ports, where each port corresponds to one layer. In an example, each DMRS port may correspond to one layer, such that the DMRS ports 0, 1 may be associated with the TCI state 315 and correspond to a first two layers and the DMRS ports 2, 3 may be associated with the TCI state 320 correspond to a next two layers. Data layers (unlike DMRS ports) may be mapped to the same REs 305, such that each data RE 305 includes all four layers (e.g., the first two layers and the next two layers).

FIG. 4 illustrates examples of SFN communication schemes 400, 401, and 402 that support techniques for joint CSI reporting for multiple TRP communication schemes in accordance with aspects of the present disclosure. In some examples, the SFN communication schemes 400, 401, and 402 may be implemented to realize aspects of the wireless communications system 100 or the wireless communication system 200. For example, multiple TRPs may employ one of the SFN communication schemes 400, 401, and 402 to transmit over a PDSCH associated with two or more reference signals to a UE 115 by applying multiple TCI states and the UE 115 may generate a CSI report based on which of the SFN communication schemes 400, 401, or 402 is employed by the multiple TRPs. For example, the SFN communication schemes 400, 401, and 402 may illustrate joint downlink transmissions to the UE 115 from a TRP 405 applying a TCI state 415 and from a TRP 410 applying a TCI state 420.

The SFN communication scheme 400 illustrates an SFN communication scheme 0. In some aspects, the SFN communication 0 may also refer to a transparent SFN communication scheme. In some examples, the TRP 405 and the TRP 410 may each transmit two separate reference signals (e.g., a reference signal 1 (RS 1) and a reference signal 2 (RS 2), respectively) and each separate reference signal may be associated with a different PDSCH. As such, to achieve an “SFNed” PDSCH, the TRP 405 and the TRP 410 may define an additional TCI state, such as a TCI state 425, that may be used to transmit an “SFNed” reference signal associated with an “SFNed” PDSCH. The “SFNed” PDSCH in the SFN communication 0 may include DMRS ports and data layers that are associated with the additional TCI state 425.

The SFN communication scheme 401 illustrates an SFN communication scheme 1. In such an SFN communication scheme 1, the TRP 405 and the TRP 410 may transmit two separate reference signals (e.g., an RS 1 and an RS 2, respectively) and each of the two reference signals may be associated with a different PDSCH and also with a joint “SFNed” PDSCH in which each DMRS port or data layer of the “SFNed” PDSCH is associated with both the TCI state 415 and the TCI state 420. In other words, the TRP 405 and the TRP 410 may transmit reference signals (such as TRSs) in a TRP-specific or non-SFN manner while the associated DMRS and PDCCH or PDSCH from the TRPs are transmitted in an SFN manner.

The SFN communication scheme 402 illustrates an SFN communication scheme 2. In such an SFN communication scheme 2, the TRP 405 and the TRP 410 may transmit two separate reference signals (e.g., an RS 1 and an RS 2, respectively) and each of the two reference signals may be associated with a different PDSCH and also with a joint PDSCH in which each data layer of the joint PDSCH is associated with the TCI state 415 and the TCI state 420 while each DMRS port of the joint PDSCH is associated with either the TCI state 415 or the TCI state 420 (e.g., not both). For example, a DMRS port 0 of the joint PDSCH may be associated with the TCI state 415 (and not with the TCI state 420) and a DMRS port 1 of the joint PDSCH may be associated with the TCI state 420 (and not with the TCI state 415). In other words, the TRP 405 and the TRP 410 may transmit reference signals (such as TRSs) and DMRS in a TRP-specific or non-SFN manner while the associated with PDSCH (e.g., data layers) from the TRPs is transmitted in an SFN manner.

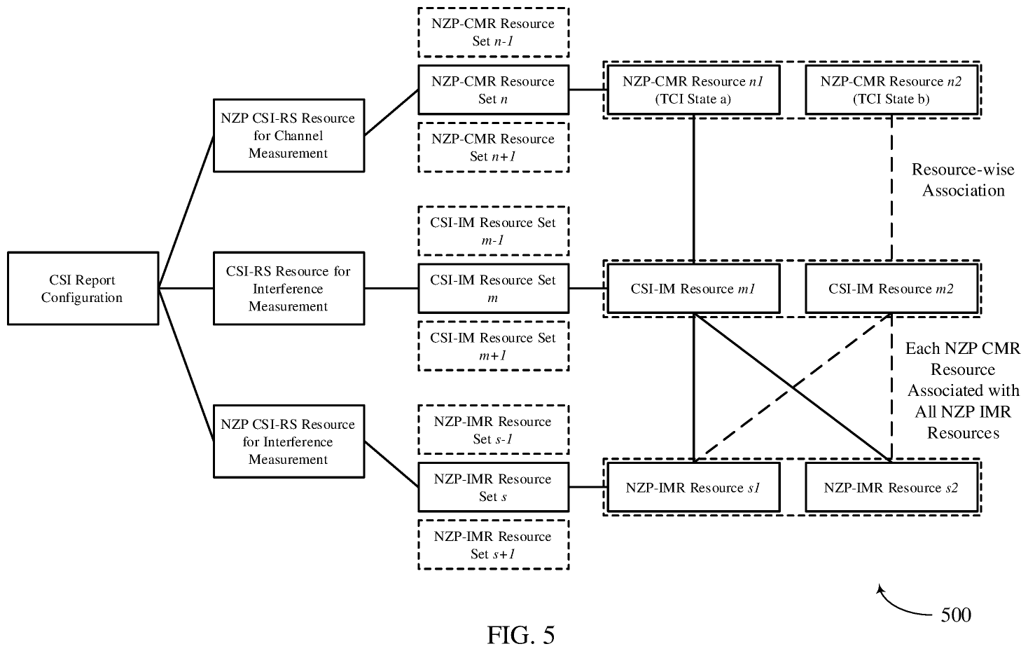

FIG. 5 illustrates an example of a CSI resource configuration 500 that supports techniques for joint CSI reporting for multiple TRP communication schemes in accordance with aspects of the present disclosure. In some examples, the CSI resource configuration 500 may be implemented to realize aspects of the wireless communications system 100 or the wireless communications system 200. For example, a UE 115 may receive a control message indicating a CSI-RS resource configuration 500 corresponding to one or more resources (e.g., CSI-RS resources) over which the UE 115 may monitor for two or more reference signals transmitted by multiple TRPs.

For example, the UE 115 may receive the control message including a CSI report configuration (which may be equivalently referred to as a CSI report config) that may link to one or more resource settings associated with different measurement types. For example, the CSI report configuration may link to one or more of a non-zero power (NZP) CSI-RS resource for channel measurement (CMR), a CSI-RS resource for interference measurement (CSI-IM), or an NZP CSI-RS for interference measurement (NZP-IMR), or any combination thereof. Each resource setting of the one or more resource settings to which the CSI report configuration may link may be associated with multiple resources sets, but one active resource set (e.g., only one active resource set).

For example, the NZP-CMR resource setting may be associated with an NZP-CMR resource set n−1, an NZP-CMR resource set n, and an NZP-CMR resource set n+1, and the NZP-CMR resource set n may be the active resource set. Similarly, the CSI-IM resource setting may be associated with an CSI-IM resource set m−1, an CSI-IM resource set m, and an CSI-IM resource set m+1, and the CSI-IM resource set m may be the active resource set. Similarly, the NZP-IMR resource setting may be associated with an NZP-IMR resource set s−1, an NZP-IMR resource set s, and an NZP-IMR resource set s+1, and the NZP-IMR resource set s may be the active resource set.

Further, each resource set may have one or more resources. For example, the NZP-CMR resource set n may include N resources including an NZP-CMR resource n1 and an NZP-CMR resource n2. In some aspects, the NZP-CMR resource n1 may be associated with a TCI state a (e.g., a first TCI state) and the NZP-CMR resource n2 may be associated with a TCI state b (e.g., a second TCI state). Similarly, the CSI-IM resource set m may include M resources including a CSI-IM resource m1 and a CSI-IM resource m2. Similarly, the NZP-IMR resource set s may include S resources including an NZP-IMR resource s1 and an NZP-IMR resource s2.

In some examples, the UE 115 may select one NZP-CMR resource out of the N NZP-CMR resources to use for reporting CSI. In such examples, the UE 115 may report the selected CMR resource in a CSI-RS resource indicator (CRI) field as part of the CSI feedback so that a receiving TRP or a serving base station knows to which NZP-CMR resource the reported CSI corresponds. Based on the selected NZP-CMR resource, the UE 115 may also implicitly select a resource from the M resources including a CSI-IM resource m1 and a CSI-IM resource m2 and one or more resources from the S resources including an NZP-IMR resource s1 and an NZP-IMR resource s2. For example, an NZP-CMR resource may feature a resource-wise association with a CSI-IM resource, such that one NZP-CMR resources is associated with one CSI-IM resource. For instance, the NZP-CMR resource n1 may be associated with the CSI-IM resource m1 and the NZP-CMR resource n2 may be associated with the CSI-IM resource m2. Additionally, each NZP-CMR resource may be associated with all NZP-IMR resources collectively, such that the NZP-CMR resource n1 and the NZP-CMR resource n2 may both be associated with the NZP-IMR resource s1 and the NZP-IMR resource s2.

Such a CSI resource configuration 500 may be implemented by the multiple TRPs and the UE 115 in examples in which the multiple TRPs apply different TCI states and employ a multi-TRP communication scheme. For example, the multiple TRPs and the UE 115 may identify a CSI resource configuration 500 that indicates one or more resources over which the UE 115 may monitor for two or more reference signals. In some implementations, for instance, the UE 115 may be configured with one resource over which the UE 115 may monitor for the two or more reference signals. In such implementations, the one resource may include two CSI-RS port groups, each CSI-RS port group associated with a different TCI state. For example, one CSI-RS port group may be associated with the TCI state a and the other CSI-RS port group may be associated with the TCI state b. In some other implementations, the UE 115 may be configured with two resources over which the UE 115 may monitor for the two or more reference signals, where each resource of the two resources may be associated with a different TCI state. For example, one resource may be associated with the TCI state a and the other resource may be associated with the TCI state b.

FIGS. 6A and 6B illustrate examples of communication schemes 600, 601, 602, and 603 that support techniques for joint CSI reporting for multiple TRP communication schemes in accordance with aspects of the present disclosure. In some examples, the communication schemes 600, 601, 602, and 603 may be implemented to realize aspects of the wireless communications system 100 or the wireless communication system 200. For example, a TRP 605 and a TRP 610 may perform joint transmissions over a PDSCH associated with two or more reference signals to a UE 115 according to one of the communication schemes 600, 601, 602, or 603 by applying different TCI states and the UE 115 may generate a CSI report based on which of the communication scheme 600, 601, 602, or 603 is used by the TRP 605 and the TRP 610. For example, the TRP 605 may employ a TCI state a (e.g., a first TCI state) and the TRP 610 may apply a TCI state b (e.g., a second TCI state).

The communication scheme 600 illustrates an example in which a TRP 605-a and a TRP 610-a may perform a joint transmission over a channel 615-a and a channel 620-a, respectively, according to an SDM communication scheme as described with reference to FIG. 3. Each of the TRP 605-a and the TRP 610-a may be associated with a number of DMRS ports 630 and a number of CSI-RS ports 635 (which may correspond to a number of transmit antennas 625 used by each of the TRP 605-a and the TRP 610-a). The TRP 605-a may have a first number of DMRS ports 630 (e.g., La layers) and the TRP 610-a may have a second number DMRS ports 630 (e.g., L_{b} layers). Additionally, the TRP 605-a may use a precoding weight Wₐ for transmitting a reference signal to the UE 115-b and the TRP 610-a may use a precoding weight W_{b} for transmitting to the UE 115-b. In some cases, the precoding weights Wₐ and W_{b} may be based on a previously reported PMI from the UE 115-b. In some aspects, the channel estimation of the channel 615-a may be determined as Hₐ and the channel estimation of the channel 620-a may be determined as H_{b}. In some cases, the UE 115-b may determine Hₐ and H_{b} based on reference signals (e.g., CSI-RSs or TRSs) transmitted by the TRP 605-a and the TRP 610-a that are associated with the channel 615-a and the channel 620-a. Accordingly, the UE 115-b may receive the joint transmission from the TRP 605-a and the TRP 610-a as defined in Equation (1), shown below:

$$Y = [ \begin{matrix}{H}_{a} & {H}_{b}\end{matrix} ] [ \begin{matrix}{W}_{a} & {X}_{a} \\ {W}_{b} & {X}_{b}\end{matrix} ] + I + N . \qquad ( 1 )$$

As shown in Equation (1), Y corresponds to the received signal at the UE 115-b, X corresponds to the transmitted data, I corresponds to an interference term, and N corresponds to a noise term. In some implementations of the present disclosure, the UE 115-b may receive an indication from one of the TRP 605-a or the TRP 610-a, or from a serving base station, that the TRP 605-a and the TRP 610-a will transmit to the UE 115-b according to the SDM communication scheme and the UE 115-b may generate a CSI report based on the SDM communication scheme. For example, the UE 115-b may include, within the CSI report, separate indications of CSI-RS ports or resources (e.g., the TRP 605-a and the TRP 610-a may use a different number of CSI-RS ports 635 and may transmit the reference signals over separate resources), separate PMIs determined jointly, separate RIs determined jointly, and separate Us. Such CSI reporting information for the SDM communication scheme is also shown in table format in Table 1. Further, for DMRS, the UE 115-b may perform separate estimation for the TRP 605-a and for the TRP 610-a and one data layer may be mapped to one DMRS port.

The communication scheme 601 illustrates an example in which a TRP 605-b and a TRP 610-b may perform a joint transmission to a UE 115-c over a channel 615-b and a channel 620-b, respectively, according to a coherent SFN communication scheme, which may be categorized as an SFN communication scheme 0 or as an SFN communication 1 as described with reference to FIG. 4. Each of the TRP 605-b and the TRP 610-b may be associated with a number of DMRS ports 630 and a number of CSI-RS ports 635 (which may correspond to a number of transmit antennas 625 used by each of the TRP 605-b and the TRP 610-b). As shown in the communication scheme 601, the TRP 605-b and the TRP 610-b may be co-located using a same number of transmit antennas 625 and may have a common number of DMRS ports 630 (e.g., two) and a common precoding weight W for transmitting to the UE 115-c. In some cases, the precoding weight W may be based on a previously reported PMI from the UE 115-c. In some aspects, the channel estimation of the channel 615-b may be determined as Hₐ and the channel estimation of the channel 620-b may be determined as H_{b}. In some cases, the UE 115-c may determine Hₐ and H_{b} based on reference signals (e.g., CSI-RSs or TRSs) transmitted by the TRP 605-b and the TRP 610-b that are associated with the channel 615-b and the channel 620-b. Accordingly, the UE 115-c may receive the joint transmission from the TRP 605-b and the TRP 610-b as defined in Equation (2), shown below:

Y=(Hₐ+H_{b})WX+I+N. (2)

As shown in Equation (2), Y corresponds to the received signal at the UE 115-c, X corresponds to the transmitted data, I corresponds to an interference term, and N corresponds to a noise term. In some implementations of the present disclosure, the UE 115-c may receive an indication from one of the TRP 605-b or the TRP 610-b, or from a serving base station 105, that the TRP 605-b and the TRP 610-b will transmit to the UE 115-c according to the coherent SFN communication scheme and the UE 115-c may generate a CSI report based on the coherent SFN communication scheme. For example, the UE 115-c may include, within the CSI report, an indication of a same CSI-RS port or resource (because the reference signals transmitted according to the SFN communication scheme 0 may be associated with an additionally defined TCI state and may be “SFNed”—e.g., the same CSI-RS ports are transmitted by both of the TRP 605-b and the TRP 610-b such that the same number of CSI-RS ports are transmitted by both the TRP 605-b and the TRP 610-b and the TRP 605-b and the TRP 610-b may transmit the reference signals over a same resource), one PMI (e.g., one W is feedbacked by the UE 115-c), one RI, and one LI. Such CSI reporting information for the coherent SFN communication scheme is also shown in table format in Table 1. Further, for DMRS, the UE 115-c may perform joint estimation for the TRP 605-b and the TRP 610-b and one data layer may be mapped to one DMRS port.

The communication scheme 602 illustrates an example in which a TRP 605-c and a TRP 610-c may perform a joint transmission to a UE 115-d over a channel 615-c and a channel 620-c, respectively, according to a CJT communication scheme, which may be categorized as an SFN communication scheme 1 as described with reference to FIG. 4. Each of the TRP 605-c and the TRP 610-c may be associated with a number of DMRS ports 630 and a number of CSI-RS ports 635 (which may correspond to a number of transmit antennas 625 used by each of the TRP 605-c and the TRP 610-c). As shown in the communication scheme 602, the TRP 605-c and the TRP 610-c may have a common number of DMRS ports 630 (e.g., two) and a common precoding weight W for transmitting to the UE 115-d. In some cases, the precoding weight W may be based on a previously reported PMI from the UE 115-d. In some aspects, the channel estimation of the channel 615-c may be determined as Hₐ and the channel estimation of the channel 620-c may be determined as H_{b}. In some cases, the UE 115-d may determine Hₐ and H_{b} based on reference signals (e.g., CSI-RSs or TRSs) transmitted by the TRP 605-c and the TRP 610-c that are associated with the channel 615-c and the channel 620-c. Accordingly, the UE 115-d may receive the joint transmission from the TRP 605-c and the TRP 610-c as defined in Equation (3), shown below:

Y=[HₐH_{b}]WX+1+N. (3)

As shown in Equation (3), Y corresponds to the received signal at the UE 115-d, X may correspond to the transmitted data, I corresponds to an interference term, and N corresponds to a noise term. In some implementations of the present disclosure, the UE 115-d may receive an indication from one of the TRP 605-c or the TRP 610-c, or from a serving base station 105, that the TRP 605-c and the TRP 610-c will transmit to the UE 115-d according to the CJT communication scheme and the UE 115-d may generate a CSI report based on the CJT communication scheme. For example, the UE 115-d may include, within the joint CSI report, separate indications of CSI-RS ports or resources (e.g., the TRP 605-c and the TRP 610-c may use a different number of CSI-RS ports 635 and may transmit the reference signals over separate resources), one jointly determined PMI (e.g., W is based on both Hₐ and H), one jointly determined RI, and one LI. Such CSI reporting information for the CJT communication scheme is also shown in table format in Table 1. Further, for DMRS, the UE 115-d may perform joint estimation for the TRP 605-c and for the TRP 610-c and one data layer may be mapped to one DMRS port.

The communication scheme 603 illustrates an example in which a TRP 605-d and a TRP 610-d may perform a joint transmission to a UE 115-e over a channel 615-d and a channel 620-d, respectively, according to an NCJT SFN communication scheme, which may be categorized as either an SFN communication scheme 1 or an SFN communication scheme 2 as described with reference to FIG. 4. Each of the TRP 605-d and the TRP 610-d may be associated with a number of DMRS ports 630 and a number of CSI-RS ports 635 (which may correspond to a number of transmit antennas 625 used by each of the TRP 605-c and the TRP 610-c). The TRP 605-d may have a first number of DMRS ports 630 and the TRP 610-d may have a second number DMRS ports 630. Additionally, the TRP 605-d may use a precoding weight Wₐ for transmitting a reference signal to the UE 115-e and the TRP 610-d may use a precoding weight W_{b} for transmitting to the UE 115-e. In some cases, the precoding weights Wₐ and W_{b} may be based on a previously reported PMI from the UE 115-e. In some aspects, the channel estimation of the channel 615-d may be determined as Hₐ and the channel estimation of the channel 620-d may be determined as H_{b}. In some cases, the UE 115-e may determine Hₐ and H_{b} based on reference signals (e.g., CSI-RSs or TRSs) transmitted by the TRP 605-d and the TRP 610-d that are associated with the channel 615-d and the channel 620-d. Accordingly, the UE 115-e may receive the joint transmission from the TRP 605-d and the TRP 610-d as defined in Equation (4), shown below:

Y=(HₐWₐ+H_{b}W_{b})X+I+N. (4)

As shown in Equation (4), Y corresponds to the received signal at the UE 115-e, X corresponds to the transmitted data, I corresponds to an interference term, and N corresponds to a noise term. In some implementations of the present disclosure, the UE 115-e may receive an indication from one of the TRP 605-d or the TRP 610-d, or from a serving base station 105, that the TRP 605-d and the TRP 610-d will transmit to the UE 115-e according to the NCJT SFN communication scheme 1 or 2 and the UE 115-e may generate a CSI report based on the NCJT SFN communication scheme 1 or 2. For example, if the TRP 605-d and the TRP 610-d transmit the reference signals according to an NCJT SFN communication scheme 1, the UE 115-e may include, within the joint CSI report, separate indications of CSI-RS ports or resources (e.g., the TRP 605-c and the TRP 610-c may use a different number of CSI-RS ports 635 and may transmit the reference signals over separate resources), separate PMIs determined jointly (e.g., Wₐ is based on both Hₐ and H_{b} and W_{b} is based on both Hₐ and H_{b}), one joint RI, and one LI.

Alternatively or additionally, if the TRP 605-d and the TRP 610-d transmit the reference signals according to an NCJT SFN communication scheme 2, the UE 115-e may include, within the joint CSI report, separate indications of CSI-RS ports or resources (e.g., the TRP 605-c and the TRP 610-c may use a different number of CSI-RS ports 635 and may transmit the reference signals over separate resources), separate PMIs determined jointly (e.g., Wₐ is based on both Hₐ and H_{b} and W_{b} is based on both Hₐ and H_{b}), one joint RI, and separate LIs. Such CSI reporting information for NCJT SFN communication schemes 1 and 2 are also shown in table format in Table 1. Further, for DMRS, the UE 115-e may perform joint estimation for the TRP 605-d and for the TRP 610-d and one data layer may be mapped to one DMRS port for a NCJT SFN communication scheme 1. Alternatively or additionally, the UE 115-e may perform separate estimation for the TRP 605-d and for the TRP 610-d and one data layer may be mapped to two DMRS ports for an NCJT SFN communication scheme 2.

As described herein, the communication scheme 601, illustrating a transparent SFN communication scheme, and the communication scheme 602, illustrating a CJT SFN communication scheme, may both be categorized as an SFN communication scheme 1. Such categorization may be applicable from a PDSCH processing point of view from a UE perspective, because each DMRS port 630 and each data layer are associated with both the first TCI state and the second TCI state. However, the communication scheme 601 and the communication scheme 602 may be different from a CSI point of view. For example, the UE 115 may report a joint PMI for a “CJT communication scheme.” For a “transparent communication scheme,” however, the UE 115 may add the channels corresponding to the CSI-RS ports and report one PMI such that, in this case, the communication scheme is no longer transparent from a CSI point of view.

Additionally, although not shown in FIGS. 6A and 6B, a TRP 605 and a TRP 610 may transmit to the UE 115 according to an FDM or a TDM communication scheme. In such examples in which the TRP 605 and the TRP 610 transmit according to the FDM or the TDM communication scheme, the UE 115 may include, within a joint CSI report, separate indications of CSI-RS ports or resources, separate PMIs determined jointly, one joint RI, and separate Us. Such CSI reporting information for FDM or TDM communication schemes is also shown in table format in Table 1. Further, for DMRS, the UE 115 may perform separate estimation for the TRP 605 and for the TRP 610 (e.g., in different REs or RBs and symbols) and one data layer may be mapped to one DMRS port.

TABLE 1

| | CSI-RS Port(s)/ | | | |
|---|---|---|---|---|
| | Resource(s) | PMI | RI | LI |
| SDM | Separate ports/ | Separate PMI | Separate RIs | Separate |
| Scheme | resources | determined | determined | LIs |
| | | jointly | jointly | |
| Transparent | Same port/ | One PMI | One RI | One LI |
| SFN | resource | | | |
| CJT | Separate ports/ | Joint PMI | Joint RI | One LI |
| | resources | | | |
| NCJT SFN | Separate ports/ | Separate PMI | Joint RI | One LI |
| Scheme 1 | resources | determined | | |
| | | jointly | | |
| NCJT SFN | Separate ports/ | Separate PMI | Joint RI | Separate |
| Scheme 2 | resources | determined | | LIs |
| | | jointly | | |
| FDM/TDM | Separate ports/ | Separate PMI | Joint RI | Separate |
| Schemes | resources | determined | | LIs |
| | | independently | | |

FIG. 7 illustrates examples of reported PMIs 700 and 701 that support techniques for joint CSI reporting for multiple TRP communication schemes in accordance with aspects of the present disclosure. In some examples, the reported PMIs 700 and 701 may be reported in a joint CSI report from a UE 115 based on receiving a transmission over a data channel associated with two or more reference signals from multiple TRPs according to a multi-TRP communication scheme, such as an SFN communication scheme, where the multiple TRPs apply different TCI states.

For instance, in some examples, the UE 115 may include two PMIs in a CSI report (e.g., in examples in which the multiple TRPs employ an SFN communication scheme 1 or an SFN communication scheme 2) including a PMI 705 and a PMI 710. In some aspects, the PMI 705 and the PMI 710 may be determined jointly by the UE 115. Additionally, the PMI 705 may correspond to a precoding weight Wₐ, and the PMI 710 may correspond to a precoding weight W_{b}, as illustrated by and described with reference to FIGS. 6A and 6B. For example, the UE 115 may report the PMI 705 for a first TRP that applies a first TCI state and uses the Wₐ corresponding to the PMI 705 and the UE 115 may report the PMI 710 for a second TRP that applies a second TCI state and uses the W_{b} corresponding to the PMI 710.

In some examples of the present disclosure, the UE 115 may determine how many Us to include in the joint CSI report based on one of an indicated SFN communication scheme or an indication of a quantity of Us to include in the joint CSI report (e.g., an explicit configuration). For example, the UE 115, based on the indicated SFN communication scheme or the explicit indication, may include one or two Us in the joint CSI report.

In some implementations, such as in implementations in which the multiple TRPs use an SFN communication scheme 1, the UE 115 may report a single LI in the joint CSI report. In such implementations, as illustrated by the reported PMIs 700, the single LI may indicate an i^{th} column of both the PMI 705-a and the PMI 710-a corresponding to the strongest layer by considering both reported PMIs 700. As such, a TRP or a serving base station receiving the joint CSI report may determine that the strongest layer corresponds to the layer mapped to the i^{th} column (e.g., a same selected column) across both reported PMIs 700 (and across both TCI states). In such implementations, the TRP or the serving base station may transmit a PT-RS in the layer indicated by the single LI and both the transmitted PT-RS port and the associated DMRS port are associated with the multiple TCI states applied by the multiple TRPs.

In some other implementations, such as in implementations in which the multiple TRPs use an SFN communication scheme 2, the UE 115 may report two LIs in the joint CSI report. In such implementations, as illustrated by the reported PMIs 701, a first LI may indicate an i^{th} column of the PMI 705-b and a second LI may indicate a j^{th} column of the PMI 710-b, where the i^{th} column of the PMI 705-b may correspond to the strongest layer of the first TCI state (e.g., considered independently) and the j^{th} column of the PMI 710-b may correspond to the strongest layer of the second TCI state (e.g., considered independently). In such implementations, the TRP or the serving base station may transmit a first PT-RS in the layer indicated by the first LI and may transmit a second PT-RS in the layer indicated by the second LI, where the first PT-RS ports and their associated DMRS ports are associated with the first TCI state and the second PT-RS and their associated DMRS ports are associated with the second TCI state.

Alternatively or additionally, in implementations in which the multiple TRPs use the SFN communication scheme 2, the UE 115 may report a single LI corresponding to one of the PMI 705 or the PMI 710 such that the single LI may indicate a strongest layer for that selected PMI. For example, the UE 115 may determine to report an LI for the PMI 705 or the PMI 710, and may include a single LI that references the reported PMI. As described in more detail herein, including with reference to FIG. 2, the one of the two PMIs that the UE 115 may report and for which the UE 115 may include an LI may be fixed or may be selected by the UE 115. For example, the UE 115 may determine to report an LI for the PMI 705 or the PMI 710, and may include a single LI that references the selected PMI. Alternatively or additionally, the UE 115 may be pre-configured or receive signaling to (e.g., always) select to report an LI for either the PMI 705 or the PMI 710.

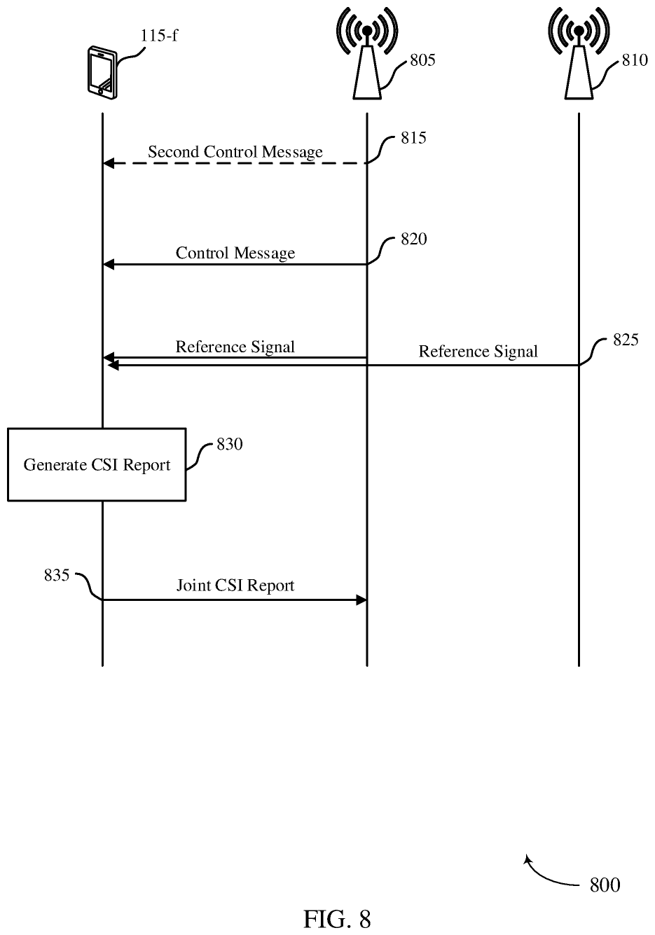

FIG. 8 illustrates an example of a process flow 800 that supports techniques for joint CSI reporting for multiple TRP communication schemes in accordance with aspects of the present disclosure. In some examples, the process flow 800 may implement aspects of the wireless communications system 100 or the wireless communications system 200. For example, the UE 115-f may receive a transmission over a data channel associated with two or more reference signals from multiple TRPs, such as a TRP 805 and a TRP 810, transmitted according to multi-TRP communication scheme and the UE 115-f may generate a joint CSI report based on the multi-TRP communication scheme.

At 815, the TRP 805 may, in some implementations, transmit a second control message. Such a second control message may indicate a set of multi-TRP communication schemes, such as SFN communication schemes, that the TRP 805 and the TRP 810 may use for transmitting over a data channel associated with two or more reference signals to the UE 115-f.

At 820, the TRP 805 may transmit a control message to the UE 115-f including a joint CSI reporting configuration that indicates a multi-TRP communication scheme, or a subset of multi-TRP communications schemes of the set of multi-TRP communication schemes and multiple TCI states to be applied by the TRP 805 and the TRP 810. In some examples, the control message may indicate a mode corresponding to the multi-TRP communication scheme to be applied by the TRP 805 and the TRP 810 or corresponding to a quantity of parameters that are to be included in the joint CSI report (where the quantity of parameters that are to be included in the joint CSI report may correspond or relate to a multi-TRP communication scheme to be applied by the TRP 805 and the TRP 810). In some implementations, the control message may indicate a quantity of Us that are to be included in the joint CSI report based on indicating one of an SFN communication scheme or explicitly indicating the quantity of Us that to be included in the joint CSI report, or both. In some aspects, the TRP 805 may transmit the control message via RRC signaling, a MAC-CE, DCI, or any combination thereof.

At 825, the UE 115-f may monitor for and receive two or more reference signals from the TRP 805 and the TRP 810 based on the control message. In some aspects, the two or more reference signals may be CSI-RSs or TRSs. For example, the control message may provide a CSI-RS resource configuration indicating resources over which the UE 115-f may monitor for the two or more reference signals and the UE 115-f may monitor over such resources accordingly. In some examples, the UE 115-f may receive the two or more reference signals as a joint transmission from the TRP 805 and the TRP 810.

At 830, the UE 115-f may generate the joint CSI report based on the two or more reference signals, the multi-TRP communication scheme indicated by the control message, and the multiple TCI states applied by the TRP 805 and the TRP 810. For example, according to the techniques described herein, the UE 115-f may determine a quantity of one or more CSI parameters to include in the joint CSI report based on the indicated multi-TRP communication scheme. In some implementations, the UE 115-f may generate the joint CSI report including the quantity of Us indicated by the control message. The UE 115-f may include one or more PMIs, one or more RIs, one or more Us, or one or more CQIs, or any combination thereof, in the joint CSI report based on the indicated multi-TRP communication scheme. In examples in which the UE 115-f is configured with a subset of multi-TRP communication schemes from which the UE 115-f may select, the UE 115-f may additionally indicate the selected multi-TRP communication scheme in the joint CSI report. In some implementations, the UE 115-f may generate the CSI report to include one or two PMIs based on the indicated or selected multi-TRP communication scheme and based on how the UE 115-f is configured to consider the channel (e.g., as a concatenated channel or as a combined channel).

At 835, the UE 115-f may transmit the joint CSI report to the TRP 805, which may function or otherwise operate as a serving base station for the UE 115-f In some examples, the UE 115-f may transmit the joint CSI report including the quantity of CSI parameters determined based on the indicated multi-TRP communication scheme. In some examples, the UE 115-f may transmit the joint CSI report as a two-part CSI report, such that the UE 1115-f may transmit a first part of the joint CSI report over a first resource, the first part having a fixed size, and may transmit a second part of the joint CSI report over a second resource, the second part having a variable size.

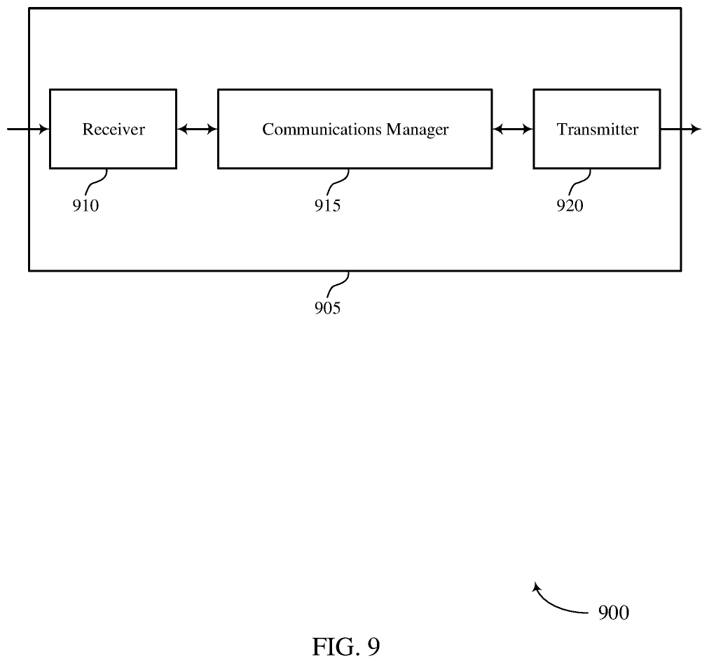

FIG. 9 shows a block diagram 900 of a device 905 that supports techniques for joint CSI reporting for multiple TRP communication schemes in accordance with aspects of the present disclosure. The device 905 may be an example of aspects of a UE 115 as described herein. The device 905 may include a receiver 910, a communications manager 915, and a transmitter 920. The device 905 may also include a processor. Each of these components may be in communication with one another (e.g., via one or more buses).

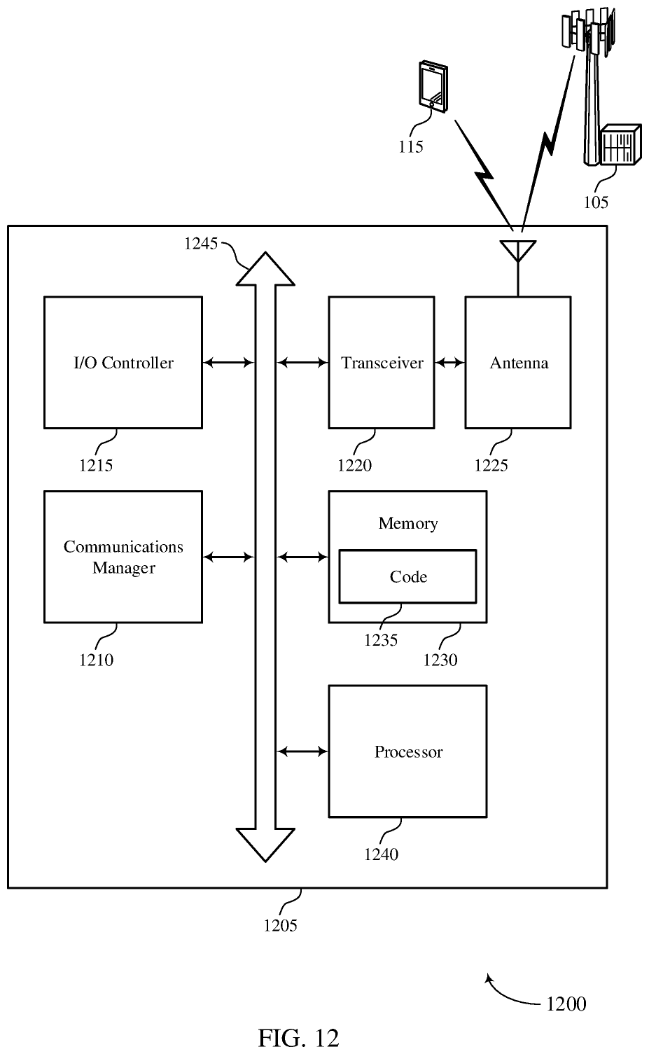

The receiver 910 may receive information such as packets, user data, or control information associated with various information channels (e.g., control channels, data channels, and information related to techniques for joint CSI reporting for SFN communication schemes, etc.). Information may be passed on to other components of the device 905. The receiver 910 may be an example of aspects of the transceiver 1220 described with reference to FIG. 12. The receiver 910 may utilize a single antenna or a set of antennas.

In some implementations, the communications manager 915 may receive a control message including a joint CSI reporting configuration that indicates a multi-TRP communication scheme of a set of multi-TRP communication schemes and a set of transmission configuration indicator states to be applied by two or more TRPs, monitor for two or more reference signals from the two or more TRPs based on the control message, generate a joint CSI report based on the two or more reference signals, the multi-TRP communication scheme, and the set of transmission configuration indicator states, and transmit the joint CSI report.

In some other implementations, the communications manager 915 may receive a control message including a joint CSI reporting configuration that indicates a set of transmission configuration indicator states to be applied by two or more TRPs and at least one of an SFN communication scheme of a set of SFN communication schemes, a quantity of one or more Us to be included in a joint CSI report, or both, identify the quantity of the one or more Us to include in the joint CSI report based on the SFN communication scheme, the quantity of the one or more Us, or both, indicated in the control message, monitor for two or more reference signals from the two or more TRPs based on the control message, generate the joint CSI report including the one or more Us based on the two or more reference signals, the quantity of the one or more Us, the SFN communication scheme, and the set of transmission configuration indicator states, and transmit the joint CSI report. The communications manager 915 may be an example of aspects of the communications manager 1210 described herein.

The communications manager 915, or its sub-components, may be implemented in hardware, code (e.g., software or firmware) executed by a processor, or any combination thereof. If implemented in code executed by a processor, the functions of the communications manager 915, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 915, or its sub-components, may be physically located at various positions, including being distributed such that portions of functions are implemented at different physical locations by one or more physical components. In some examples, the communications manager 915, or its sub-components, may be a separate and distinct component in accordance with various aspects of the present disclosure. In some examples, the communications manager 915, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 920 may transmit signals generated by other components of the device 905. In some examples, the transmitter 920 may be collocated with a receiver 910 in a transceiver module. For example, the transmitter 920 may be an example of aspects of the transceiver 1220 described with reference to FIG. 12. The transmitter 920 may utilize a single antenna or a set of antennas.

In some examples, the communications manager 915 may be implemented as an integrated circuit or chipset for a mobile device modem, and the receiver 910 and the transmitter 920 may be implemented as analog components (for example, amplifiers, filters, antennas) coupled to the mobile device modem to enable wireless transmission and reception over one or more bands.

The communications manager 915 may be implemented to realize one or more potential advantages. In some implementations, the communications manager 915 may provide more complete CSI to a serving base station based on receiving an indication of a multi-TRP communication scheme to be applied by multiple TRPs. As such, the communications manager 915 may facilitate greater channel knowledge, which may result in improved scheduling decisions, better network planning, and greater throughput, among other examples. Further, based on facilitating improved scheduling decisions and greater throughput, the communications manager 915, or one or more processing components of the communications manager 915, may enter a sleep mode more frequently or for longer durations of time, which may result in improved power savings or longer battery life at the device 905.

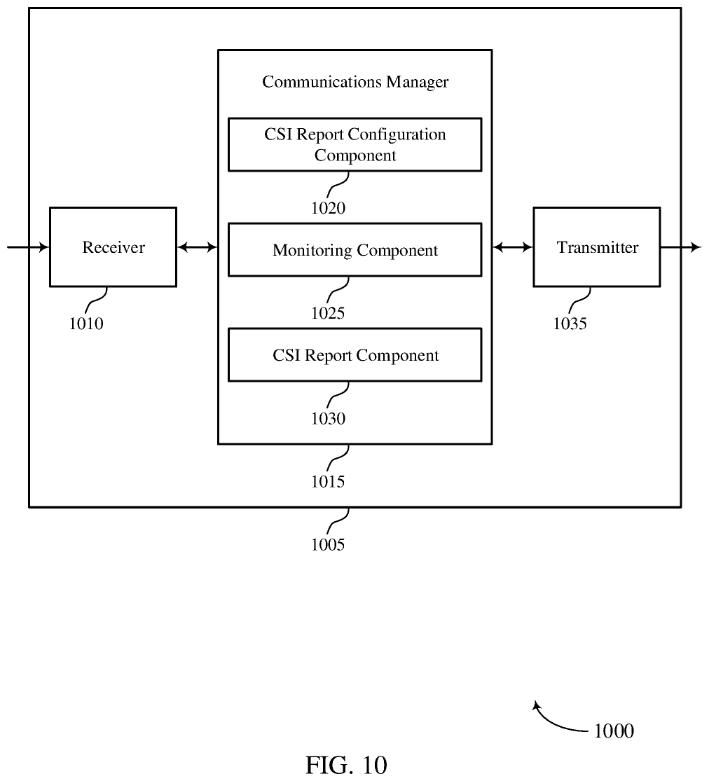

FIG. 10 shows a block diagram 1000 of a device 1005 that supports techniques for joint CSI reporting for multiple TRP communication schemes in accordance with aspects of the present disclosure. The device 1005 may be an example of aspects of a device 905, or a UE 115 as described herein. The device 1005 may include a receiver 1010, a communications manager 1015, and a transmitter 1035. The device 1005 may also include a processor. Each of these components may be in communication with one another (e.g., via one or more buses).

The receiver 1010 may receive information such as packets, user data, or control information associated with various information channels (e.g., control channels, data channels, and information related to techniques for joint CSI reporting for SFN communication schemes, etc.). Information may be passed on to other components of the device 1005. The receiver 1010 may be an example of aspects of the transceiver 1220 described with reference to FIG. 12. The receiver 1010 may utilize a single antenna or a set of antennas.

The communications manager 1015 may be an example of aspects of the communications manager 915 as described herein. The communications manager 1015 may include a CSI report configuration component 1020, a monitoring component 1025, and a CSI report component 1030. The communications manager 1015 may be an example of aspects of the communications manager 1210 described herein.

The CSI report configuration component 1020 may receive a control message including a joint CSI reporting configuration that indicates a multi-TRP communication scheme of a set of multi-TRP communication schemes and a set of transmission configuration indicator states to be applied by two or more TRPs. The monitoring component 1025 may monitor for two or more reference signals from the two or more TRPs based on the control message. The CSI report component 1030 may generate a joint CSI report based on the two or more reference signals, the multi-TRP communication scheme, and the set of transmission configuration indicator states and transmit the joint CSI report.

The CSI report configuration component 1020 may receive a control message including a joint CSI reporting configuration that indicates a set of transmission configuration indicator states to be applied by two or more TRPs and at least one of an SFN communication scheme of a set of SFN communication schemes, a quantity of one or more LIs to be included in a joint CSI report, or both and identify the quantity of the one or more LIs to include in the joint CSI report based on the SFN communication scheme, the quantity of the one or more LIs, or both, indicated in the control message. The monitoring component 1025 may monitor for two or more reference signals from the two or more TRPs based on the control message. The CSI report component 1030 may generate the joint CSI report including the one or more LIs based on the two or more reference signals, the quantity of the one or more LIs, the SFN communication scheme, and the set of transmission configuration indicator states and transmit the joint CSI report.

The transmitter 1035 may transmit signals generated by other components of the device 1005. In some examples, the transmitter 1035 may be collocated with a receiver 1010 in a transceiver module. For example, the transmitter 1035 may be an example of aspects of the transceiver 1220 described with reference to FIG. 12. The transmitter 1035 may utilize a single antenna or a set of antennas.

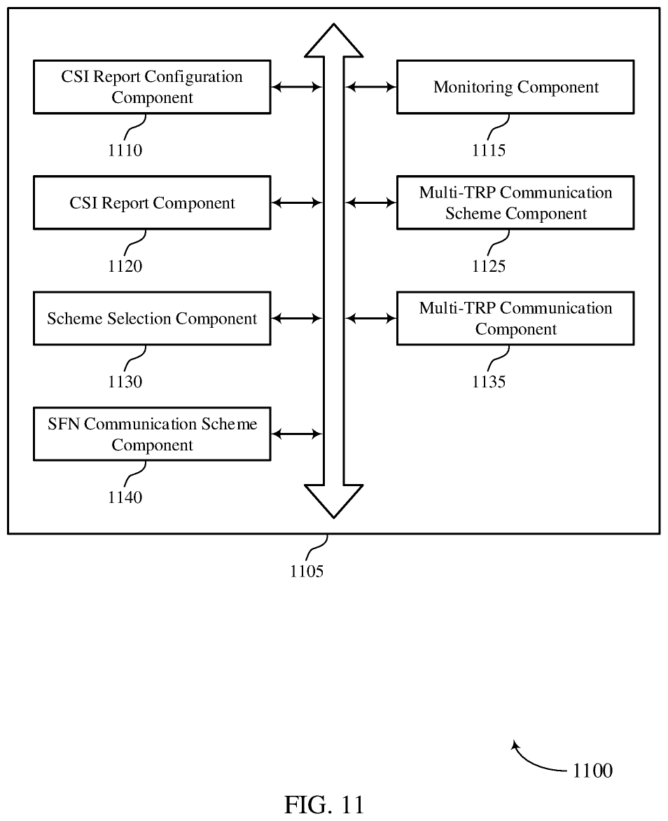

FIG. 11 shows a block diagram 1100 of a communications manager 1105 that supports techniques for joint CSI reporting for multiple TRP communication schemes in accordance with aspects of the present disclosure. The communications manager 1105 may be an example of aspects of a communications manager 915, a communications manager 1015, or a communications manager 1210 described herein. The communications manager 1105 may include a CSI report configuration component 1110, a monitoring component 1115, a CSI report component 1120, a multi-TRP communication scheme component 1125, a scheme selection component 1130, a multi-TRP communication component 1135, and an SFN communication scheme component 1140. Each of these modules may communicate, directly or indirectly, with one another (e.g., via one or more buses).

The CSI report configuration component 1110 may receive a control message including a joint CSI reporting configuration that indicates a multi-TRP communication scheme of a set of multi-TRP communication schemes and a set of transmission configuration indicator states to be applied by two or more TRPs. In some examples, the CSI report configuration component 1110 may receive the control message via RRC signaling, a MAC-CE, DCI, or any combination thereof.

The monitoring component 1115 may monitor for two or more reference signals from the two or more TRPs based on the control message.

The CSI report component 1120 may generate a joint CSI report based on the two or more reference signals, the multi-TRP communication scheme, and the set of transmission configuration indicator states. In some examples, the CSI report component 1120 may transmit the joint CSI report. In some examples, the CSI report component 1120 may transmit the joint CSI report including one or more CSI parameters according to the multi-TRP communication scheme. In some examples, the CSI report component 1120 may transmit the joint CSI report including a quantity of one or more reported CSI parameters that is selected according to the multi-TRP communication scheme.

In some examples, the CSI report component 1120 may transmit the joint CSI report including an indication of the multi-TRP communication scheme that is selected from the one or more multi-TRP communication schemes based on a respective spectral efficiency metric observed for the one or more multi-TRP communication schemes. In some examples, the CSI report component 1120 may transmit the indication of the multi-TRP communication scheme in a first part of the joint CSI report. In some examples, the CSI report component 1120 may transmit one or more CSI parameters according to the multi-TRP communication scheme in a second part of the joint CSI report.

The multi-TRP communication scheme component 1125 may receive a second control message indicating the set of multi-TRP communication schemes, where the joint CSI reporting configuration indicates one or more multi-TRP communication schemes of the set of multi-TRP communication schemes. In some cases, each of the one or more multi-TRP communication schemes indicated by the joint CSI reporting configuration correspond to at least one CSI reporting hypothesis.

In some cases, the set of multi-TRP communication schemes include a space-division multiplexing communication scheme, a time-division multiplexing scheme, a frequency-division multiplexing scheme, a coherent joint transmission communication scheme, a first SFN communication scheme in which each DMRS and each data layer of a data transmission are associated with a single transmission configuration indicator state, a second SFN communication scheme in which each DMRS port and each data layer of the data transmission are associated with the set of transmission configuration indicator states, a third SFN communication scheme in which each data layer of the data transmission are associated with the set of transmission configuration indicator states and in which each DMRS port is associated with one of the set of transmission configuration indicator states, or any combination thereof.

The scheme selection component 1130 may select to report the multi-TRP communication scheme from the one or more multi-TRP communication schemes in the joint CSI report.

The multi-TRP communication component 1135 may communicate with multiple TRPs according to a multi-TRP communication scheme. In some cases, the two or more TRPs include a first TRP and a second TRP and the set of transmission configuration indicator states include a first transmission configuration indicator state and a second transmission configuration indicator state, and where the first TRP applies the first transmission configuration indicator state and the second TRP applies the second transmission configuration indicator state. In some cases, the two or more TRPs include a first TRP and a second TRP and the set of transmission configuration indicator states include a first transmission configuration indicator state and a second transmission configuration indicator state, and where the first TRP applies the first transmission configuration indicator state and the second TRP applies the second transmission configuration indicator state.

In some examples, the CSI report configuration component 1110 may receive a control message including a joint CSI reporting configuration that indicates a set of transmission configuration indicator states to be applied by two or more TRPs and at least one of an SFN communication scheme of a set of SFN communication schemes, a quantity of one or more Us to be included in a joint CSI report, or both. In some examples, the CSI report configuration component 1110 may identify the quantity of the one or more Us to include in the joint CSI report based on the SFN communication scheme, the quantity of the one or more Us, or both, indicated in the control message.

In some examples, the CSI report configuration component 1110 may receive the control message via RRC signaling, a MAC-CE, DCI, or any combination thereof. In some cases, the joint CSI reporting configuration includes a field indicating the quantity of the one or more LIs to be included in the joint CSI report, the quantity corresponding to the SFN communication scheme.

In some examples, the monitoring component 1115 may monitor for two or more reference signals from the two or more TRPs based on the control message. In some examples, the monitoring component 1115 may receive one or more phase tracking reference signals over one or more layers corresponding to the one or more LIs of the joint CSI report.

In some examples, the monitoring component 1115 may receive the control message including an indication of a single reference signal resource associated with the set of transmission configuration indicator states, where the single reference signal resource is associated with a set of reference signal port groups, each reference signal port group of the set of reference signal port groups corresponding to one of the set of transmission configuration indicator states. In some examples, the monitoring component 1115 may monitor the single reference signal resource, where each of the two or more reference signals is received based on monitoring the single reference signal resource, each of the two or more reference signals corresponding to a reference signal port group of the set of reference signal port groups.

In some examples, the monitoring component 1115 may receive the control message including an indication of a set of reference signal resources, each reference signal resource of the set of reference signal resources corresponding to one of the set of transmission configuration indicator states. In some examples, the monitoring component 1115 may monitor the set of reference signal resources, where each of the two or more reference signals is received based on monitoring the set of reference signal resources, each of the two or more reference signals corresponding to a reference signal resource of the set of reference signal resources.

In some examples, the CSI report component 1120 may generate the joint CSI report including the one or more Us based on the two or more reference signals, the quantity of the one or more Us, the SFN communication scheme, and the set of transmission configuration indicator states. In some examples, the CSI report component 1120 may transmit the joint CSI report.

In some examples, the CSI report component 1120 may transmit the joint CSI report including a first PMI associated with a first transmission configuration indicator state of the set of transmission configuration indicator states and a second PMI associated with a second transmission configuration indicator state of the set of transmission configuration indicator states.

In some examples, the CSI report component 1120 may transmit the joint CSI report including a single LI based on the SFN communication scheme, where the single LI indicates a layer corresponding to a same column in each of the first PMI and the second PMI. In some examples, the CSI report component 1120 may transmit the joint CSI report including a first LI and a second LI based on the SFN communication scheme, where the first LI corresponds to a first layer corresponding to a first column of the first PMI and the second LI corresponds to a second layer corresponding to a second column of the second PMI.

In some examples, the CSI report component 1120 may transmit the joint CSI report including a single LI based on the SFN communication scheme, where the single LI indicates a layer corresponding to a column of one of the first PMI or the second PMI. In some examples, the CSI report component 1120 may transmit the joint CSI report including an indication of the selected one of the first PMI or the second PMI. In some examples, the CSI report component 1120 may transmit the one or more Us in a first part of the joint CSI report, the first part of the joint CSI report having a fixed size. In some examples, the CSI report component 1120 may transmit the one or more Us in a second part of the joint CSI report, the second part of the joint CSI report having a variable size.

In some examples, the CSI report component 1120 may transmit the joint CSI report including a single PMI corresponding to all ports or a set of ports of the two or more reference signals. In some examples, the CSI report component 1120 may transmit the joint CSI report including a single PMI corresponding to a port-to-port sum of respective pluralities of ports associated with the two or more reference signals.

In some cases, the one or more CSI parameters include one or more PMIs, one or more rank indicators, one or more Us, or one or more channel quality indicators. In some cases, the first part of the joint CSI report is associated with a fixed size and the second part of the joint CSI report is associated with a variable size that is based on the multi-TRP communication scheme.

In some cases, the one of the first PMI or the second PMI reported in the joint CSI report is preconfigured or signaled. In some cases, the first PMI and the second PMI have a same number of columns corresponding to a jointly selected rank indicator.

The SFN communication scheme component 1140 may communicate with multiple TRPs according to an SFN communication scheme. In some cases, the set of SFN communication schemes include a coherent joint transmission communication scheme, a first SFN communication scheme in which each DMRS and each data layer of a data transmission are associated with a single transmission configuration indicator state, a second SFN communication scheme in which each DMRS port and each data layer of the data transmission are associated with the set of transmission configuration indicator states, a third SFN communication scheme in which each data layer of the data transmission are associated with the set of transmission configuration indicator states and in which each DMRS port is associated with one of the set of transmission configuration indicator states, or any combination thereof.

FIG. 12 shows a diagram of a system 1200 including a device 1205 that supports techniques for joint CSI reporting for multiple TRP communication schemes in accordance with aspects of the present disclosure. The device 1205 may be an example of or include the components of device 905, device 1005, or a UE 115 as described herein. The device 1205 may include components for bi-directional voice and data communications including components for transmitting and receiving communications, including a communications manager 1210, an I/O controller 1215, a transceiver 1220, an antenna 1225, memory 1230, and a processor 1240. These components may be in electronic communication via one or more buses (e.g., bus 1245).

In some implementations, the communications manager 1210 may receive a control message including a joint CSI reporting configuration that indicates a multi-TRP communication scheme of a set of multi-TRP communication schemes and a set of transmission configuration indicator states to be applied by two or more TRPs, monitor for two or more reference signals from the two or more TRPs based on the control message, generate a joint CSI report based on the two or more reference signals, the multi-TRP communication scheme, and the set of transmission configuration indicator states, and transmit the joint CSI report.

In some other implementations, the communications manager 1210 may receive a control message including a joint CSI reporting configuration that indicates a set of transmission configuration indicator states to be applied by two or more TRPs and at least one of an SFN communication scheme of a set of SFN communication schemes, a quantity of one or more Us to be included in a joint CSI report, or both, identify the quantity of the one or more Us to include in the joint CSI report based on the SFN communication scheme, the quantity of the one or more Us, or both, indicated in the control message, monitor for two or more reference signals from the two or more TRPs based on the control message, generate the joint CSI report including the one or more Us based on the two or more reference signals, the quantity of the one or more Us, the SFN communication scheme, and the set of transmission configuration indicator states, and transmit the joint CSI report.

The I/O controller 1215 may manage input and output signals for the device 1205. The I/O controller 1215 may also manage peripherals not integrated into the device 1205. In some cases, the I/O controller 1215 may represent a physical connection or port to an external peripheral. In some cases, the I/O controller 1215 may utilize an operating system such as iOS®, ANDROID®, MS-DOS®, MS-WINDOWS®, OS/2®, UNIX®, LINUX®, or another known operating system. In other cases, the I/O controller 1215 may represent or interact with a modem, a keyboard, a mouse, a touchscreen, or a similar device. In some cases, the I/O controller 1215 may be implemented as part of a processor. In some cases, a user may interact with the device 1205 via the I/O controller 1215 or via hardware components controlled by the I/O controller 1215.

The transceiver 1220 may communicate bi-directionally, via one or more antennas, wired, or wireless links as described herein. For example, the transceiver 1220 may represent a wireless transceiver and may communicate bi-directionally with another wireless transceiver. The transceiver 1220 may also include a modem to modulate the packets and provide the modulated packets to the antennas for transmission, and to demodulate packets received from the antennas.

In some cases, the wireless device may include a single antenna 1225. However, in some cases the device may have more than one antenna 1225, which may be capable of concurrently transmitting or receiving multiple wireless transmissions.

The memory 1230 may include random-access memory (RAM) and read-only memory (ROM). The memory 1230 may store computer-readable, computer-executable code 1235 including instructions that, when executed, cause the processor to perform various functions described herein. In some cases, the memory 1230 may contain, among other things, a basic I/O system (BIOS) which may control basic hardware or software operation such as the interaction with peripheral components or devices.

The processor 1240 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1240 may be configured to operate a memory array using a memory controller. In other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for joint CSI reporting for SFN communication schemes).

The code 1235 may include instructions to implement aspects of the present disclosure, including instructions to support wireless communications. The code 1235 may be stored in a non-transitory computer-readable medium such as system memory or other type of memory. In some cases, the code 1235 may not be directly executable by the processor 1240 but may cause a computer (e.g., when compiled and executed) to perform functions described herein.

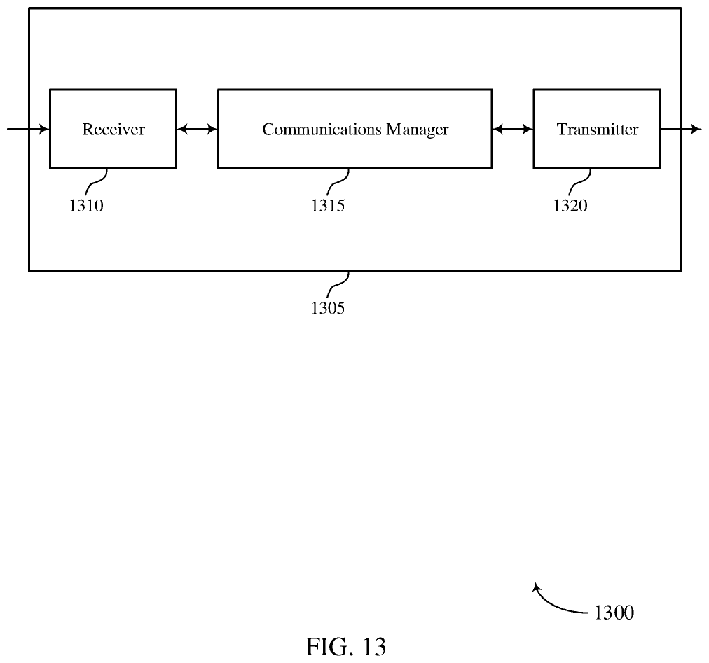

FIG. 13 shows a block diagram 1300 of a device 1305 that supports techniques for joint CSI reporting for multiple TRP communication schemes in accordance with aspects of the present disclosure. The device 1305 may be an example of aspects of a base station 105 as described herein. The device 1305 may include a receiver 1310, a communications manager 1315, and a transmitter 1320. The device 1305 may also include a processor. Each of these components may be in communication with one another (e.g., via one or more buses).

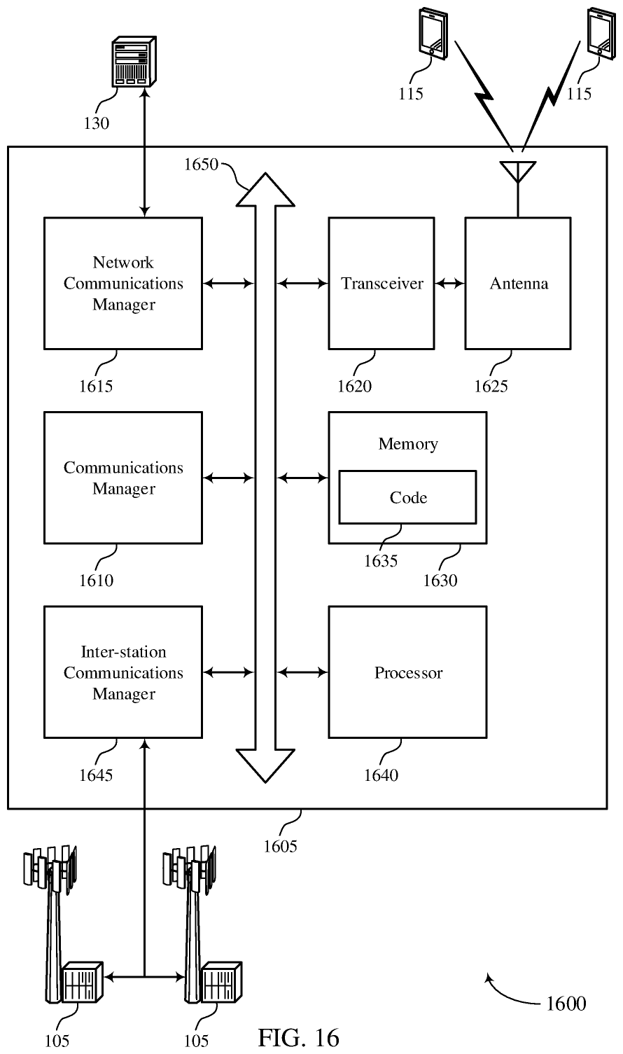

The receiver 1310 may receive information such as packets, user data, or control information associated with various information channels (e.g., control channels, data channels, and information related to techniques for joint CSI reporting for SFN communication schemes, etc.). Information may be passed on to other components of the device 1305. The receiver 1310 may be an example of aspects of the transceiver 1620 described with reference to FIG. 16. The receiver 1310 may utilize a single antenna or a set of antennas.

In some implementations, the communications manager 1315 may transmit, to a UE, a control message including a joint CSI reporting configuration that indicates a multi-TRP communication scheme of a set of multi-TRP communication schemes and a set of transmission configuration indicator states to be applied by the first TRP and a second TRP, transmit a reference signal according to the multi-TRP communication scheme and a first transmission configuration indicator state of the set of transmission configuration indicator states, and receive, from the UE, a joint CSI report based on the reference signal.

In some other implementations, the communications manager 1315 may transmit, to a UE, a control message including a joint CSI reporting configuration that indicates a set of transmission configuration indicator states to be applied by the first TRP and a second TRP and at least one of an SFN communication scheme of a set of SFN communication schemes, a quantity of one or more Us to be included in a joint CSI report, or both, transmit a reference signal according to the SFN communication scheme, and receive, from the UE, the joint CSI report including the one or more Us based on the reference signal. The communications manager 1315 may be an example of aspects of the communications manager 1610 described herein.

The communications manager 1315, or its sub-components, may be implemented in hardware, code (e.g., software or firmware) executed by a processor, or any combination thereof. If implemented in code executed by a processor, the functions of the communications manager 1315, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 1315, or its sub-components, may be physically located at various positions, including being distributed such that portions of functions are implemented at different physical locations by one or more physical components. In some examples, the communications manager 1315, or its sub-components, may be a separate and distinct component in accordance with various aspects of the present disclosure. In some examples, the communications manager 1315, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 1320 may transmit signals generated by other components of the device 1305. In some examples, the transmitter 1320 may be collocated with a receiver 1310 in a transceiver module. For example, the transmitter 1320 may be an example of aspects of the transceiver 1620 described with reference to FIG. 16. The transmitter 1320 may utilize a single antenna or a set of antennas.

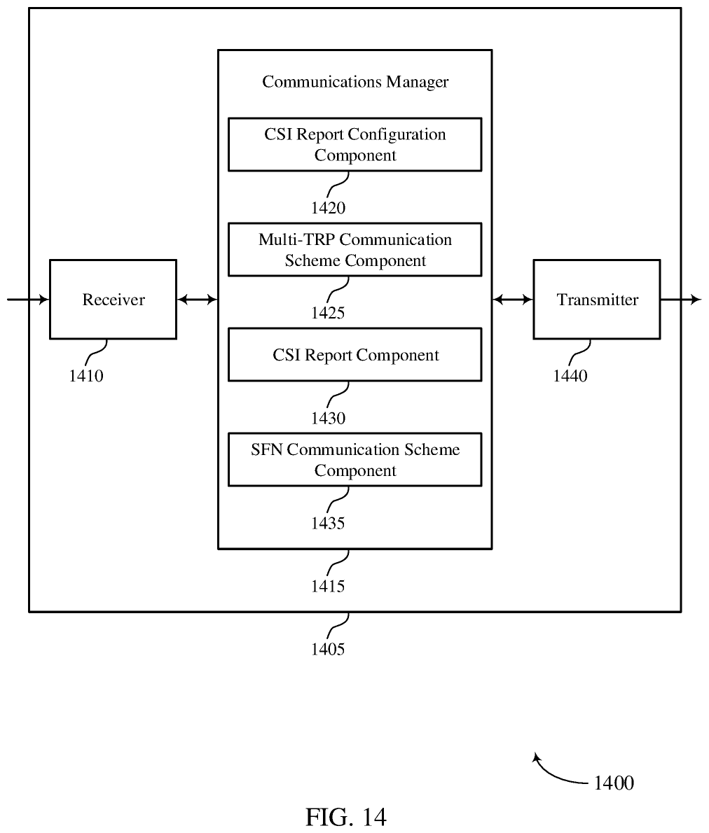

FIG. 14 shows a block diagram 1400 of a device 1405 that supports techniques for joint CSI reporting for multiple TRP communication schemes in accordance with aspects of the present disclosure. The device 1405 may be an example of aspects of a device 1305, or a base station 105 as described herein. The device 1405 may include a receiver 1410, a communications manager 1415, and a transmitter 1440. The device 1405 may also include a processor. Each of these components may be in communication with one another (e.g., via one or more buses).

The receiver 1410 may receive information such as packets, user data, or control information associated with various information channels (e.g., control channels, data channels, and information related to techniques for joint CSI reporting for SFN communication schemes, etc.). Information may be passed on to other components of the device 1405. The receiver 1410 may be an example of aspects of the transceiver 1620 described with reference to FIG. 16. The receiver 1410 may utilize a single antenna or a set of antennas.

The communications manager 1415 may be an example of aspects of the communications manager 1315 as described herein. The communications manager 1415 may include a CSI report configuration component 1420, a multi-TRP communication scheme component 1425, a CSI report component 1430, and an SFN communication scheme component 1435. The communications manager 1415 may be an example of aspects of the communications manager 1610 described herein.

The CSI report configuration component 1420 may transmit, to a UE, a control message including a joint CSI reporting configuration that indicates a multi-TRP communication scheme of a set of multi-TRP communication schemes and a set of transmission configuration indicator states to be applied by the first TRP and a second TRP. The multi-TRP communication scheme component 1425 may transmit a reference signal according to the multi-TRP communication scheme and a first transmission configuration indicator state of the set of transmission configuration indicator states. The CSI report component 1430 may receive, from the UE, a joint CSI report based on the reference signal.

The CSI report configuration component 1420 may transmit, to a UE, a control message including a joint CSI reporting configuration that indicates a set of transmission configuration indicator states to be applied by the first TRP and a second TRP and at least one of an SFN communication scheme of a set of SFN communication schemes, a quantity of one or more Us to be included in a joint CSI report, or both. The SFN communication scheme component 1435 may transmit a reference signal according to the SFN communication scheme. The CSI report component 1430 may receive, from the UE, the joint CSI report including the one or more Us based on the reference signal.

The transmitter 1440 may transmit signals generated by other components of the device 1405. In some examples, the transmitter 1440 may be collocated with a receiver 1410 in a transceiver module. For example, the transmitter 1440 may be an example of aspects of the transceiver 1620 described with reference to FIG. 16. The transmitter 1440 may utilize a single antenna or a set of antennas.

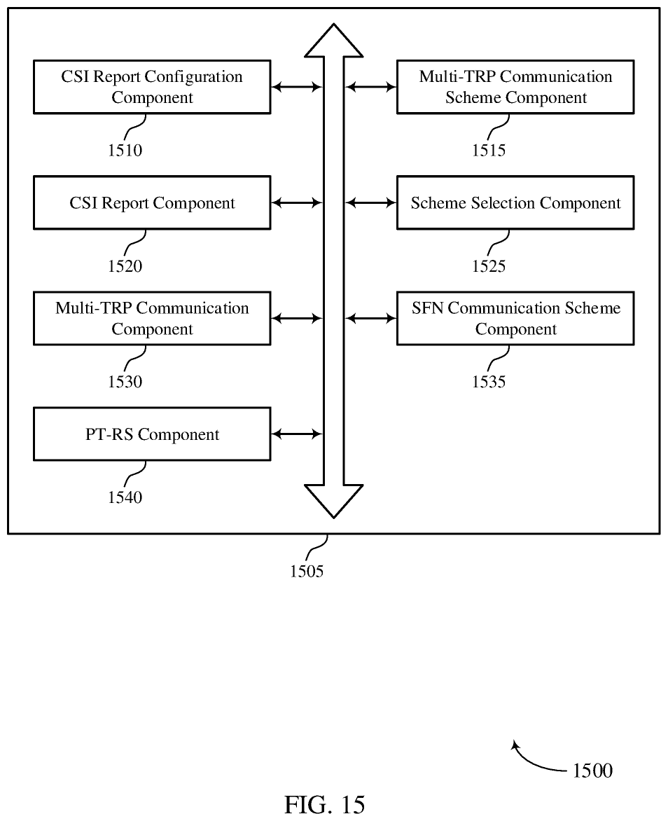

FIG. 15 shows a block diagram 1500 of a communications manager 1505 that supports techniques for joint CSI reporting for multiple TRP communication schemes in accordance with aspects of the present disclosure. The communications manager 1505 may be an example of aspects of a communications manager 1315, a communications manager 1415, or a communications manager 1610 described herein. The communications manager 1505 may include a CSI report configuration component 1510, a multi-TRP communication scheme component 1515, a CSI report component 1520, a scheme selection component 1525, a multi-TRP communication component 1530, an SFN communication scheme component 1535, and a PT-RS component 1540. Each of these modules may communicate, directly or indirectly, with one another (e.g., via one or more buses).

The CSI report configuration component 1510 may transmit, to a UE, a control message including a joint CSI reporting configuration that indicates a multi-TRP communication scheme of a set of multi-TRP communication schemes and a set of transmission configuration indicator states to be applied by the first TRP and a second TRP. In some examples, the CSI report configuration component 1510 may transmit the control message via RRC signaling, a MAC-CE, DCI, or any combination thereof.

The multi-TRP communication scheme component 1515 may transmit a reference signal according to the multi-TRP communication scheme and a first transmission configuration indicator state of the set of transmission configuration indicator states. In some examples, the multi-TRP communication scheme component 1515 may transmit, to the UE, a second control message indicating the set of multi-TRP communication schemes, where the joint CSI reporting configuration indicates one or more multi-TRP communication schemes of the set of multi-TRP communication schemes. In some cases, each of the one or more multi-TRP communication schemes indicated by the joint CSI reporting configuration correspond to at least one CSI reporting hypothesis.

In some cases, the set of multi-TRP communication schemes include a space-division multiplexing communication scheme, a time-division multiplexing scheme, a frequency-division multiplexing scheme, a coherent joint transmission communication scheme, a first SFN communication scheme in which each DMRS and each data layer of a data transmission are associated with a single transmission configuration indicator state, a second SFN communication scheme in which each DMRS port and each data layer of the data transmission are associated with the set of transmission configuration indicator states, a third SFN communication scheme in which each data layer of the data transmission are associated with the set of transmission configuration indicator states and in which each DMRS port is associated with one of the set of transmission configuration indicator states, or any combination thereof.

The CSI report component 1520 may receive, from the UE, a joint CSI report based on the reference signal. In some examples, the CSI report component 1520 may receive the joint CSI report including one or more CSI parameters according to the multi-TRP communication scheme. In some examples, the CSI report component 1520 may receive the joint CSI report including a quantity of one or more reported CSI parameters that is selected according to the multi-TRP communication scheme.

In some examples, the CSI report component 1520 may receive the indication of the multi-TRP communication scheme in a first part of the joint CSI report. In some examples, the CSI report component 1520 may receive one or more CSI parameters according to the multi-TRP communication scheme in a second part of the joint CSI report. In some cases, the one or more CSI parameters include one or more PMIs, one or more rank indicators, one or more LIs, or one or more channel quality indicators.

The scheme selection component 1525 may receive the joint CSI report including an indication of the multi-TRP communication scheme that is selected from the one or more multi-TRP communication schemes based on a respective spectral efficiency metric observed for the one or more multi-TRP communication schemes.

The multi-TRP communication component 1530 may communicate with a UE according to a first TCI state while a second TRP communicates with the UE according to a second TCI state. In some cases, the set of transmission configuration indicator states include the first transmission configuration indicator state and a second transmission configuration indicator state, and where the first TRP applies the first transmission configuration indicator state and the second TRP applies the second transmission configuration indicator state.

In some examples, the CSI report configuration component 1510 may transmit, to a UE, a control message including a joint CSI reporting configuration that indicates a set of transmission configuration indicator states to be applied by the first TRP and a second TRP and at least one of an SFN communication scheme of a set of SFN communication schemes, a quantity of one or more LIs to be included in a joint CSI report, or both. In some examples, the CSI report configuration component 1510 may transmit the control message via RRC signaling, a MAC-CE, DCI, or any combination thereof. In some examples, the CSI report configuration component 1510 may transmit the control message including an indication of a single reference signal resource associated with the set of transmission configuration indicator states, where the single reference signal resource is associated with a set of reference signal port groups, each reference signal port group of the set of reference signal port groups corresponding to one of the set of transmission configuration indicator states.

In some examples, the CSI report configuration component 1510 may transmit the control message including an indication of a set of reference signal resources, each reference signal resource of the set of reference signal resources corresponding to one of the set of transmission configuration indicator states. In some cases, the joint CSI reporting configuration includes a field indicating the quantity of the one or more LIs to be included in the joint CSI report, the quantity corresponding to the SFN communication scheme.

In some examples, the CSI report component 1520 may receive, from the UE, the joint CSI report including the one or more LIs based on the reference signal. In some examples, the CSI report component 1520 may receive the joint CSI report including a first PMI associated with a first transmission configuration indicator state of the set of transmission configuration indicator states and a second PMI associated with a second transmission configuration indicator state of the set of transmission configuration indicator states.

In some examples, the CSI report component 1520 may receive the joint CSI report including one a single LI based on the SFN communication scheme, where the single LI indicates a layer corresponding to a same column in each of the first PMI and the second PMI. In some examples, the CSI report component 1520 may receive the joint CSI report including a first LI and a second LI based on the SFN communication scheme, where the first LI corresponds to a first layer corresponding to a first column of the first PMI and the second LI corresponds to a second layer corresponding to a second column of the second PMI.

In some examples, the CSI report component 1520 may receive the joint CSI report including a single LI based on the SFN communication scheme, where the single LI indicates a layer corresponding to a column of one of the first PMI or the second PMI. In some examples, the CSI report component 1520 may receive the joint CSI report including an indication of the selected one of the first PMI or the second PMI.

In some examples, the CSI report component 1520 may receive the one or more LIs in a first part of the joint CSI report, the first part of the joint CSI report having a fixed size. In some examples, the CSI report component 1520 may receive the one or more LIs in a second part of the joint CSI report, the second part of the joint CSI report having a variable size.

In some examples, the CSI report component 1520 may receive the joint CSI report including a single PMI corresponding to all ports or a set of ports associated with two or more reference signals, the two or more reference signals including the reference signal. In some examples, the CSI report component 1520 may receive the joint CSI report including a single PMI corresponding to a port-to-port sum of respective pluralities of ports associated with two or more reference signals, the two or more reference signals including the reference signal.

In some cases, the first part of the joint CSI report is associated with a fixed size and the second part of the joint CSI report is associated with a variable size that is based on the multi-TRP communication scheme. In some cases, the one of the first PMI or the second PMI reported in the joint CSI report is preconfigured or signaled. In some cases, the first PMI and the second PMI have a same number of columns corresponding to a jointly selected rank indicator.

The multi-TRP communication component 1530 may communicate with a UE according to a first TCI state while a second TRP communicates with the UE according to a second TCI state. In some cases, the set of transmission configuration indicator states include the first transmission configuration indicator state and a second transmission configuration indicator state, and where the first TRP applies the first transmission configuration indicator state and the second TRP applies the second transmission configuration indicator state.

The SFN communication scheme component 1535 may transmit a reference signal according to the SFN communication scheme. In some cases, the set of SFN communication schemes include a first SFN communication scheme in which each DMRS and each data layer of a data transmission are associated with a single transmission configuration indicator state, a second SFN communication scheme in which each DMRS port and each data layer of the data transmission are associated with the set of transmission configuration indicator states, a third SFN communication scheme in which each data layer of the data transmission are associated with the set of transmission configuration indicator states and in which each DMRS port is associated with one of the set of transmission configuration indicator states, or any combination thereof.

The PT-RS component 1540 may transmit one or more phase tracking reference signals over one or more layers corresponding to the one or more Us of the joint CSI report.

FIG. 16 shows a diagram of a system 1600 including a device 1605 that supports techniques for joint CSI reporting for multiple TRP communication schemes in accordance with aspects of the present disclosure. The device 1605 may be an example of or include the components of device 1305, device 1405, or a base station 105 as described herein. The device 1605 may include components for bi-directional voice and data communications including components for transmitting and receiving communications, including a communications manager 1610, a network communications manager 1615, a transceiver 1620, an antenna 1625, memory 1630, a processor 1640, and an inter-station communications manager 1645. These components may be in electronic communication via one or more buses (e.g., bus 1650).

In some implementations, the communications manager 1610 may transmit, to a UE, a control message including a joint CSI reporting configuration that indicates a multi-TRP communication scheme of a set of multi-TRP communication schemes and a set of transmission configuration indicator states to be applied by the first TRP and a second TRP, transmit a reference signal according to the multi-TRP communication scheme and a first transmission configuration indicator state of the set of transmission configuration indicator states, and receive, from the UE, a joint CSI report based on the reference signal.

In some other implementations, the communications manager 1610 may transmit, to a UE, a control message including a joint CSI reporting configuration that indicates a set of transmission configuration indicator states to be applied by the first TRP and a second TRP and at least one of an SFN communication scheme of a set of SFN communication schemes, a quantity of one or more Us to be included in a joint CSI report, or both, transmit a reference signal according to the SFN communication scheme, and receive, from the UE, the joint CSI report including the one or more LIs based on the reference signal.

The network communications manager 1615 may manage communications with the core network (e.g., via one or more wired backhaul links). For example, the network communications manager 1615 may manage the transfer of data communications for client devices, such as one or more UEs 115.

The transceiver 1620 may communicate bi-directionally, via one or more antennas, wired, or wireless links as described herein. For example, the transceiver 1620 may represent a wireless transceiver and may communicate bi-directionally with another wireless transceiver. The transceiver 1620 may also include a modem to modulate the packets and provide the modulated packets to the antennas for transmission, and to demodulate packets received from the antennas.

In some cases, the wireless device may include a single antenna 1625. However, in some cases the device may have more than one antenna 1625, which may be capable of concurrently transmitting or receiving multiple wireless transmissions.

The memory 1630 may include RAM, ROM, or a combination thereof. The memory 1630 may store computer-readable code 1635 including instructions that, when executed by a processor (e.g., the processor 1640) cause the device to perform various functions described herein. In some cases, the memory 1630 may contain, among other things, a BIOS which may control basic hardware or software operation such as the interaction with peripheral components or devices.

The processor 1640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some cases, a memory controller may be integrated into processor 1640. The processor 1640 may be configured to execute computer-readable instructions stored in a memory (e.g., the memory 1630) to cause the device 1605 to perform various functions (e.g., functions or tasks supporting techniques for joint CSI reporting for SFN communication schemes).

The inter-station communications manager 1645 may manage communications with other base station 105, and may include a controller or scheduler for controlling communications with UEs 115 in cooperation with other base stations 105. For example, the inter-station communications manager 1645 may coordinate scheduling for transmissions to UEs 115 for various interference mitigation techniques such as beamforming or joint transmission. In some examples, the inter-station communications manager 1645 may provide an X2 interface within an LTE/LTE-A wireless communication network technology to provide communication between base stations 105.

The code 1635 may include instructions to implement aspects of the present disclosure, including instructions to support wireless communications. The code 1635 may be stored in a non-transitory computer-readable medium such as system memory or other type of memory. In some cases, the code 1635 may not be directly executable by the processor 1640 but may cause a computer (e.g., when compiled and executed) to perform functions described herein.

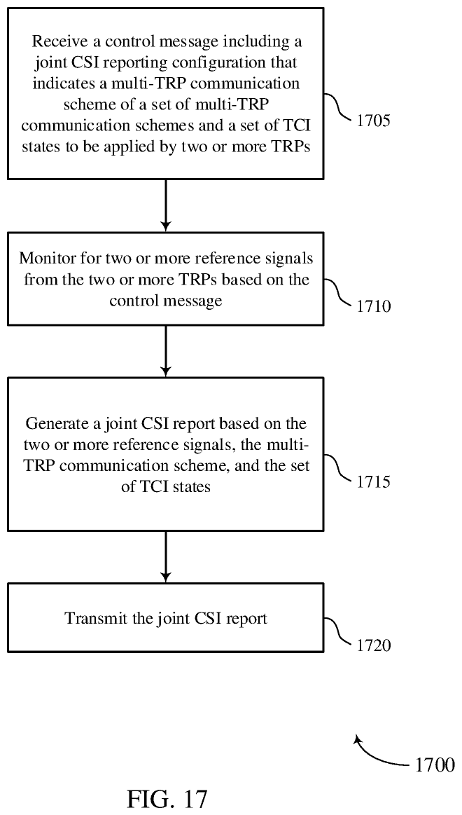

FIG. 17 shows a flowchart illustrating a method 1700 that supports techniques for joint CSI reporting for multiple TRP communication schemes in accordance with aspects of the present disclosure. The operations of method 1700 may be implemented by a UE 115 or its components as described herein. For example, the operations of method 1700 may be performed by a communications manager as described with reference to FIGS. 9 through 12. In some examples, a UE may execute a set of instructions to control the functional elements of the UE to perform the functions described herein. Additionally or alternatively, a UE may perform aspects of the functions described herein using special-purpose hardware.

At 1705, the UE may receive a control message including a joint CSI reporting configuration that indicates a multi-TRP communication scheme of a set of multi-TRP communication schemes and a set of transmission configuration indicator states to be applied by two or more TRPs. The operations of 1705 may be performed according to the methods described herein. In some examples, aspects of the operations of 1705 may be performed by a CSI report configuration component as described with reference to FIGS. 9 through 12.

At 1710, the UE may monitor for two or more reference signals from the two or more TRPs based on the control message. The operations of 1710 may be performed according to the methods described herein. In some examples, aspects of the operations of 1710 may be performed by a monitoring component as described with reference to FIGS. 9 through 12.

At 1715, the UE may generate a joint CSI report based on the two or more reference signals, the multi-TRP communication scheme, and the set of transmission configuration indicator states. The operations of 1715 may be performed according to the methods described herein. In some examples, aspects of the operations of 1715 may be performed by a CSI report component as described with reference to FIGS. 9 through 12.

At 1720, the UE may transmit the joint CSI report. The operations of 1720 may be performed according to the methods described herein. In some examples, aspects of the operations of 1720 may be performed by a CSI report component as described with reference to FIGS. 9 through 12.

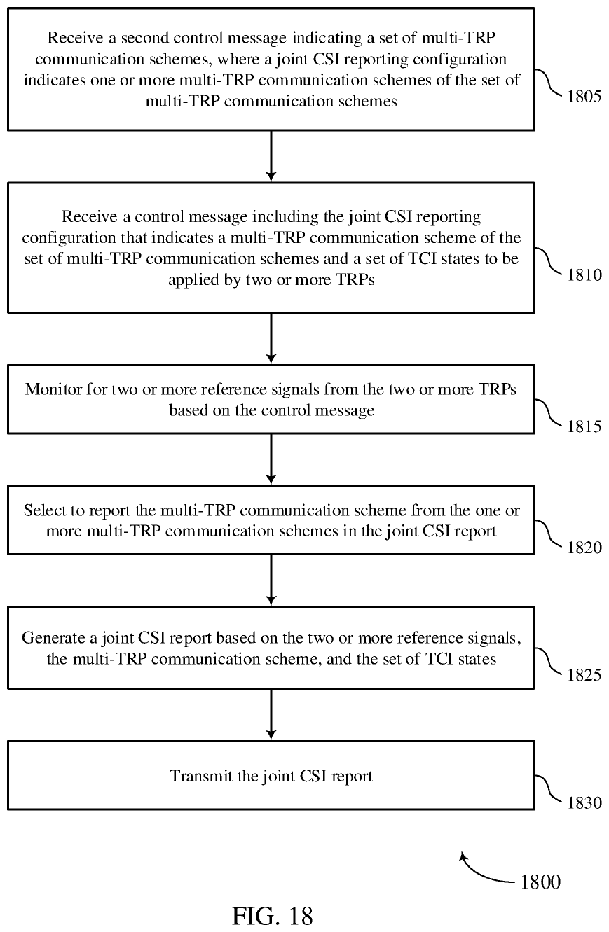

FIG. 18 shows a flowchart illustrating a method 1800 that supports techniques for joint CSI reporting for multiple TRP communication schemes in accordance with aspects of the present disclosure. The operations of method 1800 may be implemented by a UE 115 or its components as described herein. For example, the operations of method 1800 may be performed by a communications manager as described with reference to FIGS. 9 through 12. In some examples, a UE may execute a set of instructions to control the functional elements of the UE to perform the functions described herein. Additionally or alternatively, a UE may perform aspects of the functions described herein using special-purpose hardware.

At 1805, the UE may receive a second control message indicating a set of multi-TRP communication schemes, where a joint CSI reporting configuration indicates one or more multi-TRP communication schemes of the set of multi-TRP communication schemes. The operations of 1805 may be performed according to the methods described herein. In some examples, aspects of the operations of 1805 may be performed by a multi-TRP communication scheme component as described with reference to FIGS. 9 through 12.

At 1810, the UE may receive a control message including the joint CSI reporting configuration that indicates a multi-TRP communication scheme of the set of multi-TRP communication schemes and a set of transmission configuration indicator states to be applied by two or more TRPs. The operations of 1810 may be performed according to the methods described herein. In some examples, aspects of the operations of 1810 may be performed by a CSI report configuration component as described with reference to FIGS. 9 through 12.

At 1815, the UE may monitor for two or more reference signals from the two or more TRPs based on the control message. The operations of 1815 may be performed according to the methods described herein. In some examples, aspects of the operations of 1815 may be performed by a monitoring component as described with reference to FIGS. 9 through 12.

At 1820, the UE may select to report the multi-TRP communication scheme from the one or more multi-TRP communication schemes in the joint CSI report. The operations of 1820 may be performed according to the methods described herein. In some examples, aspects of the operations of 1820 may be performed by a scheme selection component as described with reference to FIGS. 9 through 12.

At 1825, the UE may generate the joint CSI report based on the two or more reference signals, the multi-TRP communication scheme, and the set of transmission configuration indicator states. The operations of 1825 may be performed according to the methods described herein. In some examples, aspects of the operations of 1825 may be performed by a CSI report component as described with reference to FIGS. 9 through 12.

At 1830, the UE may transmit the joint CSI report. The operations of 1830 may be performed according to the methods described herein. In some examples, aspects of the operations of 1830 may be performed by a CSI report component as described with reference to FIGS. 9 through 12.

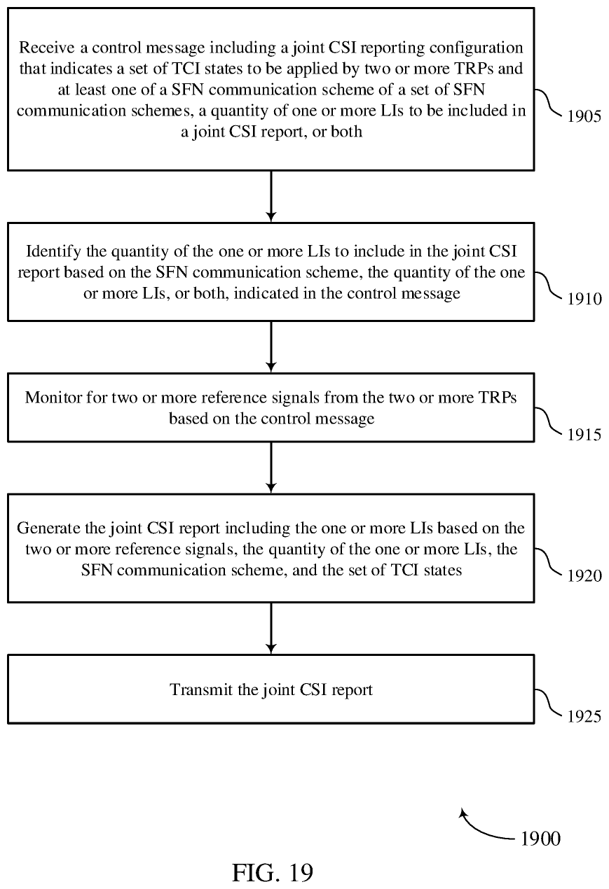

FIG. 19 shows a flowchart illustrating a method 1900 that supports techniques for joint CSI reporting for multiple TRP communication schemes in accordance with aspects of the present disclosure. The operations of method 1900 may be implemented by a UE 115 or its components as described herein. For example, the operations of method 1900 may be performed by a communications manager as described with reference to FIGS. 9 through 12. In some examples, a UE may execute a set of instructions to control the functional elements of the UE to perform the functions described herein. Additionally or alternatively, a UE may perform aspects of the functions described herein using special-purpose hardware.

At 1905, the UE may receive a control message including a joint CSI reporting configuration that indicates a set of transmission configuration indicator states to be applied by two or more TRPs and at least one of an SFN communication scheme of a set of SFN communication schemes, a quantity of one or more Us to be included in a joint CSI report, or both. The operations of 1905 may be performed according to the methods described herein. In some examples, aspects of the operations of 1905 may be performed by a CSI report configuration component as described with reference to FIGS. 9 through 12.

At 1910, the UE may identify the quantity of the one or more Us to include in the joint CSI report based on the SFN communication scheme, the quantity of the one or more Us, or both, indicated in the control message. The operations of 1910 may be performed according to the methods described herein. In some examples, aspects of the operations of 1910 may be performed by a CSI report configuration component as described with reference to FIGS. 9 through 12.

At 1915, the UE may monitor for two or more reference signals from the two or more TRPs based on the control message. The operations of 1915 may be performed according to the methods described herein. In some examples, aspects of the operations of 1915 may be performed by a monitoring component as described with reference to FIGS. 9 through 12.

At 1920, the UE may generate the joint CSI report including the one or more Us based on the two or more reference signals, the quantity of the one or more Us, the SFN communication scheme, and the set of transmission configuration indicator states. The operations of 1920 may be performed according to the methods described herein. In some examples, aspects of the operations of 1920 may be performed by a CSI report component as described with reference to FIGS. 9 through 12.

At 1925, the UE may transmit the joint CSI report. The operations of 1925 may be performed according to the methods described herein. In some examples, aspects of the operations of 1925 may be performed by a CSI report component as described with reference to FIGS. 9 through 12.

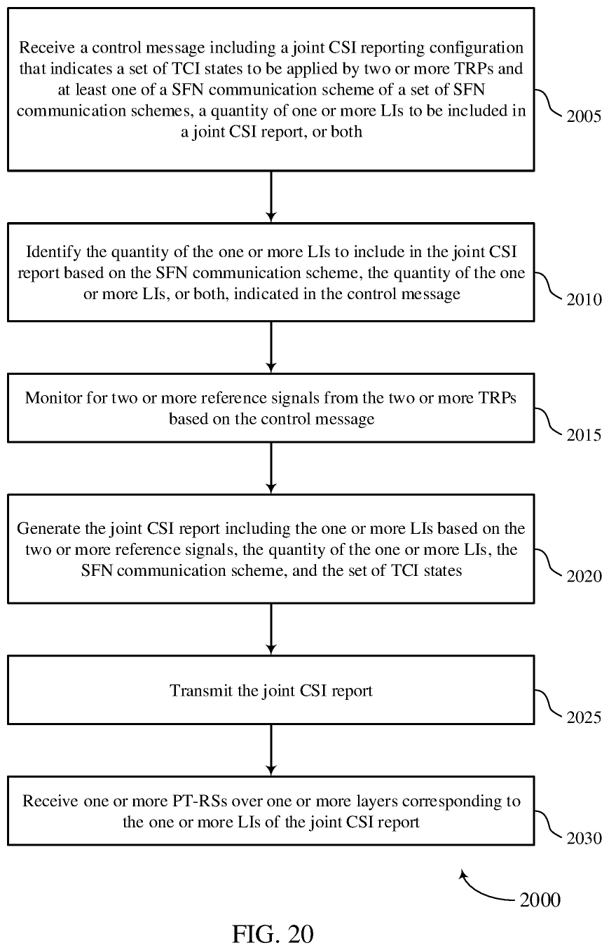

FIG. 20 shows a flowchart illustrating a method 2000 that supports techniques for joint CSI reporting for multiple TRP communication schemes in accordance with aspects of the present disclosure. The operations of method 2000 may be implemented by a UE 115 or its components as described herein. For example, the operations of method 2000 may be performed by a communications manager as described with reference to FIGS. 9 through 12. In some examples, a UE may execute a set of instructions to control the functional elements of the UE to perform the functions described herein. Additionally or alternatively, a UE may perform aspects of the functions described herein using special-purpose hardware.

At 2005, the UE may receive a control message including a joint CSI reporting configuration that indicates a set of transmission configuration indicator states to be applied by two or more TRPs and at least one of an SFN communication scheme of a set of SFN communication schemes, a quantity of one or more Us to be included in a joint CSI report, or both. The operations of 2005 may be performed according to the methods described herein. In some examples, aspects of the operations of 2005 may be performed by a CSI report configuration component as described with reference to FIGS. 9 through 12.

At 2010, the UE may identify the quantity of the one or more Us to include in the joint CSI report based on the SFN communication scheme, the quantity of the one or more Us, or both, indicated in the control message. The operations of 2010 may be performed according to the methods described herein. In some examples, aspects of the operations of 2010 may be performed by a CSI report configuration component as described with reference to FIGS. 9 through 12.

At 2015, the UE may monitor for two or more reference signals from the two or more TRPs based on the control message. The operations of 2015 may be performed according to the methods described herein. In some examples, aspects of the operations of 2015 may be performed by a monitoring component as described with reference to FIGS. 9 through 12.

At 2020, the UE may generate the joint CSI report including the one or more Us based on the two or more reference signals, the quantity of the one or more Us, the SFN communication scheme, and the set of transmission configuration indicator states. The operations of 2020 may be performed according to the methods described herein. In some examples, aspects of the operations of 2020 may be performed by a CSI report component as described with reference to FIGS. 9 through 12.

At 2025, the UE may transmit the joint CSI report. The operations of 2025 may be performed according to the methods described herein. In some examples, aspects of the operations of 2025 may be performed by a CSI report component as described with reference to FIGS. 9 through 12.

At 2030, the UE may receive one or more phase tracking reference signals over one or more layers corresponding to the one or more Us of the joint CSI report. The operations of 2030 may be performed according to the methods described herein. In some examples, aspects of the operations of 2030 may be performed by a monitoring component as described with reference to FIGS. 9 through 12.

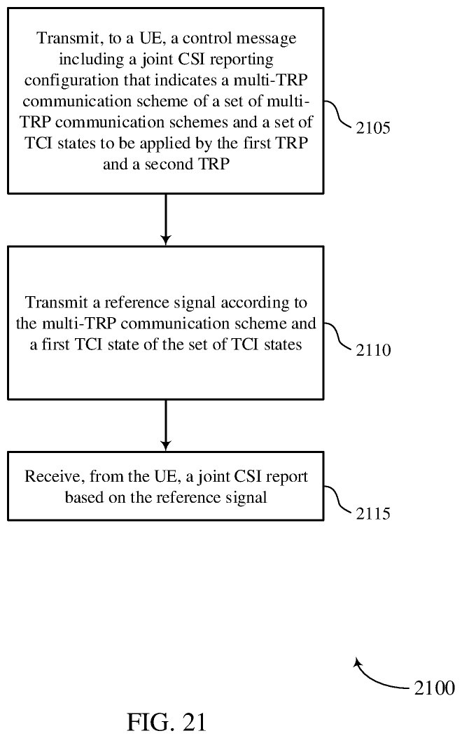

FIG. 21 shows a flowchart illustrating a method 2100 that supports techniques for joint CSI reporting for multiple TRP communication schemes in accordance with aspects of the present disclosure. The operations of method 2100 may be implemented by a base station 105 or its components as described herein. For example, the operations of method 2100 may be performed by a communications manager as described with reference to FIGS. 13 through 16. In some examples, a base station may execute a set of instructions to control the functional elements of the base station to perform the functions described herein. Additionally or alternatively, a base station may perform aspects of the functions described herein using special-purpose hardware.

At 2105, the base station may transmit, to a UE, a control message including a joint CSI reporting configuration that indicates a multi-TRP communication scheme of a set of multi-TRP communication schemes and a set of transmission configuration indicator states to be applied by the first TRP and a second TRP. The operations of 2105 may be performed according to the methods described herein. In some examples, aspects of the operations of 2105 may be performed by a CSI report configuration component as described with reference to FIGS. 13 through 16.

At 2110, the base station may transmit a reference signal according to the multi-TRP communication scheme and a first transmission configuration indicator state of the set of transmission configuration indicator states. The operations of 2110 may be performed according to the methods described herein. In some examples, aspects of the operations of 2110 may be performed by a multi-TRP communication scheme component as described with reference to FIGS. 13 through 16.

At 2115, the base station may receive, from the UE, a joint CSI report based on the reference signal. The operations of 2115 may be performed according to the methods described herein. In some examples, aspects of the operations of 2115 may be performed by a CSI report component as described with reference to FIGS. 13 through 16.

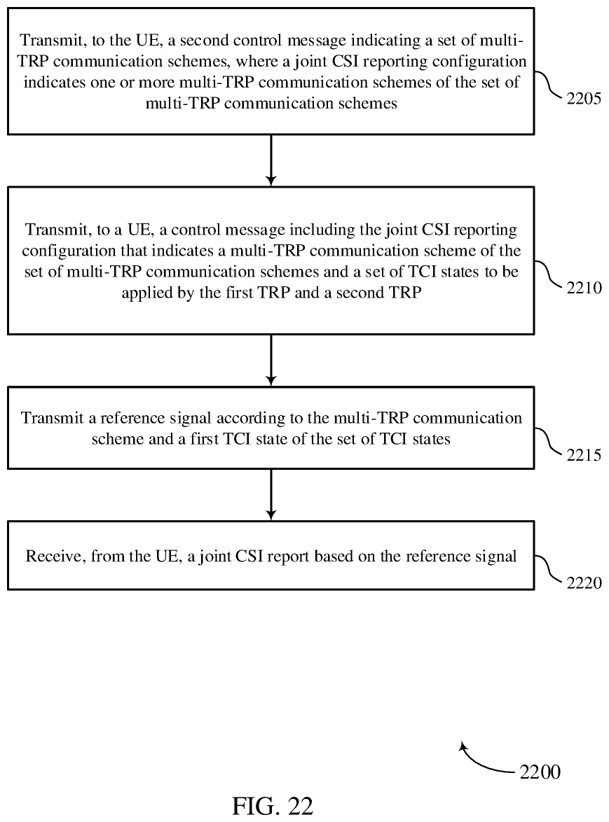

FIG. 22 shows a flowchart illustrating a method 2200 that supports techniques for joint CSI reporting for multiple TRP communication schemes in accordance with aspects of the present disclosure. The operations of method 2200 may be implemented by a base station 105 or its components as described herein. For example, the operations of method 2200 may be performed by a communications manager as described with reference to FIGS. 13 through 16. In some examples, a base station may execute a set of instructions to control the functional elements of the base station to perform the functions described herein. Additionally or alternatively, a base station may perform aspects of the functions described herein using special-purpose hardware.

At 2205, the base station may transmit, to the UE, a second control message indicating a set of multi-TRP communication schemes, where a joint CSI reporting configuration indicates one or more multi-TRP communication schemes of the set of multi-TRP communication schemes. The operations of 2205 may be performed according to the methods described herein. In some examples, aspects of the operations of 2205 may be performed by a multi-TRP communication scheme component as described with reference to FIGS. 13 through 16.

At 2210, the base station may transmit, to a UE, a control message including the joint CSI reporting configuration that indicates a multi-TRP communication scheme of the set of multi-TRP communication schemes and a set of transmission configuration indicator states to be applied by the first TRP and a second TRP. The operations of 2210 may be performed according to the methods described herein. In some examples, aspects of the operations of 2210 may be performed by a CSI report configuration component as described with reference to FIGS. 13 through 16.

At 2215, the base station may transmit a reference signal according to the multi-TRP communication scheme and a first transmission configuration indicator state of the set of transmission configuration indicator states. The operations of 2215 may be performed according to the methods described herein. In some examples, aspects of the operations of 2215 may be performed by a multi-TRP communication scheme component as described with reference to FIGS. 13 through 16.

At 2220, the base station may receive, from the UE, a joint CSI report based on the reference signal. The operations of 2220 may be performed according to the methods described herein. In some examples, aspects of the operations of 2220 may be performed by a CSI report component as described with reference to FIGS. 13 through 16.

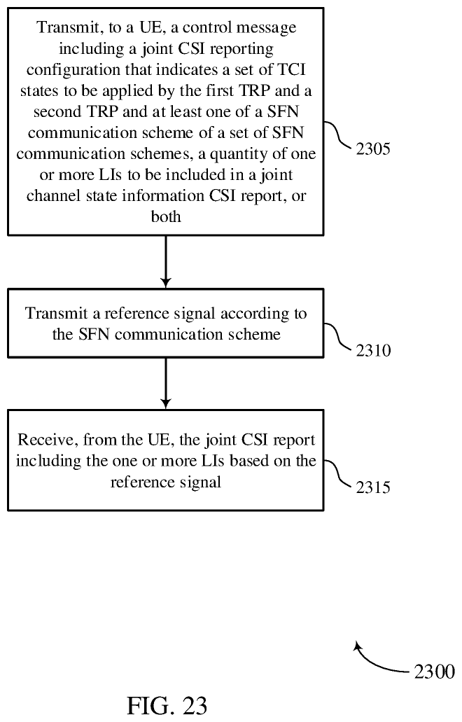

FIG. 23 shows a flowchart illustrating a method 2300 that supports techniques for joint CSI reporting for multiple TRP communication schemes in accordance with aspects of the present disclosure. The operations of method 2300 may be implemented by a base station 105 or its components as described herein. For example, the operations of method 2300 may be performed by a communications manager as described with reference to FIGS. 13 through 16. In some examples, a base station may execute a set of instructions to control the functional elements of the base station to perform the functions described herein. Additionally or alternatively, a base station may perform aspects of the functions described herein using special-purpose hardware.

At 2305, the base station may transmit, to a UE, a control message including a joint CSI reporting configuration that indicates a set of transmission configuration indicator states to be applied by the first TRP and a second TRP and at least one of an SFN communication scheme of a set of SFN communication schemes, a quantity of one or more Us to be included in a joint CSI report, or both. The operations of 2305 may be performed according to the methods described herein. In some examples, aspects of the operations of 2305 may be performed by a CSI report configuration component as described with reference to FIGS. 13 through 16.

At 2310, the base station may transmit a reference signal according to the SFN communication scheme. The operations of 2310 may be performed according to the methods described herein. In some examples, aspects of the operations of 2310 may be performed by an SFN communication scheme component as described with reference to FIGS. 13 through 16.

At 2315, the base station may receive, from the UE, the joint CSI report including the one or more Us based on the reference signal. The operations of 2315 may be performed according to the methods described herein. In some examples, aspects of the operations of 2315 may be performed by a CSI report component as described with reference to FIGS. 13 through 16.

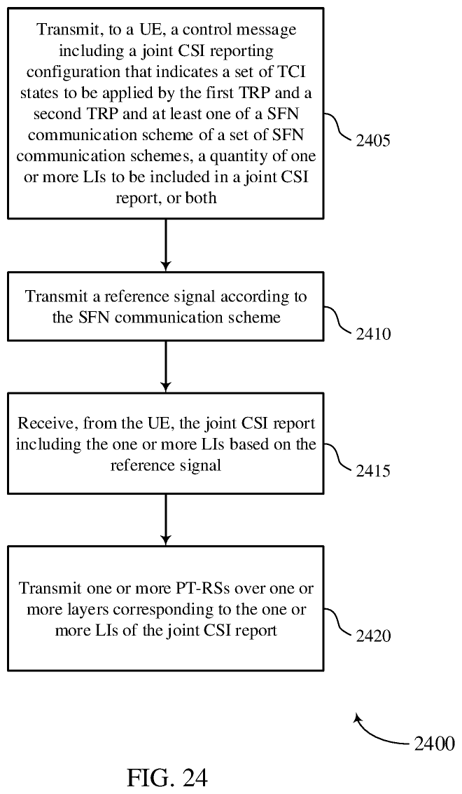

FIG. 24 shows a flowchart illustrating a method 2400 that supports techniques for joint CSI reporting for multiple TRP communication schemes in accordance with aspects of the present disclosure. The operations of method 2400 may be implemented by a base station 105 or its components as described herein. For example, the operations of method 2400 may be performed by a communications manager as described with reference to FIGS. 13 through 16. In some examples, a base station may execute a set of instructions to control the functional elements of the base station to perform the functions described herein. Additionally or alternatively, a base station may perform aspects of the functions described herein using special-purpose hardware.

At 2405, the base station may transmit, to a UE, a control message including a joint CSI reporting configuration that indicates a set of transmission configuration indicator states to be applied by the first TRP and a second TRP and at least one of an SFN communication scheme of a set of SFN communication schemes, a quantity of one or more Us to be included in a joint CSI report, or both. The operations of 2405 may be performed according to the methods described herein. In some examples, aspects of the operations of 2405 may be performed by a CSI report configuration component as described with reference to FIGS. 13 through 16.

At 2410, the base station may transmit a reference signal according to the SFN communication scheme. The operations of 2410 may be performed according to the methods described herein. In some examples, aspects of the operations of 2410 may be performed by an SFN communication scheme component as described with reference to FIGS. 13 through 16.

At 2415, the base station may receive, from the UE, the joint CSI report including the one or more Us based on the reference signal. The operations of 2415 may be performed according to the methods described herein. In some examples, aspects of the operations of 2415 may be performed by a CSI report component as described with reference to FIGS. 13 through 16.

At 2420, the base station may transmit one or more phase tracking reference signals over one or more layers corresponding to the one or more Us of the joint CSI report. The operations of 2420 may be performed according to the methods described herein. In some examples, aspects of the operations of 2420 may be performed by a PT-RS component as described with reference to FIGS. 13 through 16.

It should be noted that the methods described herein describe possible implementations, and that the operations and the steps may be rearranged or otherwise modified and that other implementations are possible. Further, aspects from two or more of the methods may be combined.

Example 1: A method for wireless communication at a UE, comprising: receiving a control message comprising a joint CSI reporting configuration that indicates a multi-TRP communication scheme of a plurality of multi-TRP communication schemes and a plurality of TCI states to be applied by two or more TRPs; monitoring for two or more reference signals from the two or more TRPs based at least in part on the control message; generating a joint CSI report based at least in part on the two or more reference signals, the multi-TRP communication scheme, and the plurality of TCI states; and transmitting the joint CSI report.

Example 2: The method of example 1, wherein transmitting the joint CSI report comprises: transmitting the joint CSI report comprising one or more CSI parameters according to the multi-TRP communication scheme.

Example 3: The method of example 2, wherein the one or more CSI parameters comprise one or more PMIs, one or more RIs, one or more Us, or one or more CQIs.

Example 4: The method of any one of examples 1-3, wherein transmitting the joint CSI report comprises: transmitting the joint CSI report comprising a quantity of one or more reported CSI parameters that is selected according to the multi-TRP communication scheme.

Example 5: The method of any one of examples 1-4, further comprising: receiving a second control message indicating the plurality of multi-TRP communication schemes, wherein the joint CSI reporting configuration indicates one or more multi-TRP communication schemes of the plurality of multi-TRP communication schemes; and selecting to report the multi-TRP communication scheme from the one or more multi-TRP communication schemes in the joint CSI report.

Example 6: The method of example 5, wherein transmitting the joint CSI report comprises: transmitting the joint CSI report including an indication of the multi-TRP communication scheme that is selected from the one or more multi-TRP communication schemes based at least in part on a respective spectral efficiency metric observed for the one or more multi-TRP communication schemes.

Example 7: The method of example 6, wherein transmitting the joint CSI report further comprises: transmitting the indication of the multi-TRP communication scheme in a first part of the joint CSI report; and transmitting one or more CSI parameters according to the multi-TRP communication scheme in a second part of the joint CSI report.

Example 8: The method of example 7, wherein the first part of the joint CSI report is associated with a fixed size and the second part of the joint CSI report is associated with a variable size that is based at least in part on the multi-TRP communication scheme.

Example 9: The method of any one of examples 5-8, wherein each of the one or more multi-TRP communication schemes indicated by the joint CSI reporting configuration correspond to at least one CSI reporting hypothesis.

Example 10: The method of any one of examples 1-9, wherein receiving the control message comprises: receiving the control message via RRC signaling, a MAC-CE, DCI, or any combination thereof.

Example 11: The method of any one of examples 1-10, wherein the plurality of multi-TRP communication schemes comprise a SDM communication scheme, a TDM scheme, a FDM scheme, a coherent joint transmission communication scheme, a first SFN communication scheme in which each DMRS and each data layer of a data transmission are associated with a single TCI state, a second SFN communication scheme in which each DMRS port and each data layer of the data transmission are associated with the plurality of TCI states, a third SFN communication scheme in which each data layer of the data transmission are associated with the plurality of TCI states and in which each DMRS port is associated with one of the plurality of TCI states, or any combination thereof.

Example 12: The method of any one of examples 1-11, wherein the two or more TRPs comprise a first TRP and a second TRP and the plurality of TCI states comprise a first TCI state and a second TCI state, and wherein the first TRP applies the first TCI state and the second TRP applies the second TCI state.

Example 13: A method for wireless communication at a UE, comprising: receiving a control message comprising a joint CSI reporting configuration that indicates a plurality of TCI states to be applied by two or more TRPs and at least one of a SFN communication scheme of a plurality of SFN communication schemes, a quantity of one or more Us to be included in a joint CSI report, or both; identifying the quantity of the one or more Us to include in the joint CSI report based at least in part on the SFN communication scheme, the quantity of the one or more Us, or both, indicated in the control message; monitoring for two or more reference signals from the two or more TRPs based at least in part on the control message; generating the joint CSI report comprising the one or more Us based at least in part on the two or more reference signals, the quantity of the one or more Us, the SFN communication scheme, and the plurality of TCI states; and transmitting the joint CSI report.

Example 14: The method of example 13, wherein transmitting the joint CSI report comprises: transmitting the joint CSI report comprising a first PMI associated with a first TCI state of the plurality of TCI states and a second PMI associated with a second TCI state of the plurality of TCI states.

Example 15: The method of example 14, wherein transmitting the joint CSI report further comprises: transmitting the joint CSI report comprising a single LI based at least in part on the SFN communication scheme, wherein the single LI indicates a layer corresponding to a same column in each of the first PMI and the second PMI.

Example 16: The method of example 14, wherein transmitting the joint CSI report further comprises: transmitting the joint CSI report comprising a first LI and a second LI based at least in part on the SFN communication scheme, wherein the first LI corresponds to a first layer corresponding to a first column of the first PMI and the second LI corresponds to a second layer corresponding to a second column of the second PMI.

Example 17: The method of example 14, wherein transmitting the joint CSI report further comprises: transmitting the joint CSI report comprising a single LI based at least in part on the SFN communication scheme, wherein the single LI indicates a layer corresponding to a column of one of the first PMI or the second PMI.

Example: 18: The method of example 17, wherein the one of the first PMI or the second PMI reported in the joint CSI report is preconfigured or signaled.

Example 19: The method of example 17, wherein the one of the first PMI or the second PMI reported in the joint CSI report is selected based at least in part on a signal metric, and wherein transmitting the joint CSI report further comprises: transmitting the joint CSI report comprising an indication of the selected one of the first PMI or the second PMI.

Example 20: The method of any one of examples 14-19, wherein the first PMI and the second PMI have a same number of columns corresponding to a jointly selected RI.

Example 21: The method of any one of examples 13-20, further comprising: receiving one or more phase tracking reference signals over one or more layers corresponding to the one or more LIs of the joint CSI report.

Example 22: The method of any one of examples 13-21, wherein receiving the control message comprises: receiving the control message comprising an indication of a single reference signal resource associated with the plurality of TCI states, wherein the single reference signal resource is associated with a plurality of reference signal port groups, each reference signal port group of the plurality of reference signal port groups corresponding to one of the plurality of TCI states.

Example 23: The method of example 22, further comprising: monitoring the single reference signal resource, wherein each of the two or more reference signals is received based at least in part on monitoring the single reference signal resource, each of the two or more reference signals corresponding to a reference signal port group of the plurality of reference signal port groups.

Example 24: The method of any one of examples 13-21, wherein receiving the control message comprises: receiving the control message comprising an indication of a plurality of reference signal resources, each reference signal resource of the plurality of reference signal resources corresponding to one of the plurality of TCI states.

Example 25: The method of example 24, further comprising: monitoring the plurality of reference signal resources, wherein each of the two or more reference signals is received based at least in part on monitoring the plurality of reference signal resources, each of the two or more reference signals corresponding to a reference signal resource of the plurality of reference signal resources.

Example 26: The method of any one of examples 13-25, wherein transmitting the joint CSI report comprises: transmitting the one or more Us in a first part of the joint CSI report, the first part of the joint CSI report having a fixed size.

Example 27: The method of any one of examples 13-25, wherein transmitting the joint CSI report comprises: transmitting the one or more Us in a second part of the joint CSI report, the second part of the joint CSI report having a variable size.

Example 28: The method of example 13, wherein transmitting the joint CSI report comprises: transmitting the joint CSI report comprising a single PMI corresponding to all ports or a plurality of ports of the two or more reference signals.

Example 29: The method of example 13, wherein transmitting the joint CSI report comprises: transmitting the joint CSI report comprising a single PMI corresponding to a port-to-port sum of respective pluralities of ports associated with the two or more reference signals.

Example 30: The method of any one of examples 13-29, wherein the joint CSI reporting configuration comprises a field indicating the quantity of the one or more Us to be included in the joint CSI report, the quantity corresponding to the SFN communication scheme.

Example 31: The method of any one of examples 13-30, wherein receiving the control message comprises: receiving the control message via RRC signaling, a MAC-CE, DCI, or any combination thereof.

Example 32: The method of any one of examples 13-31, wherein the plurality of SFN communication schemes comprise a coherent joint transmission communication scheme, a first SFN communication scheme in which each DMRS and each data layer of a data transmission are associated with a single TCI state, a second SFN communication scheme in which each DMRS port and each data layer of the data transmission are associated with the plurality of TCI states, a third SFN communication scheme in which each data layer of the data transmission are associated with the plurality of TCI states and in which each DMRS port is associated with one of the plurality of TCI states, or any combination thereof.

Example 33: The method of any one of examples 13-32, wherein the two or more TRPs comprise a first TRP and a second TRP and the plurality of TCI states comprise a first TCI state and a second TCI state, and wherein the first TRP applies the first TCI state and the second TRP applies the second TCI state.

Example 34: A method for wireless communication at a first TRP, comprising: transmitting, to a UE, a control message comprising a joint CSI reporting configuration that indicates a multi-TRP communication scheme of a plurality of multi-TRP communication schemes and a plurality of TCI states to be applied by the first TRP and a second TRP; transmitting a reference signal according to the multi-TRP communication scheme and a first TCI state of the plurality of TCI states; receiving, from the UE, a joint CSI report based at least in part on the reference signal.

Example 35: The method of example 34, wherein receiving the joint CSI report comprises: receiving the joint CSI report comprising one or more CSI parameters according to the multi-TRP communication scheme.

Example 36: The method of example 35, wherein the one or more CSI parameters comprise one or more PMIs, one or more RIs, one or more Us, or one or more CQIs.

Example 37: The method of any one of examples 34-36, wherein receiving the joint CSI report comprises: receiving the joint CSI report comprising a quantity of one or more reported CSI parameters that is selected according to the multi-TRP communication scheme.

Example 38: The method of any one of examples 34-37, further comprising: transmitting, to the UE, a second control message indicating the plurality of multi-TRP communication schemes, wherein the joint CSI reporting configuration indicates one or more multi-TRP communication schemes of the plurality of multi-TRP communication schemes.

Example 39: The method of example 38, wherein receiving the joint CSI report comprises: receiving the joint CSI report including an indication of the multi-TRP communication scheme that is selected from the one or more multi-TRP communication schemes based at least in part on a respective spectral efficiency metric observed for the one or more multi-TRP communication schemes.

Example 40: The method of example 39, wherein receiving the joint CSI report comprises: receiving the indication of the multi-TRP communication scheme in a first part of the joint CSI report; and receiving one or more CSI parameters according to the multi-TRP communication scheme in a second part of the joint CSI report.

Example 41: The method of example 40, wherein the first part of the joint CSI report is associated with a fixed size and the second part of the joint CSI report is associated with a variable size that is based at least in part on the multi-TRP communication scheme.

Example 42: The method of any one of examples 38-41, wherein each of the one or more multi-TRP communication schemes indicated by the joint CSI reporting configuration correspond to at least one CSI reporting hypothesis.

Example 43: The method of any one of examples 34-42, wherein transmitting the control message comprises: transmitting the control message via RRC signaling, a MAC-CE, DCI, or any combination thereof.

Example 44: The method of any one of examples 34-43, wherein the plurality of multi-TRP communication schemes comprise a SDM communication scheme, a TDM scheme, a FDM scheme, a coherent joint transmission communication scheme, a first SFN communication scheme in which each DMRS and each data layer of a data transmission are associated with a single TCI state, a second SFN communication scheme in which each DMRS port and each data layer of the data transmission are associated with the plurality of TCI states, a third SFN communication scheme in which each data layer of the data transmission are associated with the plurality of TCI states and in which each DMRS port is associated with one of the plurality of TCI states, or any combination thereof.

Example 45: The method of any one of examples 34-44, wherein the plurality of TCI states comprise the first TCI state and a second TCI state, and wherein the first TRP applies the first TCI state and the second TRP applies the second TCI state.

Example 46: A method for wireless communication at a first TRP, comprising: transmitting, to a UE, a control message comprising a joint CSI reporting configuration that indicates a plurality of TCI states to be applied by the first TRP and a second TRP and at least one of a SFN communication scheme of a plurality of SFN communication schemes, a quantity of one or more Us to be included in a joint CSI report, or both; transmitting a reference signal according to the SFN communication scheme; and receiving, from the UE, the joint CSI report comprising the one or more Us based at least in part on the reference signal.

Example 47: The method of example 46, wherein receiving the joint CSI report comprises: receiving the joint CSI report comprising a first PMI associated with a first TCI state of the plurality of TCI states and a second PMI associated with a second TCI state of the plurality of TCI states.

Example 48: The method of example 47, wherein receiving the joint CSI report further comprises: receiving the joint CSI report comprising one a single LI based at least in part on the SFN communication scheme, wherein the single LI indicates a layer corresponding to a same column in each of the first PMI and the second PMI.

Example 49: The method of example 47, wherein receiving the joint CSI report further comprises: receiving the joint CSI report comprising a first LI and a second LI based at least in part on the SFN communication scheme, wherein the first LI corresponds to a first layer corresponding to a first column of the first PMI and the second LI corresponds to a second layer corresponding to a second column of the second PMI.

Example 50: The method of example 47, wherein receiving the joint CSI report further comprises: receiving the joint CSI report comprising a single LI based at least in part on the SFN communication scheme, wherein the single LI indicates a layer corresponding to a column of one of the first PMI or the second PMI.

Example 51: The method of example 50, wherein the one of the first PMI or the second PMI reported in the joint CSI report is preconfigured or signaled.

Example 52: The method of example 50, wherein the one of the first PMI or the second PMI reported in the joint CSI report is selected based at least in part on a signal metric, and wherein receiving the joint CSI report further comprises: receiving the joint CSI report comprising an indication of the selected one of the first PMI or the second PMI.

Example 53: The method of any one of examples 47-52, wherein the first PMI and the second PMI have a same number of columns corresponding to a jointly selected RI.

Example 54: The method of any one of examples 46-53, further comprising: transmitting one or more phase tracking reference signals over one or more layers corresponding to the one or more LIs of the joint CSI report.

Example 55: The method of any one of examples 46-54, wherein transmitting the control message comprises: transmitting the control message comprising an indication of a single reference signal resource associated with the plurality of TCI states, wherein the single reference signal resource is associated with a plurality of reference signal port groups, each reference signal port group of the plurality of reference signal port groups corresponding to one of the plurality of TCI states.

Example 56: The method of any one of examples 46-54, wherein transmitting the control message comprises: transmitting the control message comprising an indication of a plurality of reference signal resources, each reference signal resource of the plurality of reference signal resources corresponding to one of the plurality of TCI states.

Example 57: The method of any one of examples 46-56, wherein receiving the joint CSI report comprises: receiving the one or more Us in a first part of the joint CSI report, the first part of the joint CSI report having a fixed size.

Example 58: The method of any one of examples 46-56, wherein receiving the joint CSI report comprises: receiving the one or more Us in a second part of the joint CSI report, the second part of the joint CSI report having a variable size.

Example 59: The method of example 46, wherein receiving the joint CSI report comprises: receiving the joint CSI report comprising a single PMI corresponding to all ports or a plurality of ports associated with two or more reference signals, the two or more reference signals comprising the reference signal.

Example 60: The method of example 46, wherein receiving the joint CSI report comprises: receiving the joint CSI report comprising a single PMI corresponding to a port-to-port sum of respective pluralities of ports associated with two or more reference signals, the two or more reference signals comprising the reference signal.

Example 61: The method of any one of examples 46-60, wherein the joint CSI reporting configuration comprises a field indicating the quantity of the one or more Us to be included in the joint CSI report, the quantity corresponding to the SFN communication scheme.

Example 62: The method of any one of examples 46-61, wherein transmitting the control message comprises: transmitting the control message via RRC signaling, a MAC-CE, DCI, or any combination thereof.

Example 63: The method of any one of examples 46-62, wherein the plurality of SFN communication schemes comprise a first SFN communication scheme in which each DMRS and each data layer of a data transmission are associated with a single TCI state, a second SFN communication scheme in which each DMRS port and each data layer of the data transmission are associated with the plurality of TCI states, a third SFN communication scheme in which each data layer of the data transmission are associated with the plurality of TCI states and in which each DMRS port is associated with one of the plurality of TCI states, or any combination thereof.

Example 64: The method of any one of examples 46-63, wherein the plurality of TCI states comprise a first TCI state and a second TCI state, and wherein the first TRP applies the first TCI state and the second TRP applies the second TCI state.

Example 65: An apparatus comprising at least one means for performing a method of any of examples 1-12.

Example 66: An apparatus for wireless communications comprising a processor; memory in electronic communication with the processor; and instructions stored in the memory and executable by the processor to cause the apparatus to perform a method of any of examples 1-12.

Example 67: A non-transitory computer-readable medium storing code for wireless communications, the code comprising instructions executable by a processor to perform a method of any of examples 1-12.

Example 68: An apparatus comprising at least one means for performing a method of any of examples 13-33.

Example 69: An apparatus for wireless communications comprising a processor; memory in electronic communication with the processor; and instructions stored in the memory and executable by the processor to cause the apparatus to perform a method of any of examples 13-33.

Example 70: A non-transitory computer-readable medium storing code for wireless communications, the code comprising instructions executable by a processor to perform a method of any of examples 13-33.

Example 71: An apparatus comprising at least one means for performing a method of any of examples 34-45.

Example 72: An apparatus for wireless communications comprising a processor; memory in electronic communication with the processor; and instructions stored in the memory and executable by the processor to cause the apparatus to perform a method of any of examples 34-45.

Example 73: A non-transitory computer-readable medium storing code for wireless communications, the code comprising instructions executable by a processor to perform a method of any of examples 34-45.

Example 74: An apparatus comprising at least one means for performing a method of any of examples 46-64.

Example 75: An apparatus for wireless communications comprising a processor; memory in electronic communication with the processor; and instructions stored in the memory and executable by the processor to cause the apparatus to perform a method of any of examples 46-64.

Example 76: A non-transitory computer-readable medium storing code for wireless communications, the code comprising instructions executable by a processor to perform a method of any of examples 46-64.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communication at a user equipment (UE), comprising:
receiving a control message comprising a joint channel state information reporting configuration that indicates a multi-transmission and reception point communication scheme of a plurality of multi-transmission and reception point communication schemes and a plurality of transmission configuration indicator states to be applied by two or more transmission and reception points;
monitoring for two or more reference signals from the two or more transmission and reception points based at least in part on the control message;
generating a joint channel state information report based at least in part on the two or more reference signals, the multi-transmission and reception point communication scheme, and the plurality of transmission configuration indicator states; and
transmitting the joint channel state information report.

2. The method of claim 1, wherein transmitting the joint channel state information report comprises:
transmitting the joint channel state information report comprising one or more channel state information parameters according to the multi-transmission and reception point communication scheme.

3. The method of claim 2, wherein the one or more channel state information parameters comprise one or more precoding matrix indicators, one or more rank indicators, one or more layer indicators, or one or more channel quality indicators.

4. The method of claim 1, wherein transmitting the joint channel state information report comprises:
transmitting the joint channel state information report comprising a quantity of one or more reported channel state information parameters that is selected according to the multi-transmission and reception point communication scheme.

5. The method of claim 1, further comprising:
receiving a second control message indicating the plurality of multi-transmission and reception point communication schemes, wherein the joint channel state information reporting configuration indicates one or more multi-transmission and reception point communication schemes of the plurality of multi-transmission and reception point communication schemes; and
selecting to report the multi-transmission and reception point communication scheme from the one or more multi-transmission and reception point communication schemes in the joint channel state information report.

6-33. (canceled)

34. A method for wireless communication at a first transmission and reception point, comprising:
transmitting, to a user equipment (UE), a control message comprising a joint channel state information reporting configuration that indicates a multi-transmission and reception point communication scheme of a plurality of multi-transmission and reception point communication schemes and a plurality of transmission configuration indicator states to be applied by the first transmission and reception point and a second transmission and reception point;
transmitting a reference signal according to the multi-transmission and reception point communication scheme and a first transmission configuration indicator state of the plurality of transmission configuration indicator states; and
receiving, from the UE, a joint channel state information report based at least in part on the reference signal.

35. The method of claim 34, wherein receiving the joint channel state information report comprises:
receiving the joint channel state information report comprising one or more channel state information parameters according to the multi-transmission and reception point communication scheme.

36. The method of claim 35, wherein the one or more channel state information parameters comprise one or more precoding matrix indicators, one or more rank indicators, one or more layer indicators, or one or more channel quality indicators.

37. The method of claim 34, wherein receiving the joint channel state information report comprises:
receiving the joint channel state information report comprising a quantity of one or more reported channel state information parameters that is selected according to the multi-transmission and reception point communication scheme.

38. The method of claim 34, further comprising:
transmitting, to the UE, a second control message indicating the plurality of multi-transmission and reception point communication schemes, wherein the joint channel state information reporting configuration indicates one or more multi-transmission and reception point communication schemes of the plurality of multi-transmission and reception point communication schemes.

39-64. (canceled)

65. An apparatus for wireless communication at a user equipment (UE), comprising:
a processor,
memory coupled with the processor; and
instructions stored in the memory and executable by the processor to cause the apparatus to:
receive a control message comprising a joint channel state information reporting configuration that indicates a multi-transmission and reception point communication scheme of a plurality of multi-transmission and reception point communication schemes and a plurality of transmission configuration indicator states to be applied by two or more transmission and reception points;
monitor for two or more reference signals from the two or more transmission and reception points based at least in part on the control message;
generate a joint channel state information report based at least in part on the two or more reference signals, the multi-transmission and reception point communication scheme, and the plurality of transmission configuration indicator states; and
transmit the joint channel state information report.

66. The apparatus of claim 65, wherein the instructions to transmit the joint channel state information report are executable by the processor to cause the apparatus to:
transmit the joint channel state information report comprising one or more channel state information parameters according to the multi-transmission and reception point communication scheme.

67. The apparatus of claim 66, wherein the one or more channel state information parameters comprise one or more precoding matrix indicators, one or more rank indicators, one or more layer indicators, or one or more channel quality indicators.

68. The apparatus of claim 65, wherein the instructions to transmit the joint channel state information report are executable by the processor to cause the apparatus to:
transmit the joint channel state information report comprising a quantity of one or more reported channel state information parameters that is selected according to the multi-transmission and reception point communication scheme.

69. The apparatus of claim 65, wherein the instructions are further executable by the processor to cause the apparatus to:
receive a second control message indicating the plurality of multi-transmission and reception point communication schemes, wherein the joint channel state information reporting configuration indicates one or more multi-transmission and reception point communication schemes of the plurality of multi-transmission and reception point communication schemes; and
select to report the multi-transmission and reception point communication scheme from the one or more multi-transmission and reception point communication schemes in the joint channel state information report.

70. The apparatus of claim 69, wherein the instructions to transmit the joint channel state information report are executable by the processor to cause the apparatus to:
transmit the joint channel state information report including an indication of the multi-transmission and reception point communication scheme that is selected from the one or more multi-transmission and reception point communication schemes based at least in part on a respective spectral efficiency metric observed for the one or more multi-transmission and reception point communication schemes.

71. The apparatus of claim 70, wherein the instructions to transmit the joint channel state information report further are executable by the processor to cause the apparatus to:
transmit the indication of the multi-transmission and reception point communication scheme in a first part of the joint channel state information report; and
transmit one or more channel state information parameters according to the multi-transmission and reception point communication scheme in a second part of the joint channel state information report, wherein the first part of the joint channel state information report is associated with a fixed size and the second part of the joint channel state information report is associated with a variable size that is based at least in part on the multi-transmission and reception point communication scheme.

72. (canceled)

73. The apparatus of claim 69, wherein each of the one or more multi-transmission and reception point communication schemes indicated by the joint channel state information reporting configuration correspond to at least one channel state information reporting hypothesis.

74. The apparatus of claim 65, wherein the instructions to receive the control message are executable by the processor to cause the apparatus to:
receive the control message via radio resource control signaling, a medium access control (MAC) control element, downlink control information, or any combination thereof.

75. The apparatus of claim 65, wherein the plurality of multi-transmission and reception point communication schemes comprise a space-division multiplexing communication scheme, a time-division multiplexing scheme, a frequency-division multiplexing scheme, a coherent joint transmission communication scheme, a first single frequency network communication scheme in which each DMRS and each data layer of a data transmission are associated with a single transmission configuration indicator state, a second single frequency network communication scheme in which each DMRS port and each data layer of the data transmission are associated with the plurality of transmission configuration indicator states, a third single frequency network communication scheme in which each data layer of the data transmission are associated with the plurality of transmission configuration indicator states and in which each DMRS port is associated with one of the plurality of transmission configuration indicator states, or any combination thereof.

76-136. (canceled)
